(19) United States
(12) Patent Application Publication
(10) Pub. No.: US 2026/0197174 A1
(43) Pub. Date: Jul. 9, 2026

(54) NON-INTERACTIVE ZERO-KNOWLEDGE PROOFS WITH SUBVERSION SECURITY

(71) Applicant: NTT Research, Inc., Sunnyvale, CA (US)

(72) Inventors: Prabhanjan Ananth, Santa Barbara, CA (US); Gilad Asharov, Ramat Gan (IL); Vipul Goyal, Pittsburgh, PA (US); Hadar Kaner, Ramat Gan (IL); Pratik Soni, Salt Lake City, UT (US); Brent Waters, Austin, TX (US)

(73) Assignee: NTT Research, Inc., Sunnyvale, CA (US)

(21) Appl. No.: 19/441,731

(22) Filed: Jan. 6, 2026

Related U.S. Application Data
(60) Provisional application No. 63/742,253, filed on Jan. 6, 2025.

(51) Int. Cl. H04L 9/32; H04L 9/16

(52) U.S. Cl. CPC H04L 9/3221; H04L 9/16

(57) ABSTRACT

The present disclosure provides a method for generating and verifying a non-interactive zero-knowledge proof with subversion zero-knowledge security against malicious common reference strings. The method includes providing a non-interactive zero-knowledge proof system with subversion zero-knowledge security, generating and verifying the proof using a combination of a provided non-interactive zero-knowledge proof system, a delayed-input two-message publicly-verifiable S-notion zero-knowledge argument system, and a non-interactive perfectly binding and T-extractable commitment scheme. The method further includes generating a common reference string, generating a proof, and verifying the proof for an outer NIZK system. The system comprises generating an inner common reference string, computing a first message, computing a second message, committing to the second message, computing an inner proof, and verifying the inner proof using an inner NIZK system.

### CROSS-REFERENCE TO RELATED APPLICATION

This application claims the benefit of U.S. Provisional Application Ser. No. 63/742,253 filed Jan. 5, 2025, the content of which is incorporated by reference herein in its entirety for all purposes.

### FIELD OF THE INVENTION

The present disclosure relates to non-interactive zero-knowledge proof systems, and more particularly to non-interactive zero-knowledge proof systems that provide meaningful notions of privacy and soundness even when the common reference string is maliciously generated.

### BACKGROUND OF THE INVENTION

Zero-knowledge (ZK) proofs have transformed modern cryptography. Informally, they allow to prove any N P statement without revealing anything but the statement's validity, and in particular, no information is revealed about the witness. A central question in the study of zero knowledge is the minimal round complexity or whether one can construct a completely non-interactive proof consisting of a single message from the prover to the verifier. Such non-interactive zero-knowledge (NIZK) protocols are possible, but they inherently require some setup.

The standard setup is the CRS model, where the prover and the verifier share a common reference string (CRS). Who generates the CRS? The most accepted practice is to sample the CRS using some trusted authority. This, however, has a prominent weakness: if one knows the coins used to sample the CRS, or if the CRS was not sampled from the right distribution, then one can either
break privacy, in the sense of extracting secrets from proofs that were honestly generated with respect to the CRS; or,
break soundness, in the sense of providing proofs of false statements, or providing proofs of true statements but without using the corresponding witness in generating the proof.
   Whether one can break privacy or not depends on the scheme. As for soundness, for standard NIZK schemes for hard-to-decide languages, there exists an adversary that can generate a malicious CRS and break soundness. Such an adversary is exactly the simulator used for proving that the scheme satisfies the zero-knowledge property. The simulator generates a fake CRS and provides proofs to statements without knowing the witnesses. The fake CRS, together with the proof, are indistinguishable from the honest CRS and honestly generated proofs. Thereby, the simulator can also be used to prove statements that are incorrect but are indistinguishable from correct statements (e.g., proving statements of the form “com is a commitment of 0” while com is a commitment of 1.). This presents an interesting phenomenon, where as part of the proof of security of the scheme (for proving ZK), there is a description of an explicit attacker for that scheme (for breaking soundness).

Bellare, Fuchsbauer, and Scafuro introduced the study of subversion-resistant security for NIZKs, toward understanding the following intriguing question: what security proper ties are guaranteed if the CRS is maliciously sampled? They show that the ZK property can still be guaranteed (this notion is called “subversion-ZK NIZK”, i.e., NIZK that pro vides ZK when the CRS is subverted). However, the construction uses knowledge-type assumptions, which are non-falsifiable. Constructing subversion-ZK NIZK based on standard cryptographic assumptions seems unlikely: Bellare et al. observe that subversion-ZK NIZKs imply certain forms of two-round ZK protocols, which, again, are only known from knowledge-type assumptions. For soundness, they showed that no NIZK scheme could guarantee soundness when the CRS is maliciously sampled, as this clashes with the ZK property required when the CRS is honestly generated.

The current state of affairs is, therefore, unsatisfactory. On the one hand, NIZKs for all NP languages have been extensively studied but typically fail to provide security guarantees if the trusted authority is corrupted. On the other hand, the notions of NIZKs addressing corrupted authority are impossible to achieve or are based on non standard cryptographic assumptions. This leads us to the following question: Is it possible to achieve a non-interactive proof system based on standard (falsifiable) cryptographic assumptions which satisfy meaningful notions of privacy and soundness even if the CRS was maliciously generated?

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Trusted setup is commonly used for non-interactive proof and argument systems. However, there is no guarantee that the setup parameters in these systems are generated in a trustworthy manner. Building upon previous works, we conduct a systematic study of non-interactive zero-knowledge arguments in the common reference string model where the authority running the trusted setup might be corrupted.

We explore both zero-knowledge and soundness properties in this setting.
We consider a new notion of NIZK called subversion advice-ZK NIZK that strengthens the notion of zero-knowledge with malicious authority security considered by Ananth, Asharov, Dahari and Goyal (EUROCRYPT'21), and present a construction of a subversion advice-ZK NIZK from the sub-exponential hardness of learning with errors.
We introduce a new notion that strengthens the traditional definition of soundness, called accountable soundness, and present generic compilers that lift any NIZK for interesting languages in NP to additionally achieve accountable soundness.
Finally, we combine our results for both subversion advice-ZK and accountable soundness to achieve a subversion advice-ZK NIZK that also satisfies accountable soundness. This results in the first NIZK construction that satisfies meaningful notions of both soundness and zero-knowledge even for maliciously chosen CRS.

### 0.1 Results

We study NIZKs with subverted CRS and show how relaxed security properties of privacy and soundness can be simultaneously achieved, even when the CRS is maliciously gen-crated. Our constructions are based on standard cryptographic assumptions. Of course, when the CRS is honestly generated, our construction achieves the standard soundness and ZK properties. We tackle privacy and soundness separately and then show how to combine them generically.
Privacy. Our goal is to start with any NIZK which provides the zero-knowledge property when the CRS is honestly sampled and convert it into a NIZK that also achieves some privacy notion even when the CRS is maliciously sampled. As mentioned, achieving full ZK when the CRS is maliciously sampled based on standard cryptographic assumptions seems unlikely. Therefore, we consider relaxations of the ZK property for the case when the CRS is maliciously sampled.

We emphasize that we aim to achieve two notions of privacy simultaneously. (1) Primary full ZK when the CRS is honestly generated; (2) Subverted some relaxed notion of privacy when the CRS is maliciously generated (a “fallback”). Several relaxed notions of privacy were previously studied as the primary notion, such as witness indistinguishability or witness hiding. It seems natural to adopt those notions as the fallback guarantee. However, we propose a novel notion, which, as we will see, is strictly more robust than those notions:

Our New Privacy Notion: Subversion Advice-ZK. We compare the view of an adversary in the real world to its view in the ideal world, where:
Real: The adversary generates some (possibly malicious) CRS*, and then obtains honestly generated proofs computed with respect to CRS* for statements of its choice (adaptively);
Ideal: The adversary generates some (possibly malicious) CRS*, and then we sample (not necessarily in polynomial time) one-time advice d from some distribution [symbol] (CRS*). An efficient simulator [symbol] then generates proofs for adversarially (adaptively) chosen statements using the one-time advice d.

In other words, this notion requires the existence of an efficient simulator that might receive some advice that depends on the code of the adversary sampling the CRS and the possibly malicious CRS, but not the instances to be proven.

Philosophically, the corrupted authority cannot learn any additional information about the witness from the NIZK proofs, beyond what is leaked by d, where d is generated from the advice distribution. In particular, if the language we are considering is hard against sub-exponential adversaries and moreover, the sampling from the distribution can be done in sub-exponential time then clearly, the NIZK proofs alone cannot help the adversary to recover the witness. Indeed, we show that our definition implies that seeing the NIZK proofs cannot provide any advantage to the adversary in computing any deterministic predicate or function of the witness as discussed later in more detail.

In many proofs for NIZK constructions, it is common to plant a trapdoor in the CRS to enable simulation. Could the advice d then be simply this CRS trapdoor of a typical NIZK construction? The answer is no, as standard security definitions for NIZKs provide no guarantee for maliciously chosen CRS.

Our main result for subversion advice-ZK NIZK is the following:

Theorem 0.1 (informal). Assuming two round delayed-input publicly-verifiable witness indistinguishable arguments for NP, NIZK arguments for NP, subexponentially-hard collision-resistant hash functions, and non-interactive commitments, then for every NP language L there exists a scheme H such that:
Primary: Π is a NIZK argument system for L (i.e., it achieves standard ZK and soundness when the CRS is sampled honestly as described by Π);
Subverted: Π ensures ZK with advice when the CRS is maliciously sampled.

Interestingly all the necessary tools for Theorem 0.1 along with the NIZKs can be instantiated from the subexponential hardness of the learning with errors problem. We also show that the privacy guarantee in our notion is strictly stronger than other relaxations of ZK, such as witness-indistinguishability and witness-hiding. We also introduce another notion, called “subversion function hiding”, which informally means that what ever partial information the verifier, who also controls the CRS, can learn from seeing a proof can be efficiently simulated. We show that subversion advice-ZK also implies this notion.

Our notion is a special case of SPS (super polynomial simulation) ZK, introduced for interactive ZK proof systems in prior work, in which the simulator is allowed to be inefficient. However a key difference is that for SPS-ZK, the simulator is allowed to run in superpolynomial time for every statement. In contrast, we require our simulator to efficiently simulate proofs for multiple statements given a one-time advice that is generated via a superpolynomial time computation.

A drawback of SPS ZK is that it is only helpful for languages that are hard against algorithms running in super-polynomial time and, thus, not useful for “not-so-hard” languages. In contrast, we require efficient simulation (with an advice possibly generated inefficiently but prior to seeing the statement), which allows our notion to be meaningful also for “not-so-hard” languages. As an example, if the language is not-so-hard and has a unique witnesses, a perfectly acceptable construction for SPS-ZK is to just send the witness in clear (since the SPS simulator would just brute force the witness). This is not possible in our setting.

Accountable Soundness. It has been shown that no scheme can simultaneously achieve ZK in the case of honestly generated CRS, and soundness in the case of maliciously gen-crated CRS. We, therefore, take a different route and use the notion of accountability. Accountability in the generation of the CRS was introduced by Ananth, Asharov, Dahari, and Goyal. It guarantees that if the authority misbehaves, one can generate a publicly verifiable proof certifying that the authority is corrupted. The work of Ananth et al. ad-dresses only some specific settings where the authority breaks privacy, i.e., it shows how to hold the authority accountable only if the authority helps others to extract witnesses from honestly generated proofs. The case where the authority helps others to break soundness, that is, helps others to prove false statements, was never explored.

As we already mentioned, ensuring soundness even when the CRS is maliciously gen-crated is important. Any NIZK proof system has an adversary (i.e., the simulator for the ZK property) that can provide proofs to statements without knowing the corresponding witness and therefore, also prove statements that are not in the language (but are indistinguishable from factual statements). To hold the misbehaving authority accountable, we require the following two properties:
1. Accountability. Suppose that the authority generated some malicious CRS*, and then it helps others to prove statements (that are either valid or invalid). The accountability property guarantees that we can hold such an authority accountable by producing a piece of evidence that can be presented in a court of law to penalize this authority. This is formalized by adding to the NIZK scheme another algorithm, called Judge, which determines if some given piece of evidence indicates that the CRS is corrupted.
   This definition is modeled as a game between the authority [symbol] and an extractor ε. If the authority generating the CRS is engaged in the aforementioned activity, the goal of the extractor is to generate a string that can be used to implicate the authority. Specifically, upon receiving the CRS from the authority, the extractor can query the authority and ask for proofs of some instances of its choice. The extractor computes, from authority-provided proofs, a piece of evidence to implicate the authority. We stress that this extractor interacts with the malicious authority online without being able to rewind it. This is because, in the real world, we cannot rewind such an authority.
2. Defamation-free. Accountability cannot stand by itself. We complement the definition by defining another property called defamation-free. This definition states that if the CRS is honestly generated, then it is computationally hard to generate a piece of evidence that the Judge would accept.
   If a NIZK scheme is a traditional NIZK scheme in the case of an honestly generated CRS, and in addition, satisfies the above two security requirements, then the scheme is a NIZK system with accountable soundness. We show:
   Theorem 0.2 (informal). Let L be a NP∩co-NP language. Then, every NIZK system for L can be transformed into a NIZK system with accountable soundness.
   Theorem 0.3 (informal). Let L be a sparse language. (By “sparse” we mean that L⊆Σ of some domain Σ, and |L|/|Σ| is exponentially small in the security parameter.) Then, every NIZK system for L can be transformed into a NIZK system with accountable sound ness.

It is important to note that the above transformations preserve the efficiency of the proof system. As for Theorem 0.2, we also remark that the language L does not have to be in co-NP; we can also handle languages in which large enough NO instances have a witness of not being in L. We show that the above theorems capture languages and cryptosystems with practical interest. For instance:
ZCash: Consider the proof system that exists in the ZCash system, such as the one for the language POUR—a user pours “old” coins into “new” coins. The statement consists of commitments to hidden values, and we show that such a proof system is captured by a generalization of Theorem 0.2. See Section 6.1.2 for an elaborated discussion.
GMW compiler: A particular usage of NIZK systems is in transforming multi-party computation protocols from semi-honest to malicious security. Such a transformation was first proposed by the GMW compiler. We demonstrate that our results capture NIZK languages used in the GMW compiler by considering the particular case of applying the GMW compiler on Yao's semi-honest two-party protocol.
Other cryptosystems: Our theorems can also be applied to commonly used crypto-languages, such as proving that a given tuple is a DDH tuple (a language in NP∩co-NP), proving that a particular string is an output of a pseudorandom generation (a sparse language), or that a particular commitment is a bit commitment (a language in NP∩co-NP). We also show other examples validity of ciphertexts, hash-time-lock contracts, and sequential composition of hash in Section 6.1.2 and Section 6.2.1.
   General feasibility for accountable soundness. Our results above for accountable soundness are practical and do not slow down the proof system's process. Yet, they assume some structure in the language. We also show a general feasibility result for any NP language from subexponential hardness assumptions. We refer the reader to the technical overview for further details.
   Putting it all together. As opposed to prior negative results, our two notions can co-exist. Thus, we can have a NIZK scheme that provides subversion advice-ZK and accountable soundness for the case where the CRS is maliciously sampled. Our work is in the form of general compilers: we take an existing NIZK and uplift it to achieve this extra security. NIZKs can be instantiated from various assumptions, including factoring, falsifiable assumptions on bilinear maps, and from the subexponential hardness of LWE. This gives the first construction of NIZKs, providing reasonable notion of privacy in the subversion setting from post-quantum assumptions. Comparatively, prior works on constructing NIZKs that offer security for maliciously chosen CRS are based on bilinear maps and are susceptible to quantum attacks.
   When can our notions be applied? When using such notions it is imperative for a system designer to realize when they can and cannot be successfully applied. We examine accountable soundness and zero knowledge in turn. Our notion of soundness guarantees security against a corrupt authority that will willingly create false proofs for any statement as a service.

In practice to hold such an attacker accountable we need two things to occur. First, the attacker needs this service just enough that he will likely interact with someone willing to turn him in. If an authority works to help a small cabal or even a single user cheat, it might be difficult to expose the bad behavior. On the other hand, if the corrupted authority runs an open service or say is willing to help for a fee, he might be more likely to be caught. Arguably, this is somewhat similar to the problem of traitor tracing, as studied in prior work, which shows how to trace the origin of a “pirate” decrypting box or algorithm. But this only works if the decoding algorithm is spread widely enough where it gets into the hands of a user that wishes to expose the corruption. Nonetheless, in our setting even if the authority helps a single user cheat, he risks leaving a proof of bad behavior with that user (which that user can exploit later on, e.g., by blackmailing the authority).

Second, one needs to ask what service does the authority need to provide in order to subvert the security of our system. Running a service that will create a proof for any submitted statement will almost certainly subvert security for most conceivable scenarios. However, it might be possible for a more circumspect authority to subvert security by being more judicious in what statements it will create proofs for. For example, the authority might only create a proof for a statement x under certain conditions. The goal of such an authority is then to provide a service that gives enough to help undermine the security of the larger system, but the service is limited in such a way that he will not be held accountable.

This leads us to the following viewpoint. It is not prudent to simply replace a NIZK with an accountable one in a system and presume that accountability will follow. Instead, one should define the desired security property of the larger system and then try to prove that if security is violated it will lead to the authority being held accountable. We believe that in some systems our notion will be sufficient and in others it might not. For cases where it falls short we expect it will lead to interesting open problems for strengthening accountability.

On the zero knowledge side it is instructive to compare our subversion notion of zero knowledge to the work of Barak and Pass, who show how to achieve one message zero knowledge against uniform attackers. At some level a one message zero knowledge system achieves zero knowledge against a corrupted authority simply by the virtue of having no authority. The main restriction on applying our subversion notion is that it is only applicable in a security game where the attacker/authority will publish the CRS at the beginning of the security game. This will not apply in a situation where the publication of the CRS can possibly be delayed or depend on other inputs in the game. (Since in this situation one cannot non-uniformly pre-compute the trapdoor advice for the CRS.) We get the usual (security against non-uniform attackers) notion of soundness when the authority is not corrupted and either no or accountable soundness (depending if the additional transformation is applied) if the authority is corrupted. In contrast the Barak-Pass system does not have such a restriction since there is no CRS. However, it only maintains soundness against uniform attackers and requires less standard assumption of the “keyless” flavor such as keyless collision resistant hash functions.

Open problems. We believe that a systematic study of the notions of accountability in the CRS model is an exciting line of research. Our work leaves open some interesting problems. In our definition of accountable soundness, we considered the most basic setting where the extractor has full control over the statement. That is, we capture only the setting where the authority runs some service in which it receives queries x and replies with proofs π without ever seeing the corresponding witnesses. Already addressing this basic setting is challenging and requires interesting technical work.

In reality, the authority might only answer limited types of statements, or with each query of some statement x, it might be willing to answer only on statement ƒ(x) for some function ƒ. It is intriguing to understand under what functions ƒ achieving accountable soundness is possible.

According to an aspect of the present disclosure, a method for generating and verifying a non-interactive zero-knowledge proof providing subversion zero-knowledge security against malicious common reference strings is provided. The method includes providing a non-interactive zero-knowledge proof system with subversion zero-knowledge security, wherein the subversion zero-knowledge security comprises that for every non-uniform probabilistic polynomial-time adversary [symbol] that generates a potentially malicious common reference string CRS*, there exists a probabilistic polynomial-time simulator [symbol] and an S(λ)-time computable advice distribution [symbol] such that the view of [symbol] in a real proof generation process [symbol] (λ) is computationally indistinguishable from the view of [symbol] in an ideal simulation process [symbol] (λ). The method includes generating and verifying the non-interactive zero-knowledge proof using a combination of a provided non-interactive zero-knowledge proof system that optionally provides no subversion security, a delayed-input two-message publicly-verifiable S-advice zero-knowledge argument system, and a non-interactive perfectly binding and T-extractable commitment scheme. The method further includes generating and verifying the non-interactive zero-knowledge proof with subversion zero-knowledge security (referred to as the outer NIZK system) by generating a common reference string, generating a proof, and verifying the proof.

According to other aspects of the present disclosure, the method may include one or more of the following features. The delayed-input two-message publicly-verifiable S-advice zero-knowledge argument system may be constructed using a T-hard trapdoor generation protocol, a non-interactive perfectly binding and T-extractable commitment scheme, and a delayed-input, two-message, T-sound and publicly-verifiable witness in distinguishable argument for a language that combines the statement to be proven and the trapdoor. The non-interactive zero-knowledge proof system with subversion zero-knowledge security may satisfy perfect completeness and computational adaptive sound ness when the common reference string is honestly generated. Generating the proof π for the outer NIZK system may further comprise computing the second message zk₂ using the statement x and witness w as inputs to the prover algorithm P of the delayed-input two-message publicly-verifiable S-advice zero-knowledge argument system, and computing the inner proof π_{Inner} for the statement that there exists a zk₂ such that the verifier algorithm V₁ of the delayed-input two-message publicly-verifiable S-advice zero-knowledge argument system accepts (zk₁, zk₂) and c is a commitment to zk₂. Verifying the proof for the outer NIZK system may further comprise parsing the common reference string CRS as (CRSᵢₙₙₑᵣ, zk₁), parsing the proof π as (π_{Inner}, c), and verifying the inner proof π_{Inner} for the statement (x, zk₁, c) using the inner NIZK system. The S(λ)-time computable advice distribution [symbol] may be independent of the statement to be proven and can be sampled in super-polynomial time S(s), where S is a function of the security parameter A but independent of the hardness of the language L. The subversion zero-knowledge security may imply that the non-interactive zero-knowledge proof system satisfies subversion witness indistinguishability, subversion witness hiding, and subversion function hiding properties.

According to another aspect of the present disclosure, a system for generating and verifying a non-interactive zero-knowledge proof providing subversion zero-knowledge security against malicious common reference strings is provided. The system includes a processor and a memory storing instructions that, when executed by the processor, cause the system to perform operations similar to the method described above.

According to other aspects of the present disclosure, the system may include features similar to those described for the method.

According to yet another aspect of the present disclosure, a non-transitory computer-readable medium storing instructions is provided. When executed by a processor, the instructions cause the processor to perform a method for generating and verifying a non-interactive zero-knowledge proof providing subversion zero-knowledge security against malicious common reference strings, similar to the method described above.

According to other aspects of the present disclosure, the non-transitory computer-readable medium may include features similar to those described for the method and system.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 illustrates a flowchart of a method for generating and verifying a non-interactive zero-knowledge proof, according to aspects of the present disclosure.

FIG. 2 illustrates a block diagram of a non-interactive zero-knowledge proof system, according to an embodiment.

FIG. 3 illustrates a system diagram of a non-interactive zero-knowledge proof system with subversion security, according to aspects of the present disclosure.

FIG. 4 illustrates a block diagram of a computing system architecture, according to an embodiment.

FIG. 5 illustrates a block diagram of a non-interactive zero-knowledge proof system with subversion security, according to aspects of the present disclosure.

FIG. 6 illustrates a block diagram of a client computing architecture, according to an embodiment.

FIG. 7 illustrates a block diagram of a server-client network architecture, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

### 1 Technical Overview

In this section, we give an overview of our techniques where Section 1.1 presents our new notion of subversion advice-ZK, and Section 1.2 discusses accountable soundness.

### 1.1 Subversion Advice-ZK NIZK

Let us recall the setting. We have an authority [symbol] that samples a malicious common reference string CRS*. We want to ensure that some meaningful notion of privacy prevails for proofs of statements computed using CRS*. We propose the following definition. For every authority [symbol] there exists a distribution [symbol] (not necessarily efficient to sample from) along with an efficient PPT simulator [symbol] such that the view of the adversary is computationally-indistinguishable in the following two processes:
Real: The adversary generates some (possibly malicious) CRS* and then obtains honestly generated proofs proven with respect to CRS* for statements chosen by the adversary;
Ideal: The adversary generates some (possibly malicious) CRS*. We sample d [symbol] (CRS*). The adversary repeatedly gives some statements in which an efficient simulator [symbol] generates proofs with the help of the advice d and with respect to the flawed CRS*.

We refer to a NIZK that additionally satisfies the above property as subversion advice-ZK NIZK. See Section 4.1 for a formal definition. We emphasize that the distribution [symbol] , although inefficient to sample from, is independent of the statement/witness. In fact, in Theorem 4.1, we explicitly require sampling from [symbol] to run in some fixed superpolynomial time S(⋅), where S is function of the security parameter A but independent of the hardness of L. (In our construction, S can be set to be 2^{ω(log λ)} assuming 2^{λ}^{^{ϵ}}-hardness of either a one-way permutation or a collision-resistant hash function.)

A discussion. How well does this notion protect the witness w? To get some sense of the privacy guarantee, we compare it to several other privacy notions. Those notions were studied as the primary security notion, i.e., the privacy guarantee when the CRS is honestly generated. In the following, we adopt those notions as the fallback guarantee while requiring NIZK as the primary notion:
Subversion Witness-Indistinguishability: Witness-Indistinguishability (WI), as introduced in prior work, means that one cannot distinguish between proofs that were generated by different witnesses. In subversion WI, we require standard ZK in case of honestly generated CRS, but when the CRS is maliciously generated, then two proofs generated with different witnesses are indistinguishable. This notion is meaningless for languages where each instance has a unique witness (in which case, a proof system that completely reveals the witness satisfies this notion). Moreover, subversion WI allows leaking bits of the witness (as long as those bits do not help to identify which one of the witnesses was used), whereas ours does not allow such a leakage. Our notion implies subversion witness indistinguishability, and is strictly stronger. We refer to Appendix B for a formalization of this argument.
Subversion Witness Hiding: Witness hiding (WH), as established in prior work, ensures that one cannot learn the entire witness from the proof (unless such a witness can be efficiently computed from the statement alone). In subversion WH, we require that this holds even if the CRS is maliciously generated. However, the proof can reveal some bits of the witness as long as they do not allow for efficiently recovering the witness. Our notion implies subversion WH, and this notion is weaker than ours. We formalize this argument in Appendix B.
Subversion Super-Polynomial Simulation (SPS) NIZK: Introduced for interactive protocols in the plain model, the notion of SPS-ZK allows the simulator to run in some fixed super-polynomial time for every statement. Therefore, in the subversion setting, one can also consider a NIZK that satisfies subversion SPS-ZK as the fallback guarantee. This is a natural security guarantee; and our notion implies it in a strong sense albeit in the non-black-box simulation setting since the advice distribution could depend on the code of the corrupt authority. In particular, our simulator can efficiently simulate proofs for multiple statements when given a one-time advice string generated via some super-polynomial time computation.

In Appendix B, we introduce a new notion called “function hiding” which is a strengthening of witness hiding. Roughly, function hiding requires that the NIZK should not give any advantage to the adversary in guessing any deterministic function or predicate of the witness. The probability of such a guess being correct should remain similar before and after seeing the NIZK. We show that subversion advice-ZK for NIZKs implies subversion function hiding.

On the strength of our definition. Philosophically, our notion enables that whatever the adversary learns from multiple proofs from the honest prover, it could have computed on its own by running in time S(λ)+poly(λ) on the CRS where S is some a-priori fixed superpolynomial function. Perhaps, the S-time computed advice given to the simulator (akin to preprocessing of the language) may reveal some information to the adversary. But, similarly to the case of SPS-ZK for interactive protocols, the exact information revealed and its impact on security depends on several factors, including the hardness of the language, the adversary, and the considered application. For example, consider an adversary that embeds some “hard” instance x* in the CRS, then the S-time computed advice could reveal a witness w* for x*. What meaningful guarantees does our notion provide for the adversary's chosen statement x? We elaborate this below:
1. When the statement x is chosen independently of the malicious CRS and the language L is hard-on-the-average for polynomial-time algorithms, then our notion essentially says that any information the verifier learnt by talking to the prover can be simulated by first performing a super-polynomial time instance-independent processing (i.e., this phase does not depend on x) and then running a PPT algorithm on x.
2. The statement x being dependent on the CRS requires more care. The extreme case is where x=x*, i.e., the statement is the statement embedded in the CRS. In that case, our real-world proofs may completely reveal the witness w=w*, if the language L has unique witnesses. In that case and for that particular instance, our notion provides no meaningful guarantee. Such a similar weakness also exists in SPS-ZK for interactive protocols in the plain model, where the super-polynomial time simulator might learn a witness of a hard instance embedded by the verifier in its messages.
On the other hand, even in the extreme case of x=x*, but when instances in L have multiple witnesses, there is still some privacy guarantee. This is essentially captured by the fact that our notion implies subversion witness-indistinguishability.
   Subversion Advice-ZK NIZK construction. We now show how to construct subversion advice-ZK NIZK. We reduce this goal to a slightly weaker building block, which is a two-round argument system (V₀, P, V₁) that we introduce:
V₀(1^{λ}): The verifier sends the first message zk₁. We require that the system be delayed input; that is, zk₁ is independent of the statement x.
P(x, zk₁, w): The prover sends the second message zk₂, that depends on zk₁ and x.
V₁ (x, zk₁, zk₂): the verifier decides whether to accept or reject. We also require that this scheme is publicly verifiable, namely, that the verifier does not keep a secret state after its first message, and so everyone can verify the proof given the transcript (zk₁, zk₂).
   The hiding requirement of this proof system is similar to subversion advice-ZK:
advice-ZK: The hiding property is that for every corrupted verifier V*, there exists a (not necessarily efficient) distribution [symbol] , and an efficient simulator [symbol] , such that the following holds. Given a sample d← [symbol] , the simulator can generate transcript zk₁, zk₂ for a statement x that is indistinguishable from an execution of the protocol with an honest prover and with the corrupted V*.
   Given such a primitive, it seems immediate to convert it to a NIZK proof system: Simply run V₀(1^{λ}) to generate zk₁ and treat it as the common reference string; To prove that a statement x is in the language we run the honest prover P on (x, zk₁) and obtain π=zk₂. To verify the proof, run the verifier V₁ on (x, zk₁, zk₂). Moreover, the subversion advice-ZK property for the case of a maliciously generated CRS follows directly from the advice-ZK property of the two-round scheme.

However, the aforementioned proof system is not a NIZK. Specifically, while it provides the “fallback” guarantee when the CRS is maliciously generated, its primary privacy notion, i.e., the privacy guarantee when the CRS is honestly generated, is not full ZK. In that above construction, there is no guarantee that the simulator would be efficient without the advice since the underlying two-round scheme satisfies just ZK with advice. The simulation in ZK with advice includes the non-efficient sampling of the advice d. To solve this problem, we wrap the construction with an inner NIZK argument of knowledge scheme (GenCRSᵢₙₙₑᵣ, Pᵢₙₙₑᵣ, Vᵢₙₙₑᵣ) as follows:
To generate the CRS, we generate CRSᵢₙₙₑᵣ according to the inner NIZK scheme, and zk₁ according to the two-round accountable ZK scheme. The CRS is therefore (CRSᵢₙₙₑᵣ, zk₁).
Given (x, w), the prover computes the second message zk₂ of the two-round scheme using (x, w) and zk₁. Then, it generates using the inner NIZK scheme a proof π for the statement “I know zk₂ for which the V₁(zk₁,zk₂) accepts”. It outputs the proof π.
To verify a proof, we simply run the verifier of the inner NIZK scheme.
   It is easy to see that this scheme satisfies completeness and soundness. Moreover, ZK with advice in the case of malicious CRS, follows easily from the ZK with advice property of the two-round scheme. However, now we also have an efficient simulator for the case of an honestly generated CRS: We can use the simulator of the inner NIZK scheme to generate proofs for the statement that the prover knows zk₂ such that V₁ accepts (zk₁, zk₂), even without knowing zk₂. Thus, the simulator does not need to know the witness w to generate zk₂.

Therefore, to obtain subversion advice-ZK NIZKs, all that is left to show is how to construct a two-round ZK with advice scheme.

Construction of Two Round ZK Argument. At a high level, the construction follows the template of Pass's two-round SPS-ZK protocol. We quickly recall their construction: the verifier message consists of an image y=ƒ(s) of a one-way permutation ƒ. The prover on input a statement witness pair (x, w) computes a non-interactive commitment c to the all-zero string and computes a non-interactive witness-indistinguishable proof for the statement “either x∈L or c commits to the pre-image of ƒ”. The super-polynomial-time simulator for this construction first receives the verifier message y and brute-force inverts y to get the corresponding pre-image s and then uses s to finish the simulation.

Here, we observe that their super-polynomial-time-simulator can be decomposed into an inefficient distribution [symbol] and an efficient simulator [symbol] where the inefficient distribution [symbol] is as follows: it runs the verifier on a uniform random tape r* to get the first message y* and then runs in super-polynomial time to brute-force invert y to compute the pre-image s*. Then, it outputs (r*, s*). Now, the simulator [symbol] on input (r* s*) and statement x can compute a commitment c to s* along with the witness-indistinguishable proof using witness s*.

While the above two-round construction is sufficient to get ZK with advice, it re quires one-way permutations and non-interactive witness-indistinguishable proofs (NI-WIs). In Section 3, we present a generalization of this protocol that allows us for more general instantiations, including a post-quantum instantiation from the sub-exponential hardness of learning with errors problem.

### 1.2 Accountable Soundness

We now turn our attention to soundness. When the CRS is generated by a corrupted authority, it could exploit the randomness used in creating the CRS to generate proofs for false statements (or even true statements but without actually knowing what the witness is). We recall that one cannot hope to provide subversion-soundness for a NIZK, as this is impossible by prior negative results. Therefore, it is always possible to generate proofs for false statements when the CRS is maliciously sampled. While we cannot prevent this behavior, we can at least hope to implicate authorities who engage in this activity, if they ever actively use this knowledge to, for instance, sell proofs of false statements.
Definition. Recall that our definition (which is inspired by the accountable NIZK of Ananth et al.) changes the syntax of the NIZK proof system, by adding a new algorithm, called Judge, in addition to the standard algorithms of Gen, Prove, Vrfy. The Judge algorithm receives as an input (possibly malicious) CRS* together with some transcript τ and has to decide whether the CRS* is corrupted or not. In addition,
Accountability: accountability is modeled as a game between the authority [symbol] and an extractor ε. If the CRS generating authority is engaged in the aforementioned activity in the “real world”, then there exists an extractor in an “ideal world,” where the goal of the extractor is to generate a transcript τ that implicates the authority. The extractor, upon receiving the CRS from the authority, can query the authority and ask for proofs of instances of its choice. The extractor uses the information produced by the authority-provided proofs to compute evidence T for which Judge outputs corrupted.
Defamation-free: As mentioned, the accountability property alone does not suffice, and so we augment this property with defamation-freeness. This roughly states that if CRS is honestly generated according to GenCRS, then no adversary [symbol] (CRS) can output τ such that Judge(CRS, τ) outputs corrupted. I.e., no adversary can produce evidence that implicates an honest authority.
   Construction for languages in NP∩co-NP. We start with a simple example. Consider for instance the language of DDH tuples, namely, consider some cyclic group [symbol] of order q with generator g where the DDH problem is believed to be hard. Then, consider the following language over [symbol] × [symbol] × [symbol] :

$$L = \{ ( {h}_{1} , {h}_{2} , {h}_{3} ) \vert ∃ x , y ∈ {ℤ}_{q} s . t . {h}_{1} = {g}^{x} , {h}_{2} = {g}^{y} , {h}_{3} = {g}^{x y} \} .$$

Since for every h∈ [symbol] there exists a unique x∈ [symbol] _{q} such that h=g^{x}, we can conclude that the complement language L̅, which consists of tuples of the form (g^{x}, g^{y}, g^{z}) where z≠xy is also in NP. Now, consider a proof system for this problem, and assume that one generated the CRS maliciously such that it can, given an instance (h₁, h₂, h₃)∈L, generate proof π which is accepted by a verifier (even though this algorithm does not receive the witness x and y).

Assuming DDH, this authority cannot distinguish whether a given (h₁, h₂, h₃) is in L or in L̅. To hold the authority accountable, it is enough to sample some triplet (h₁, h₂, h₃) ∉L (say, by sampling x, y, z and then set h₁=g^{x}, h₂=g^{y}, and h₃=g^{z}), use the authority to obtain a valid proof π that “shows” that the instance is in L, and then publicize the proof π together with the witness (x, y, z) that shows that the instance is not in L. From the soundness property of the NIZK proof system, the only way to obtain the accepting proof π for an instance (h₁, h₂, h₃)∉L is by using a malicious CRS. This implies that the authority generated the CRS is corrupted.

To be slightly more formal, in the above scheme, we do not modify the way the CRS is being generated, nor the code of the prover or the verifier. The Judge algorithm receives a (possibly maliciously generated) CRS and a transcript τ and should decide whether the CRS is corrupted. In our case, the transcript τ consists of an instance (h₁, h₂, h₃), a proof π that is accepted by the scheme, and a witness w̅ (x, y, z) showing that (h₁, h₂, h₃)∉L. The judge algorithm outputs corrupted if indeed π is accepted but w̅ validates that (h₁, h₂, h₃)∉L.

Since the construction does not modify the generation of the CRS, the defamation-free property follows directly from the soundness property of the scheme. No adversary can generate an acceptable proof for an instance that is not in the language, and therefore it is impossible to frame an innocent authority that generated the CRS honestly. Importantly, the resulting scheme is practical, we do not modify the construction nor the CRS generation, and one can even use our paradigm on a previously generated CRS that is currently in use.

Distribution over the inputs. Before proceeding to other results, we mention some property of our definition. To have a meaningful security notion, we have to model the fact that the authority does not know the witness of a given instance. In particular, if the authority has some auxiliary information about the statement, then it can possibly produce the proof πhonestly (i.e., using the witness) and without forging it. To avoid this issue, we specify a distribution [symbol] such that the inputs in the security experiment are sampled from this distribution. We stress that this requirement is only for the account ability security experiment, and the NIZK construction satisfies the usual definition of NIZK and is well-defined for any input.

Note that the above requires the extractor also to have some distribution [symbol] ′ for which it generates the instance (h₁, h₂, h₃) ∉L used as part of the evidence. Moreover, in our example, the distribution [symbol] might be picking x and y at random and setting (h₁ h₂, h₃)=(g^{x}, g^{y}, g^{xy}), whereas the distribution that the extractor uses would be picking x, y, z at random and setting (h₁, h₂, h₃)=(g^{x}, g^{y}, g^{z}). Note that according to the DDH assumption, the malicious authority cannot distinguish between samples of the two distributions, and if it ever produces proofs without knowing the witness, even if it intends to do so only for statements that are in the language, then it can also be used to generate proofs for statements that are not in the language, thereby holding it accountable.

Additional results for accountable soundness. Motivated by the simple example of DDH, we essentially show that accountable soundness can be achieved for any hard language in NP∩co-NP. By a hard language, we mean the following: it should be computationally hard to distinguish yes instances from no instances. Essentially, the extractor generates a NO instance, receives a valid proof for that instance, and uses the instance, the witness showing that this is indeed a NO instance, and the proof generated by the authority to frame the authority.

We then generalize this condition and show that it also applies to languages that are not in NP∩co-NP, but for which there exists an efficiently checkable witness for some (as opposed to all) NO instances. We show that this already gives a powerful framework and captures several interesting languages that are used in cryptographic systems, such as non-interactive commitments, the GMW compiler, validity of ciphertexts, hash-time-lock contracts, and the ZCash's POUR transaction. See Section 6.1.2.

We then turn our attention to languages for which NO instances may not have a short validating proof of non-membership. For example, consider the language L_{G}, which contains strings in the range of some length doubling pseudorandom generator G, that is, L_{G}={y∈{0, 1 [symbol] :∃s∈{0, 1 [symbol] s.t. y=G(s)}. Then, for any [symbol] -bit string y̅ there does not (seem to) exist an efficiently checkable witness for y̅ ∉L_{G}. As a first step towards achieving accountable soundness for such languages, we consider “sparse languages”. We also discuss a generalization to any N P language under strong assumptions on the distribution [symbol] .

Sparse Languages. We show that if the language is “sparse”, namely, the number of elements in ILI is only a negligible fraction, then it is also possible to hold the authority accountable. Here, however, we have to modify the way the CRS is generated. In particular, if L is over [symbol] -bit strings then we add an [symbol] -bit random string x* to the CRS. If, for instance, L had only δ· [symbol] instances, then for every x∈L it is only with δ probability that x⊕x* belongs to the language (over the choice of x*). By a union bound over all x∈L, the probability over the choice of a random x* that there exists some x∈L such that x*⊕x∈L is at most δ²· [symbol] , which is negligible for δ= [symbol] . As such, we define the Judge to require an acceptable proof for x⊕x* for some x E L to deem the CRS that contains x* as being corrupted.

Defamation-freeness holds since given an honestly generated CRS that contains a uniformly random x*, any adversary A that convinces the above Judge algorithm must find an accepting proof for x⊕x* for some x∈L. But we just argued that except with negligible probability x⊕x* is not in L. Therefore, we can use [symbol] to break the adaptive soundness of the underlying NIZK. Additionally, we can show accountability for any distribution [symbol] on yes instances, which is computationally indistinguishable from the uniform distribution over [symbol] bit strings. Section 6.2 discusses the case of such “subexponentially sparse” languages, and we defer the case of negligibly sparse languages to Section 6.3.

Languages captured by this approach include outputs of pseudorandom generators or sequential composition of hash, which is a prominent benchmark for designing time- and space-efficient arguments for RAM computations, and for proving knowledge of a T-sized blockchain. See section 6.2.1.

General Feasibility Result. The main idea of going beyond sparse languages is to push the sparsity requirements onto the distribution [symbol] from which the statements are sampled from. That is, even though the language itself is not sparse, we artificially consider a subset of the language which is sparse. The main idea is that if [symbol] needs r(λ)-bits of randomness for generating instances where r is some polynomial, we use a PRG G: {0, 1}^{t(λ)}→{0, 1}^{r(λ)}, and sample an instance using [symbol] (G(s)) for a random s∈{0, 1}^{t(λ)}. In fact, assuming subexponentially-secure PRGs, we can instantiate G such that it expands a t=log²(λ)-bit seed into an r length string. Therefore, the set { [symbol] (G(s))_{s∈{0, 1}}_{^{t}} is sparse, and now we can borrow ideas from our result for sparse languages.

Coming back to the NIZK construction, we define the Judge algorithm identically as before, except that it now requires an accepting proof for x⊕x*∈L for an x for which there exists s such that x= [symbol] (G(s)). Recall that x* is a random string that is part of the CRS.

Showing defamation-freeness is now more challenging. While the high-level idea is still to contradict the adaptive soundness of the underlying NIZK, this requires some care. Specifically, let [symbol] with some PPT adversary that given an honestly generated CRS containing a uniform string x* convinces the Judge with some non-negligible probability ϵ. In particular, [symbol] finds some random string s and an accepting proof for x ⊕x* where x= [symbol] (G(s)). Then consider the following sequence of hybrids.
1. Hybrid Hyb₁: it is identical to the defamation-free experiment except we change the winning condition for [symbol] . Specifically, Hyb₁ while generating the CRS that contains x*, also samples a t-bit string s* as a guess for [symbol] 's string s. Then, we let [symbol] win Hyb₁ only if it finds an accepting proof for x⊕x* for x= [symbol] (G(s)) and it is the case that s=s*. Then, it is then clear that [symbol] wins Hyb₁ with probability ϵ/2^{t}.
2. Hybrid Hyb₂: it is identical to the Hyb₁, except we generate the string x* embedded inside the CRS differently. In particular, after sampling the guess s*, Hyb₁ programs x* such that the string [symbol] (G(s*))⊕x* is a NO instance sampled from some distribution [symbol] _{No}.

The only difference between Hyb₂ and Hyb₁ is the distribution of the string x′= [symbol] (G(s*))⊕x*. In particular, in Hyb₁, the string x′ is actually distributed according to the uniform distribution, whereas in Hyb₂ it is distributed according to [symbol] _{No}. Then if the two distributions are δ-indistinguishable then [symbol] wins Hyb₁ with probability at least ϵ/2^{t}−δ. Finally, note that if [symbol] wins Hyb₂, then it wins by finding an accepting proof for a false statement x⊕x* where x= [symbol] (G(s*)). This is because [symbol] (G(s*))⊕x* was a NO instance, and [symbol] wins only if s=s*.

Now, [symbol] can be used to build a cheating prover that breaks the adaptive soundness of the underlying soundness with probability ϵ/2^{t}−δb. Then, if δ=2^{-λ}^{^{ϵ}} and t=log(λ), we arrive at a contradiction as long as the adaptive soundness of the underlying NIZK is such that no PPT adversary can break soundness with probability better than 2^{-λ}^{^{ϵ}}. This concludes the discussion on defamation-freeness. Identical to the case of sparse languages, accountability can be shown for D which are indistinguishable from the uniform distribution over [symbol] bit strings.

There are a few caveats associated with the above construction. First, the construction (i.e., Judge) depends on the distribution [symbol] , which means that for different distributions, we need a different construction. Moreover, it requires somewhat strong assumptions (sub-exponential—indistinguishability), whereas our previous results were based on standard security. We bring this result as evidence that the general problem of (practical) accountable soundness for every N P language is intriguing and requires further investigation.

### 1.3 Related Work

To better understand the role of trust in CRS generation, a number of works have studied relaxed settings: Groth and Ostrovsky study the multi-string model where multiple authorities individually publish common reference strings with only a majority of them are guaranteed to be honest. Garg et al. study replacing a single CRS generating authority in UC with multiple, untrusted authorities. Bellare et al. introduce and study the feasibility of security properties retained by a NIZK under a maliciously chosen CRS, and Ananth et al. study accountability in the CRS generation.

In addition, numerous works have considered relaxed security notions for privacy to get non-interactive constructions in the plain model (one that does not require any common reference string). These include witness-indistinguishability, super polynomial simulation security, and witness-hiding.

Two works that come closest in spirit to ours are that of Bellare et al. and Ananth et al., which we give a detailed comparison next.

Comparison with Bellare et al. Bellare, Fuchsbauer, and Scafuro introduced the study of subversion-resistant security for NIZKs. Specifically, this asks what security properties are guaranteed if the CRS is maliciously sampled. They show a construction of a NIZK system in which the witness is protected (i.e., satisfies ZK) even if the CRS is maliciously sampled. However, the construction relies on knowledge-type assumptions, which are non-falsifiable (specifically, a knowledge-of-exponent assumption in a group equipped with a bilinear map). Constructing subversion-ZK NIZK based on standard cryptographic assumptions seems unlikely. This is because subversion-ZK NIZKs immediately imply two-round ZK protocols, which again are only known from knowledge-type assumptions. Our construction achieves a weaker notion of security than full ZK (in case of a corrupted CRS) but is based on standard assumptions.
Comparison with Ananth et al. Recently, Ananth et al. propose a notion of account ability towards addressing trust assumptions in the CRS generation procedure. More specifically, they consider a CRS generation authority that extracts witnesses from NIZK proofs generated using the maliciously sampled CRS, and then sells these witnesses for monetary benefit on the black market.
Ananth et al. build a NIZK system that achieves both accountability and defamation-free properties from polynomial-time standard assumptions on bilinear maps. Our work expand their result in two different dimensions:
1. Our subversion advice ZK NIZK subsumes accountable NIZK (see below);
2. Ananth et al. studied accountable NIZK while addressing only privacy; and we study the orthogonal question of soundness.
   Subversion advice ZK NIZKs. Our notion expands their results in three important aspects. First, subversion advice ZK NIZK immediately satisfies the notion of account ability as formulated by Ananth et al. Specifically, no PPT adversary, including the authority who generates the malicious CRS* and perhaps knows some backdoors, can extract witnesses from proofs that were proven with respect to CRS*. Thus, there is no need to hold the authority accountable, as no such authority exists. Second, the construction of Ananth et al. works only for a large class of NP languages (but not all). This, of course, limits the applicability of that result. Our construction also holds for all NP languages. Third, prior work leaves open the question of how to handle authorities that, given a proof reveals only hard-to-compute partial information about the witness instead of the witness in its entirely. Our notion of subverted advice ZK NIZKs hides not only entire witnesses but also any partial information about the witness.
   Additional related works. The notion of accountable soundness is inspired by broad-cast encryption with traitor tracing, the accountable authority of identity-based encryption, and watermarking or copy protection, as studied in prior work. In all of those works, capturing flavor of security is challenging, and there can be many perils.
   Organization. In Section 2 we provide preliminaries and definitions. In Section 3, we formally define advice ZK for two-round arguments and give our construction for NP. In Section 4, we formally define the notion of an subversion advice-ZK NIZK, and describe our subversion advice-ZK NIZK construction. Section 5 is devoted to defining accountable soundness and Section 6 describes our constructions for NP∩coNP and sparse languages, as well as our general feasibility result for NP. In Section 7 we build NIZKs with both subversion advice-ZK and accountable soundness. In Section B, we formally show connections of our subversion advice-ZK with other notions for subversion-security.

### 2 Preliminaries

Notation and Conventions. We let λ∈ [symbol] denote the security parameter. We use PPT as a shorthand for probabilistic polynomial time. We denote by x← [symbol] sampling of an instance x according to the distribution [symbol] .
A function μ is negligible if for every positive polynomial p(⋅) there exists λ₀∈ [symbol] such that for all λ>λ₀ it holds that μ(λ)<1/p(λ).
A probability ensemble X=X(a, 6λ) [symbol] is an infinite sequence of random variables indexed by a∈{0, 1}* and λ∈ [symbol] . In the context of zero knowledge, the value a will represent the parties' inputs and A will represent the security parameter. All parties are assumed to run in time that is polynomial in the security parameter.
Two probability ensembles X={X(a, λ) [symbol] , Y={Y(a, λ) [symbol] are said to be computationally indistinguishable, denoted by X≈_{c}Y, if for every non uniform PPT distinguisher D there exists a negligible function such that for every a∈{0, 1}* and every λ∈ [symbol] ,

$$\vert Pr [ D ( X ( a , λ ) ) = 1 ] - Pr [ D ( Y ( a , λ ) ) = 1 ] \vert \leq μ ( λ ) .$$

### 2.1 One-Way Functions

A function ƒ: {0, 1}*→{0, 1}* is a one-way function if:
1. There exists a deterministic polynomial time algorithm that on input s computes ƒ(s).
2. For every non-uniform PPT adversary [symbol] , there exists a negligible function μ(⋅) such that:

$$P r [ f ( {x}^{′} ) = y : x ← {\{ 0 , 1 \}}^{λ} , y = f ( x ) , {x}^{′} ← 𝒜 ( y ) ] \leq μ ( λ ) .$$

Further, we say ƒ is T-one-way for function T: [symbol] → [symbol] , if the above holds for adversaries [symbol] that run in time T(λ)·(λ) for some polynomial p(⋅)

### 2.2 Commitment Schemes

We require commitment scheme that is perfectly binding and computationally hiding. The non-interactive commitment scheme Corn has the following syntax and properties:
c←Com(m; r): The algorithm gets m{{0, 1 [symbol] and randomness r∈{0, 1 [symbol] and outputs a commitment c∈{0, 1 [symbol] . The opening of the commitment is simply the randomness r.
   We require the following properties from the commitment scheme:
Perfectly Binding: For all (m₀, m₁)∈ [symbol] such that m₀≠m₁ it holds that

$${\{ Com ( {m}_{0} ; {r}_{0} ) \}}_{{r}_{0} ∈ {\{ 0 , 1 \}}^{{ℓ}_{r} ( λ )}} ⋂ {\{ Com ( {m}_{1} ; {r}_{1} ) \}}_{{r}_{1} ∈ {\{ 0 , 1 \}}^{{ℓ}_{r} ( λ )}} = ∅ .$$

Computationally Hiding: For every polynomially bounded function α(⋅) and every polynomial-time non-uniform adversary [symbol] there exists a negligible function μ(⋅) such that every auxiliary input z∈{0, 1}^{poly(λ)}, the probability that [symbol] wins the following game is at most 1/2+μ(λ):
For security parameter λ, [symbol] (1^{λ}, z) outputs a pair of values m₀, m₁ ∈{0, 1}^{α(λ)}. The challenger on input m_{b}, for a randomly chosen bit b∈{0, 1}, outputs a commitment to m_{b}. [symbol] then outputs a bit b′ and wins iff b′=b.
T-Extraction: There exists a deterministic algorithm that runs in time T(λ)·p(λ) for some polynomial p(⋅) such that on input any string c∈{0, 1 [symbol] , outputs val(c) where

$$val ( c ) = m ⇔ ∃ r ∈ {\{ 0 , 1 \}}^{{ℓ}_{r} ( λ )} s . t . c = Com ( m ; r ) .$$

### 2.3 Non-Interactive Zero Knowledge (NIZK)

Let L be an NP language and let R_{L} be its associated relation. For (x, g)∈R_{L} we sometimes denote x the statement and w its associated witness.
Definition 2.1. Let L∈NP and let R_{L} be the corresponding NP relation. A triple of algorithms Π=(GenCRS, Prove, Verify) is called non-interactive zero knowledge (NIZK) argument for L if it satisfies:
Perfect Completeness: For all security parameters λ∈ [symbol] and for all (x, w)∈R_{L},

$$Pr [ Verify ( CRS , x , π ) = 1 : CRS ← GenCRS ( {1}^{λ} ) ; π ← Prove ( CRS , x , w ) ] = 1.$$

Computational Adaptive Soundness: For every PPT prover P*, there exists a negligible function μ(⋅) such that for all λ∈ [symbol] :

$$Pr [ {Soundness}_{Π , {P}^{*}} ( λ ) = 1 ] \leq μ ( λ ) ,$$

where the random variable Soundness_{Π,P*}(λ) is defined as follows:
   1. CRS←GenCRS(1^{λ}),
   2. (x, π)←P*(λ, CRS),
   3. The output of the experiment is 1 if x∉L∧Verify(CRS, x, π)=1.
When this probability is 0, we say that Π is perfectly sound.
Computational Zero-Knowledge: There exists a PPT simulator [symbol] =( [symbol] ₁, [symbol] ₂) where [symbol] ₁(1^{λ}) outputs (CRS [symbol] , τ) and [symbol] ₂(CRS [symbol] , τ, x) outputs Π [symbol] such that for all non-uniform PPT adversaries [symbol] :

$$\{ {𝒜}^{{𝒪}_{1} ( CRS , . , . )} ( CRS ) : CRS ← GenCRS ( {1}^{λ} ) \} {\approx }_{c} {𝒜}^{{𝒪}_{2} ( {CRS}_{𝓈 , τ , . , .} )} ( {CRS}_{𝒮} ) : ( {CRS}_{𝒮} , τ ) ← {𝒮}_{1} ( {1}^{λ} ) \}$$

where [symbol] ₁, [symbol] ₂ on input (x, w) first check that (x, w)∈R_{L}, else output ⊥. Otherwise [symbol] ₁ outputs Prove(CRS, x, w) and [symbol] ₂ outputs [symbol] ₂(CRS [symbol] , τ, x).

### 2.4 Witness Indistinguishable (WI) Arguments

Definition 2.2 (Witness Indistinguishable Argument). Let L be an NP language, and let R_{L} be its associated relation. We say that a delayed-input two-message argument system WI=(V₀, P, V₁) is witness distinguishable for L∈NP, if the following properties hold:
Perfect Completeness: For every (x, w)∈R_{L} and every wi₁∈[V₀(1^{λ})]

$$Pr [ {V}_{1} ( x , {wi}_{1} , P ( x , w , {wi}_{1} ) ) = 1 ] = 1.$$

(Two Rounds) Soundness: We say that a delayed-input two-message argument system Π=(V₀, P, V₁) achieves (two-rounds) soundness if for every PPT algorithm (corrupted prover) P* there exists a negligible function μ(⋅) such that:

$$Pr [ 2 {RndSND}_{Π , {P}^{*}} ( λ ) = 1 ] \leq μ ( λ )$$

where the random variable 2RndSND_{Π,P*}(λ) is defined as follows:
   1. m₁←V₀(1^{λ}),
   2. (x*, m₂)←P*(m₁),
   3. The outputs of the experiment is 1 if V₁(x*, m₁, m₂)=1 and x* ∉L.
We say that Π=satisfies T-soundness for some T: [symbol] → [symbol] if the above also holds for P* that run in time T(λ)·p(λ) for some polynomial p(⋅).
Witness Indistinguishability: For every polynomially bounded function s and every polynomial-time non-uniform adversary [symbol] there exists a negligible function μ(⋅) such that every auxiliary input z∈{0, 1}*, the probability that [symbol] wins the following game is at most 1/2+μ(λ):
For security parameter λ, [symbol] (1^{λ}, z) outputs an instance x∈L∩{0, 1} [symbol] ^{λ}, witnesses w₀, w₁ such that (x, w₀) and (x, w₁) belong to R_{L} and the first message wi₁. The challenger on input w_{b}, for a randomly chosen bit b∈{0, 1}, sends wi₂ to [symbol] where wi₂←P(x, w_{b}, wi₁). [symbol] then outputs a bit v′ and wins iff b′=b.

### 3 Two Round Advice ZK Arguments for NP

In this section, we build a two round argument system for NP that satisfies advice zero-knowledge. Our construction follows the Fiat-Lapidot-Shamir (FLS) paradigm where: (a) the verifier's message sets up a secret trapdoor, and (b) the prover's message contains a WI proof showing either that the given statement is true or that it knows some trap door. Section 3.1 defines advice zero-knowledge, Section 3.2 gives an abstraction of the verifier's trapdoor-generation protocol, and Section 3.3 contains our two-round argument with formal security proofs in Section 3.4 (soundness) and Section 3.5 (advice-ZK).

### 3.1 Defining Advice ZK for Two Round Arguments

Definition 3.1. Let L be an NP language, let R_{L} be its associated relation and let S be some super-polynomial function. We say that a two-message argument system H (V₀, P, V₁) satisfies S-advice ZK if for every non-uniform PPT algorithm V*, there exists a PPT algorithm [symbol] and an S(λ)-time computable advice distribution Π such that the distributions REAL_{V,Π} and [symbol] are computationally indistinguishable:

### REAL_{V*,Π}(λ):

1. On input 1^{λ}, V* sends the first message

$${zk}_{1}^{*} .$$

2. V* chooses statements adaptively until halting, and the experiment outputs its view upon halting:
   (a) V* outputs x. If x∉L, reply with ⊥, else let w be a witness for x.
   (b) Compute the second message

$$z {k}_{2} ← Prove ( {zk}_{1}^{*} , x , w )$$

Band give V*.
IDEAL [symbol] _{,Π,} [symbol] (λ):
   1. On input 1^{λ}, V* sends the first message

$${zk}_{1}^{*} .$$

2. Sample an advice string d from the distribution

$$𝒟 ( {1}^{λ} , {zk}_{1}^{*} )$$

in S(λ) time.
3. V* chooses statements adaptively until halting, and the experiment outputs its view upon halting:
   (a) V* outputs x. If x∉L, reply with ⊥, else let w be a witness for x.
(b) Run

$$𝒮 ( {1}^{λ} , {zk}_{1}^{*} , x , d )$$

and give it to V*. Note that w is not used in this computation.

We emphasize that sampling from the advice distribution [symbol] is not efficient as it requires [symbol] time, a-priori fixed super-polynomial function. However, upon given a sample from [symbol] , the simulator must run in polynomial time. Philosophically, our notion ensures that whatever the adversary could have learnt from multiple interactions, it could have efficiently computed on its own after a one-time [symbol] time preprocessing of the language. Comparatively, the notion of superpolynomial simulation (SPS)-ZK allows the simulator to perform superpolynomial time computations for every statement. In this sense, our notion implies SPS-ZK with an S-time simulator with the advice distribution [symbol] and the advice ZK simulator [symbol] acting as a single SPS simulator. In some cases though it may be qualitatively better. E.g., consider languages where (a) statements have unique witnesses, and (b) witnesses can be brute-forced in some superpolynomial time S. Here, for SPS-ZK with an [symbol] time simulator, a perfectly acceptable solution is to send the witness in the clear as the proof; the [symbol] time simulator can brute-force for it during simulation. Whereas this is not possible for S-advice ZK as the [symbol] time computation (i.e., sampling from the advice distribution) happens even before the instance is known.

Remark 3.2. Note that the adversary V* can only choose statements x. The corresponding witness w given to the honest prover in the real experiment is computed via brute force. Our definition requires indistinguishability of the two experiments irrespective of how and which witness is computed.

### 3.2 Trapdoor Generation

Towards constructing two round advice ZK argument, we consider a trapdoor generation scheme which is a tuple of four algorithms (TDGen, TDCheck, TDValid, TDSol) with the following syntax:
1. TDGen(1^{λ}) is a randomized PPT algorithm that on input the security parameter A outputs an element y∈ [symbol] .
2. TDCheck(x, y) is a deterministic PPT algorithm that on input elements x∉ [symbol] and y∈ [symbol] , outputs a bit b∈{0, 1}.
3. TDValid(y) is a deterministic PPT algorithm that on input element y∈ [symbol] , outputs a bit b∈{0, 1}.
4. TDSol(y) is a deterministic algorithm (possibly inefficient) that on input element y∈ [symbol] , outputs an element x′∈ [symbol] .
   We require the following properties:
1. For every λ∈ [symbol] we have that TDValid (TDGen(1^{λ}))=1.
2. For every λ∈ [symbol] and every y∈ [symbol] , TDValid(y)=1 iff there exists an x ∈ [symbol] such that TDCheck(x,y)=1.
3. T-hardness: For every T-sized family of circuits A={A_{λ}}_{λ} there exists a negligible function μ such that for all λ∈

[symbol]

$$Pr [ TDCheck ( {x}^{′} , y ) = 1 : y ← TDGen ( {1}^{λ} ) , {x}^{′} ← {A}_{λ} ( y ) ] \leq μ ( λ ) .$$

4. S-solvability: TDSol is an S(λ)-time algorithm such that for every λ∈ [symbol] ,

$$Pr [ TDCheck ( {x}^{′} , y ) = 1 : y ← TDGen ( {1}^{λ} ) , {x}^{′} = TDSol ( y ) ] = 1.$$

In Section A, we provide instantiations from one-way functions with efficiently recognizable range and collision-resistant hash functions.

### 3.3 Construction of Two Round Advice ZK Argument

Tools. Let L be some NP language and R_{L} be its associated relation. Let T, S: [symbol] →N be some super-polynomial functions. The construction of two-round advice ZK argument for L is based on the following building blocks:
A T-hard, S-solvable trapdoor generation protocol TD (TDGen, TDCheck, TDValid).
A perfectly binding and T-extractable non-interactive commitment Corn (Section 2.2).
A delayed-input, two-message, T-sound and publicly-verifiable, witness indistinguishable argument (Section 2.4) WI (V₀, P, V₁) for the language:

$${L}_{WI} = \{ ( x , {s}_{out} , c ) \vert ∃ ( w , r , {s}_{i n} ) s . t . ( x , w ) ∈ {R}_{L} ⋁ ( TDCheck ( {s}_{i n} , {s}_{out} ) = 1 ∧ c = Com ( {s}_{i n} , r ) ) \} .$$

Construction. In our construction, the verifier runs TDGen to compute sₒᵤₜ, and sends it along with the first message of the WI argument. Then, upon input a statement-witness pair (x, w), the prover computes a commitment c to 0 and proves, using the WI argument, that either (x, w)∈L or c is a commitment to a valid pre-image of sₒᵤₜ.

### Construction 3.3: Two-Round Advice ZK Argument

$${V}_{0}^{zk} ( {1}^{λ} ) :$$

1. Sample sₒᵤₜ←TDGen(1^{λ})
2. Sample the first message wi₁←WI.V₀(1^{λ}) of the WI protocol
3. Output zk₁ (sₒᵤₜ, wi₁).
   p^{zk}(1^{λ}, x, w, zk₁):
1. Parse zk₁ as (sₒᵤₜ, wi₁)
2. If TDValid(sₒᵤₜ)≠1 then abort and output ⊥
3. Compute a commitment c=Com(0; r) using randomness r←{0, 1}^{poly(λ)}.
4. Compute wi₂←WI.P((x, sₒᵤₜ, c), (w, ⊥, ⊥), wi₁).
5. Output zk₂ (c, wi₂).

$${V}_{1}^{zk} ( {1}^{λ} , x , ( {zk}_{1} , {zk}_{2} ) ) :$$

1. Parse zk₁ as (sₒᵤₜ, wi₁), and zk₂ (c, wi₂).
2. Accept iff WI.V₁((x, sₒᵤₜ, c), (wi₁, wi₂))=1.
   Before proceeding to the formal theorem, we highlight that:
1. The construction is two-message (verifier to prover; prover to verifier).
2. Delayed-input: the first message of the verifier is independent of the instance.
3. Publicly verifiable: The verifier does not store a secret state after its first message. The decision to accept/reject depends only on the transcript.
   Theorem 3.4. Let L be an NP language, and T(⋅), S(⋅) be super-polynomial functions. Assume (TDGen, TDCheck, TDValid) is T-hard and S-solvable, Corn is a T-extractable non-interactive commitment scheme, and WI (V₀, P, V₁) is a two-message delayed-input, publicly-verifiable, witness-indistinguishable T-adaptively sound argument for L_{WI}. Then, Construction 3.3 is a two-round delayed-input, publicly-verifiable argument for L with T-adaptive soundness and S-advice ZK.

Before proving Theorem 3.4, we make some remarks. Recently, Kuykendall and Zhandry built a two round witness-hiding argument from perfectly sound non-interactive witness-indistinguishable proofs (NIWIs) and subexponentially-secure injective one-way functions with efficiently recognizable codomain. In comparison, instantiating trapdoor generation protocol with one-way functions with efficiently recognizable range, we get a two-round advice ZK construction from two-round WI adaptively-sound arguments and subexponentially-secure non-interactive commitments and one-way functions with efficiently recognizable codomain. This is an improvement over prior work as (a) advice ZK implies the witness-hiding notion considered in that work, (b) we require two-round WI arguments as opposed to NIWI proofs. Also, our framework allows for more instantiations including from only post-quantum assumptions: trapdoor generation protocol from T-secure collision-resistant hash functions based on subexponential SIS, and T-extractable non-interactive commitments and two-round delayed-input publicly-verifiable WI arguments from subexponential LWE.

Proof of Theorem 3.4. First, note that completeness is straightforward. Secondly, the delayed-input and public-verifiability properties are inherited directly from the underlying WI protocol. We give formal proofs for the soundness and advice ZK properties in Section 3.4 and Section 3.5 respectively, which together will conclude the proof of Theorem 3.4.

### 3.4 Proof of Soundness

Lemma 3.5. The construction 3.3 is T-sound.
Proof. We will show that every non-uniform adversary P* running in time T(λ)·poly(λ) there exists a negligible function μ(⋅) such that:

$$P r [ 2 {RndSND}_{ZK , {P}^{*}} ( λ ) = 1 ] \leq μ ( λ ) .$$

To show this we consider the following two hybrids:
Hyb₀: This is the soundness security game played by P*. In particular,
   1. The challenger in the soundness game first honestly samples the first verifier message zk₁ (sₒᵤₜ, wi₁) as specified in 3.3.
   2. Run P* (1^{λ}, zk₁) to get (x, zk₂).
   3. Parse zk₂ (c, wi₂).
   4. The output of the hybrid is 1 iff x∉L and (wi₁, wi₂) is accepted by the WI verifier on the statement (x, sₒᵤₜ, c).
Hyb₁: This hybrid is identical to Hyb₀, except that we change the winning condition for P*: The output of the hybrid is 1 iff Hyb₀=1 and the commitment c is a commitment to sᵢₙ for which TDCheck(sᵢₙ, sₒᵤₜ)=0.

For a fixed corrupted T-time prover P* denote by Pb the probability that P* wins Hyb_{b}, for b∈{0, 1}. We have the following claims:

Claim 3.6. Assuming that TD is a trapdoor generation protocol which satisfies T-hardness, and Com is a perfectly binding T-extractable commitment scheme. For every corrupted T-time prover P* there exists a negligible μ(⋅) such that p₀−p₁≤μ(λ).
Proof. Let sᵢₙ, r be the opening of the commitment c sent by P*. P* is invoked on zk₁ and outputs (x, zk₂). We have that:

$$\begin{matrix}{p}_{0} = Pr [ ( x ∉ L ∧ {V}_{1}^{z k} ( x , {zk}_{1} , {zk}_{2} ) = 1 ) ∧ ( TDCheck ( {s}_{out} , {s}_{i n} ) = 0 VTDCheck ( {s}_{out} , {s}_{i n} ) = 1 ) ] \\ = Pr [ ( x ∉ L ∧ {V}_{1}^{z k} ( x , {zk}_{1} , {zk}_{2} ) = 1 ) ∧ TDCheck ( {s}_{out} , {s}_{i n} ) = 0 ] + \\ Pr [ ( x ∉ L ∧ {V}_{1}^{z k} ( x , {zk}_{1} , {zk}_{2} ) = 1 ) ∧ TDCheck ( {s}_{out} , {s}_{i n} ) = 1 ] \\ = {p}_{1} + P r [ ( x ∉ L ∧ {V}_{1}^{z k} ( x , {zk}_{1} , {zk}_{2} ) = 1 ) ∧ TDCheck ( {s}_{out} , {s}_{i n} ) = 1 ] .\end{matrix}$$

Assume towards a contradiction that p₀−p₁≥ϵ(λ) for some non-negligible ϵ(⋅). We show that P*can be used to construct a T-time adversary [symbol] for the T-hardness game of the trapdoor generation protocol TD: Upon a given input y←TDGen(1^{λ}), [symbol] computes wi₁←WI.V₀(1^{λ}) and parses zk₁ (y, wi₁). It runs P*(zk₁) and obtains its output (x, zk₂). It parses zk₂ (c, wi₂) and extracts (sᵢₙ, r) from c with brute-force in time T(λ)·p(λ) for some polynomial p. [symbol] outputs sᵢₙ.

[symbol] runs in time T(λ)·q(λ) for some polynomial q(⋅). From the binding property of Com, sᵢₙ is indeed the unique value of c. Moreover, [symbol] perfectly simulates 2RndSND_{ZK,P}*(λ) for P* and therefore with probability at least ϵ(λ), A breaks the T-hardness of TD.

Claim 3.7. By the T-adaptive computational soundness of the WI argument, there exists a negligible function μ such that p₁≤μ(λ).
Proof. Assume there exists a corrupted T-time prover P* which wins in Hyb₁ with non-negligible probability. We show that P* can be used to construct a corrupted T-time prover P_{WI} that breaks the soundness property of WI: Upon an honestly generated input wi₁, P_{WI} computes sₒᵤₜ←TDGen(1^{λ}) and parses zk₁=(sₒᵤₜ,wi₁). It runs P*(zk₁) and obtains its output (x, zk₂ (c, wi₂)). P_{WI} outputs ((x, sₒᵤₜ, c), wi₂).

P_{WI} perfectly simulates P* in Hyb₁. Therefore, if P* wins Hyb₁, we have with probability at least c(X) that x∉L, WI.V₁ ((x, sₒᵤₜ, c), zk₁, zk₂)=1 and TDCheck(sᵢₙ, sₒᵤᵣ)=0 where sₒᵤₜ is the unique de-commitment value of c (this is by the definition of Hyb₁ and the binding property of Corn). This implies that with non-negligible probability ϵ(λ), (x, sₒᵤₜ, c)∉L_{wi} and WI.V₁ ((x, sₒᵤₜ, c), wi₁, wi₂)=1, which breaks the soundness property of WI.

Combining Theorem 3.6 and Theorem 3.7 we have that there exists a negligible function μ(⋅) such that p₀≤μ. This concludes the proof of Theorem 3.5.

### 3.5 Proof of Advice ZK

Lemma 3.8. The construction 3.3 is S-advice ZK as per Theorem 3.1.
Proof. We will show that for every non-uniform PPT adversary V* there exists an S-time computable advice distribution [symbol] and a PPT simulator [symbol] such that for every (x, w)∈R_{L} the distributions REAL_{V*,Π}(λ) and [symbol] (λ) defined in Theorem 3.1 are computationally indistinguishable.

We first define the advice distribution [symbol] and the simulator [symbol] :

Recall that in the [symbol] (λ), V* first outputs zk₁, and then the advice distribution outputs some string d that would help the simulator. Advice Distribution [symbol] (1λ, zk₁):
1. Parse zk₁ (sₒᵤₜ, wi₁).
2. If TDValid(sₒᵤₜ)≠1: set sᵢₙ=⊥.
3. Else: set sᵢₙ=TDSol(sₒᵤₜ).
4. Output sᵢₙ.
   Simulator [symbol] (1^{λ}, zk₁, x, d):
1. Parsed d=sᵢₙ.
2. If sᵢₙ ⊥, then send the prover message ⊥ to V* and output its view.
3. Otherwise, parse zk₁ (sₒᵤₜ, wi₁).
4. Compute a non-interactive commitment c=Com(sᵢₙ; r) to sᵢₙ using randomness r←{0, 1}^{poly(λ)}.
5. Compute wi₂ using (sᵢₙ, r) as the witness. That is, wi₂←WI.Pfove((x, sₒᵤₜ, C), (⊥, sᵢₙ, r), wi₁).
6. Send (x, zk₂ (c, wi₂)) to V* and output its view.

First, note that sampling from [symbol] can be computed by an S-time algorithm as TDSol is an S-time algorithm. Next, to show that the view of the adversary is computationally-indistinguishable in both executions REAL_{V*,Π} and [symbol] consider the adversary V*, and let zk₁ be its first message. Run d← [symbol] (1^{λ}, zk₁). We show that its view in each iteration is computationally-indistinguishable. Specifically, let (x, w) be the instance that the adversary outputs in the current iteration such that R_{L}(x, w)=1. Consider the following sequence of distributions G₀, G₁ and G₂:
Distribution G₀(λ, zk₁, x, w, d): This distribution is identical to the view of the adversary in the current iteration in the real. In particular,
   1. Parse zk₁ (sₒᵤₜ, wi₁.
   2. Compute the prover message P^{zk}(x, w, zk₁) honestly by first computing a commitment c to 0 and then computing wi₂ for the statement (x, sₒᵤₜ, c) using the witness w.
   3. Send (x, c, wi₂) to V*
Distribution G₁ (×, zk₁, x, w, d): Parse d=sᵢₙ. This game is identical to distribution G₀, except that the commitment c inside P^{zk}(x, w, zk₁) is computed for sᵢₙ instead of being a commitment to 0 as in G₀. That is, c=Com(sᵢₙ; r) for a random r←{0, 1}^{poly(λ)}.
Distributions G₂(λ, zk₁, x, w, d): We further modify P^{zk}(x, w, zk₁). Now, wi₂ is generated using the witness (sᵢₙ, r) where r is the random coins used to compute the commitment c. Note that the proof that the verifier receives is the output of [symbol] (1^{λ}, zk₁, x, d).

We show that the distributions G₀ and G₂ are computationally indistinguishable. First, we show that G₀ and G₁ are computationally indistinguishable due to the non-uniform hiding of the commitment scheme and G₁ and G₂ are indistinguishable due to the non-uniform witness indistinguishability of the WI scheme. To conclude the proof, we remark that once the view of the adversary in some particular distribution is computationally-indistinguishable then its output (i.e., the instance (x, w)) is also computationally-indistinguishable, as follows from a simple hybrid argument.

Claim 3.9. By the non-uniform hiding of the commitment scheme, the distributions G₁ and G₂ are computationally indistinguishable.
Proof. Note that the only difference between G₂ and G₁ is how the commitment c is generated. Specifically, notice that in G₁, c is a commitment to 0 whereas in G₂, c is a commitment sᵢₙ. Let us assume for contradiction that there exists some PPT distinguisher D, a polynomial p(⋅) such that for infinitely many λ∈ [symbol] , D distinguishes the two distributions with advantage 1/p(n).

By a standard averaging argument, there exists a 1/2p(n) fraction of the outputs d of the advice distribution [symbol] , such that, conditioned on such a d occurring in both G₁ and G₂, D's advantage in distinguishing the two distributions is at least 1/2p(n). Fix one such d=( [symbol] , sᵢₙ). Then, using d we build a non-uniform adversary B that breaks the hiding of the commitment scheme with advantage 1/2p(n).

Specifically, B is given d, x, w as non-uniform advice. Recall that d=( [symbol] , sᵢₙ) where r [symbol] is random coins of [symbol] and TDCheck(sᵢₙ, sₒᵤₜ)=1 where sₒᵤₜ is defined by r [symbol] . Let (sₒᵤₜ, wi₁) be the output of [symbol] run with coins r [symbol] . B then gives the commitment challenger the message m₀=0 and m₁=sᵢₙ and receives a commitment C to m_{b} for a randomly chosen b. It then computes wi₂ for the statement (x, c) by using the witness w. It runs [symbol] on inputs (x, c, wi₂) to generate the view of [symbol] . As its guess for the challenge bit b, it outputs whatever D outputs on the view of [symbol] .

First note that B runs in polynomial time. Second, note that when the commitment challenge bit b is 0, then B perfectly emulates game G₁ for [symbol] conditioned on d being the output of the advice distribution. When b=1, B perfectly emulates game G₂ for [symbol] conditioned on d being the output of the advice distribution. Since, conditioned on d being the output of [symbol] , the distinguisher D distinguishes the two distributions with advantage 1/2p(n), we have that B breaks the non-uniform hiding of the commitment scheme with advantage 1/2p(n).

This contradicts the non-uniform hiding of the commitment scheme.

Claim 3.10. By the non-uniform witness-indistinguishability of the WI argument, the distributions G₂ and G₃ are computationally indistinguishable.
Proof. Note that the only difference between G₂ and G₃ is the witness used in computing the WI proof. Specifically, notice that in G₂, the WI proof is computed using the witness w for the statement x whereas in G₃ the WI proof is computed using the witness (sᵢₙ, r). Let us assume for contradiction that there exists some PPT distinguisher D, a polynomial p such that for infinitely many λ∈ [symbol] , D distinguishes the two distributions with advantage 1/p(n).

By a standard averaging argument, there exists a 1/2p(n) fraction of the outputs d of the advice distribution [symbol] , such that, conditioned on such a d occurring in both G₁ and G₂, D's advantage in distinguishing the two distributions is at least 1/2p(n). Fix one such d= [symbol] , sᵢₙ). Then, using d we build a non-uniform adversary B that breaks the hiding of the commitment scheme with advantage 1/2p(n).

Specifically, B is given d, x, w as non-uniform advice. Recall that d=( [symbol] , sᵢₙ) where [symbol] is random coins of [symbol] and TDCheck(sᵢₙ, sₒᵤₜ)=1 where sₒᵤₜ is defined by [symbol] . Let (sₒᵤₜ, wi₁) be the output of [symbol] run with coins [symbol] . B then computes a non-interactive commitment c to sᵢₙ using randomness r. B then forwards to the witness-indistinguishability challenger the statement (x, sₒᵤₜ, c) as well as the two witnesses w₀=w and w₁=(sᵢₙ, r). B then receives wi₂ computed using the witness w_{b} for a randomly chosen bit b. It runs [symbol] on inputs (x, c, wi₂) to generate the view of [symbol] As its guess for the challenge bit b, it outputs whatever D outputs on the view of [symbol] .

First note that B runs in polynomial time. Second, note that when the commitment challenge bit b is 0, then B perfectly emulates game G₂ for [symbol] conditioned on d being the output of the advice distribution. When b=1, B perfectly emulates game G₃ for [symbol] conditioned on d being the output of the advice distribution. Since, conditioned on d being the output of [symbol] the distinguisher D distinguishes the two distributions with advantage 1/2p(n), we have that B breaks the non-uniform witness-indistinguishability of the WI argument with advantage 1/2p(n).

Combining Theorem 3.9 and Theorem 3.10, concludes the proof of Theorem 3.8.

### 4 Subversion Advice-ZK NIZKs

In this section, we first give the formal definition of an subversion advice-ZK NIZK in Section 4.1. Then, in Section 4.2 we proceed to give our construction which converts any NIZK for NP into a subversion advice-ZK NIZK for NP while relying on two-round advice zero-knowledge arguments from Section 3.3.

### 4.1 Defining Subversion Advice-ZK NIZKs

Definition 4.1. Let L be an NP language, and let R_{L} be its associated relation. Let S be some super-polynomial function. A NIZK argument H (GenCRS, Prove, Verify) for L is an S-subversion advice-ZK NIZK if for every non-uniform PPT adversary [symbol] , there exists a PPT [symbol] and an S(⋅)-time computable advice distribution [symbol] such that the output of the following two distributions are computationally-indistinguishable:
REAL [symbol] _{,Π}(λ):
1. Obtain CRS*← [symbol] (1^{λ}).
2. A chooses statements adaptively until halting, and the experiment outputs its view upon halting:
   (a) A queries on x. If x∉L, [symbol] receives ⊥. Else, it receives π Prove(CRS*, x, w) where w is a witness for x.
      IDEAL [symbol] _{,Π,} [symbol] (λ):
1. Obtain CRS*← [symbol] (1^{λ}).
2. Sample an advice string d from the distribution [symbol] (1^{λ}, CRS*) in S(1^{λ}₎ time.
3. [symbol] chooses statements adaptively until halting, and the experiment outputs its view upon halting:
   (a) [symbol] ⁺queries on x. If x∉L, [symbol] receives ⊥. Else, it receives π= [symbol] (1^{λ}, CRS*, x, d). Note that [symbol] does not use w.

### 4.2 Construction of Subversion Advice-ZK NIZKs

Tools. Let L be an NP language and R_{L} be its associated relation. For T, S: [symbol] → [symbol] be some super-polynomial functions, we use the following building blocks, where each bullet is a different crypto-systems/algorithms, that we will use to a build a new cryptosystem that contains three algorithms (CRS generation, Prover, and Verifier)
A delayed-input two-message publicly-verifiable S-advice ZK argument ZK=(V₀, P, V₁) (Theorem 3.1) with perfect completeness and T-adaptive soundness for L.
A non-interactive perfectly binding and T-extractable commitment Corn (Sec tion 2.2).
An adaptively-sound NIZK argument NIZK (GenCRS, Prove, Verify) (Theo rem 2.1) for the associated relation of the language

$${L}_{Inner} = \{ ( x , {zk}_{1} , c ) \vert ∃ ( {zk}_{2} , r ) s . t . ZK . {V}_{1} ( x , {zk}_{1} , {zk}_{2} ) = 1 ∧ c = Co m ( z {k}_{2} ; r ) \} .$$

We describe below the construction and the theorem (proven in Section 4.3).

### Construction 4.2: Subversion Advice-ZK NIZK H

### GenCRS(1^{λ}):

1. Generate CRSᵢₙₙₑᵣ←NIZK.GenCRS(1^{λ})
2. Compute zk₁←ZK.V₀(1^{λ}).
3. CRS=(CRSᵢₙₙₑᵣ, zk₁).
   Prove(CRS, x, w), where x∈{0, 1}^{λ}:
1. Parse CRS as (CRSᵢₙₙₑᵣ, zk₁).
2. zk₂←ZK.P(x, zk₁, w).
3. c=Com(zk₂; r) for a random r ∈{0, 1}^{poly(λ)}.
4. Compute π_{Inner}=NIZK.Prove(CRSᵢₙₙₑᵣ, (x, zk₁, c), (zk₂, r)).
5. Output π=(πᵢₙₙₑᵣ, c).

### Verify (CRS, x, π):

1. Parse CRS as (CRSᵢₙₙₑᵣ, zk₁) and π as (πᵢₙₙₑᵣ, c).
2. Output the decision of NIZK.Verify (CRSᵢₙₙₑᵣ, (x, zk₁, c), πᵢₙₙₑᵣ).
   Theorem 4.3. Let L be any NP language, let T, S: [symbol] → [symbol] be some superpolgnomial functions. Then, Π is an adaptively-sound S-subversion advice-ZK NIZK argument for L assuming
1. ZK is a delayed-input, publicly-verifiable two-message S-advice ZK argument with perfect completeness and T-adaptive soundness;
2. NIZK is an adaptively-sound NIZK argument system for the language Lᵢₙₙₑᵣ,
3. Corn be a non-interactive, perfectly binding, and T-extractable commitment.

### 4.3 Proof of Theorem 4.3

We show completeness, soundness and zero-knowledge, where the CRS is honestly gen-crated. This would show that Π is a NIZK. Moreover, we will show the subversion advice-ZK property, for the case of a maliciously generated CRS.
Perfect Completeness. Let (x, w)∈R_{L} and let π Prove(CRS, x, w). That is, π=(πᵢₙₙₑᵣ, c), where πᵢₙₙₑᵣ=NIZK.Prove(CRSᵢₙₙₑᵣ, (x, zk₁, c), (zk₂, r)) and zk₂←ZK.P(x, zk₁, w) and r is the randomness such that c Com(zk₂; r). From the completeness of the two-round advice ZK argument it holds that ZK.V₁ (x, zk₁, zk₂)=1. Thus, it holds that (zk₂, r) is a valid witness for (x, zk₁, c) in the inner language Lᵢₙₙₑᵣ. Then, from perfect completeness of the inner NIZK argument, we have that

$$Pr [ NIZK . Verify ( {CRS}_{Inner} , ( x , {zk}_{1} , c ) , {π}_{Inner} ) = 1 ] = 1.$$

Adaptive Soundness. We show that for every PPT corrupted prover P* there exists a negligible function μ(⋅) such that for every λ∈ [symbol] ,

$$Pr [ {Soundness}_{Π , {P}^{*}} ( λ ) = 1 ] \leq μ ( λ ) .$$

Towards that end, we consider the following hybrids:
Hyb₀: This is the real soundness game for Π played by P*. Recall that in this hybrid, an honestly generated CRS is chosen according to GenCRS(1^{λ}). Then the corrupted prover P* is invoked on CRS, and outputs a statement-proof pair (x*, π). The output of this hybrid is 1 if x* ∉L and Verify(CRS, x*, π) 1. Recall from the construction that CRS is to be parsed as the tuple (CRS_{Inner}, zk₁) and π is to be parsed as the tuple (π_{Inner}, c). Then, the winning condition can be stated more precisely as follows:

$${Hyb}_{0} outputs 1 if {x}^{*} ∉ L ∧ NIZK . Verify ( {CRS}_{Inner} , ( {x}^{*} , {zk}_{1} , c ) , {π}_{Inner} ) = 1.$$

Hyb₁: In this hybrid, we require a stronger winning condition. In particular, the winning condition is identical to Hyb₀ except that we additionally require that (x*, zk₁, c) be in the language L_{Inner}. In particular, this means that the value z\tilde{k}₂ val(c) committed inside c is an accepting second message for the statement x* w.r.t. the two-round argument verifier ZK.V₁. The winning condition can be more precisely stated as follows: Hyb₁ outputs 1 if (1) x* ∉L; (2) NIZK.Verify(CRS_{Inner}, (x*, zk₁, c), π_{Inner})=1; (3) NIZK.Verify(CRS_{Inner}, (x*, zk₁, c), π_{Inner})=1∧ZK.V₁(x*, zk₁, val(c))=1.

Let P* be a non-uniform PPT corrupted prover P*, and denote by p₂ the success probability of P* in Hyb₁ for i∈{0, 1}.

Claim 4.4. By the adaptive soundness of NIZK, for every non-uniform PPT corrupted prover P* there exists a negligible function μ₀(⋅) such that p₀−p₁≤μ₀(λ).
Proof. Assume there exists a corrupted prover P* and a non-negligible function ϵ(⋅) such that p₀−p₁≥ϵ(λ). We show that P* can be used to construct a cheating prover P_{NIZK} that breaks the adaptive-soundness of the NIZK for the language L_{Inner}: On input an honestly generated CRS_{Inner}, P_{NIZK} samples zk₁←ZK.V₀(1^{λ}) and sets CRS (CRS_{Inner}, zk₁). It then invokes P* on input CRS to receive (x*, π=(π_{Inner}, c)). It then outputs the statement (x*, zk₁, c) along with π_{Inner} as the proof.

To analyse the success probability of P_{NIZK}, first recall that by our assumption that p₀−p₁≥ϵ(λ), this implies that the output of P_{NIZK} is such that

$$Pr [ {x}^{*} ∉ L ∧ NIZK . Verify ( {CRS}_{Inner} , ( {x}^{*} , {zk}_{1} , c ) , {π}_{Inner} ) = 1 ∧ ZK . {V}_{1} ( {x}^{*} , z {k}_{1} val ( c ) ) \neq 1 \geq ϵ ( λ ) .$$

If ZK.V₁(x*, zk₁, val(c))≠1 then this implies that (x*, zk₁, c)∉L_{Inner}. Therefore, we have that

$$Pr [ ( {x}^{*} , {zk}_{1} , c ) ∉ {L}_{Inner} ∧ NIZK . {Verify}^{*} ( C R {S}_{Inner} , ( {x}^{*} , {zk}_{1} , c ) , {π}_{Inner} ) = 1 ] \geq ϵ ( λ ) .$$

This contradicts the adaptive-soundness of the NIZK.
Claim 4.5. By the T-adaptive soundness property of ZK and T-extractability of Com, for every non-uniform PPT corrupted prover P* there exists a negligible function μ₁(⋅) such that p₁≤μ₁(λ).
Proof. Assume there exists a corrupted prover P* and a non-negligible function ϵ(⋅) such that p₁≥ϵ(λ). We show that P* can be used to construct a T-time cheating prover P_{ZK} that breaks the T-adaptive-soundness of the two round ZK argument for the language L: On input the first message zk₁ of the two-round argument ZK, P_{ZK} samples CRS_{Inner} via NIZK.GenCRS(1^{λ}) and sets CRS=(CRS_{Inner}, zk₁). It then invokes P* on CRS to receive (x*, π=(π_{Inner}, c)) as the output. It then runs the T-time extractor for the commitment scheme Com to extract z\tilde{k}₂ from the commitment c, that is, z\tilde{k}₂ val(c). It then outputs the statement x* along with the second message z\tilde{k}₂.

To analyse the success probability of P_{ZK}, first recall that by our assumption that p₁≥ϵ(λ) we have that,

$$Pr [ {x}^{*} ∉ L ∧ NIZK . {Verify}^{*} ( C R {S}_{Inner} , ( {x}^{*} , {zk}_{1} , c ) , {π}_{Inner} ) = 1 ∧ ZK . {V}_{1} ( {x}^{*} , z {k}_{1} , val ( c ) ) = 1 ] \geq ϵ ( λ ) .$$

Then, by the perfect T-extraction of Com we have that z\tilde{k}₂ equals val(c). Therefore, the output (x*, z\tilde{k}₂) of P_{ZK} is such that

$$Pr [ {x}^{*} ∉ L ⋀ ZK . {V}_{1} ( {x}^{*} , {zk}_{1} , val ( c ) ) = 1 ] \geq ϵ ( λ ) .$$

This contradicts the T-adaptive soundness of the two round argument ZK.

Combining the above two claims, we conclude that for every non-uniform PPT corrupted prover P* there exists a negligible function μ: μ₀+μ₁ such that

$$Pr [ {Soundness}_{Π , {P}^{⋆}} ( λ ) = 1 ] \leq μ ( λ ) .$$

Zero Knowledge. We first give the zero-knowledge simulator [symbol] for Π. [symbol] samples a simulated CRS (CRS_{Inner}, zk₁) where CRS_{Inner} is generated using the zero-knowledge simulator [symbol] _{Inner} of NIZK and zk₁ is honestly generated using ZK.V₀. On each query x, [symbol] computes a commitment c to all zero strings, and runs Sinner to generate a simulated proof π_{Inner} for the statement (x, zk₁, c), and outputs π=(π_{Inner}, c).

We show zero-knowledge by considering the following three hybrids.
Hyb₀: This is the real world for the ZK property of Π. The adversary receives an honestly generated CRS, and on each query (x,w), the experiment checks that (x,w)∈R_{L}. If so, it replies with Prove(CRS, x, w). Otherwise, it replies with L. The output of the experiment is the view of the adversary.
Hyb₁: This hybrid is identical to Hyb₀ except we use the ZK simulator [symbol] ᵢₙₙₑᵣ to compute simulated proofs. More specifically, the simulator [symbol] generates CRS (CRS_{Inner}, zk₁), where CRS_{Inner} is generated by [symbol] _{Inner}, and zk₁ is honestly generated according to ZK.V₀(1^{λ}). On each query (x, w), the experiment checks that (x, w)∈R_{L}. If so, it first computes an accepting zk₂ by running ZK.Prove(x, zk₁, w) and then computes a commitment c to zk₂. It then runs [symbol] _{Inner} to generate a simulated proof π_{Inner} for the statement (x, zk₁, c), and returns π=(π_{Inner}, c).
Hyb₂: This hybrid is identical to Hyb₁ except that [symbol] , for every query, generates the commitment c as a commitment to the value 0. More specifically, the simulator generates CRS=(CRS_{Inner}, zk₁), where CRS_{Inner} is generated by [symbol] _{Inner}, and zk₁ is honestly generated according to ZK.V₀(1^{λ}). On each query (x, w), the experiment checks that (x, w)∈R_{L}. If so, it first computes an accepting zk₂ by running ZK. Prove(x, zk₁, w) and then computes a commitment c to zk₂. It then runs [symbol] _{Inner} to generate a simulated proof π_{Inner} for the statement (x, zk₁, c), and returns 7 (π_{Inner}, c).
   Claim 4.6. By the zero-knowledge property of NIZK and the perfect completeness of the two round argument ZK, the view of the adversary [symbol] in Hyb₀ and Hyb₁ are indistinguishable.
   Proof. Assume there exists such adversary [symbol] for which there exists a non-uniform PPT distinguisher [symbol] that can distinguish with non-negligible probability between [symbol] 's output in Hyb₀ and Hyb₁. We show that [symbol] can be used to construct a non-uniform PPT adversary [symbol] _{Inner} that breaks the zero-knowledge of NIZK: [symbol] _{Inner} receives CRS_{Inner} (generated by either NIZK.GenCRS(1^{λ}) or [symbol] _{Inner}(1^{λ})). It computes zk₁←ZK.V₀(1^{λ}) and sends CRS (CRS_{Inner}, zk₁) to [symbol] . On each query (x, w) that [symbol] makes to its oracle, [symbol] _{Inner} computes zk₂ as in Prove and then computes a commitment c to zk₂ using randomness r. It then queries its oracle on ((x, zk₁, c), (zk₂, r)). It receives the oracle's output π_{Inner} and sends (π_{Inner}, c) to [symbol] . It outputs [symbol] 's output.

First, by the perfect completeness of the two-round argument, we have that for any query (x, w)∈L by [symbol] , the query ((x, zk₁, c), (zk₂, r)) generated by [symbol] _{Inner} is such that (x, zk₁, c)∈L_{Inner} where (zk₂, r) is the witness. Now, D can be used as a distinguisher for NIZK: If [symbol] _{Inner} is interacting with the real experiment, then it perfectly simulates [symbol] in Hyb₀. If [symbol] _{Inner} is interacting with the [symbol] _{Inner}, then it perfectly simulates [symbol] in Hyb₁. Since D can distinguish between [symbol] 's output in both executions, then it distinguishes between [symbol] _{Inner}'s outputs between the real experiment and the simulated experiment with non-negligible probability as well, violating the zero-knowledge property of NIZK.

Claim 4.7. By the hiding of the commitment scheme Com, the view of the adversary [symbol] in Hyb₁ and Hyb₂ are indistinguishable.
Proof. Assume there exists such adversary [symbol] for which there exists a non-uniform PPT distinguisher D that can distinguish with non-negligible probability between [symbol] 's output in Hyb₁ and Hyb₂. We show that [symbol] can be used to construct a non-uniform PPT adversary B that breaks the hiding of Com:

B first computes CRS=(CRS_{Inner}, zk₁) as in Hyb₁. That is, CRS_{Inner} is computed by running [symbol] _{Inner} and zk₁ is computed honestly. On each query (x, w) that [symbol] makes to its oracle, B computes zk₂ as in Prove, and then forwards (zk₂, 0^{λ}) as the two challenge messages for the hiding game. Upon receiving the challenge commitment c* (which is either a commitment to zk₂ or to 0^{λ}), B runs Sinner on the statement (x, zk₁, c*) to generate a simulated proof π_{Inner}. It sends (π_{Inner}, c*) to [symbol] . It outputs [symbol] 's output. It then runs the distinguisher D on [symbol] 's view and outputs whatever it outputs.

If B is interacting with the challenger of the hiding game of Corn with challenge bit b=0, then it perfectly simulates [symbol] in Hyb₁. Otherwise, when b=1, then B perfectly simulates [symbol] in Hyb₂. Since D can distinguish between [symbol] 's output in both executions, then it distinguisher between the case of b=0 and b=1.

Subversion Advice-ZK NIZK. We show that for every PPT adversary [symbol] , there exists a PPT simulator [symbol] and an advice distribution [symbol] such that the distributions REAL [symbol] _{,Π}(λ) and IDEAL [symbol] _{,Π,} [symbol] (λ) defined in Theorem 4.1 are computationally indistinguishable.

We first give the description of the [symbol] and [symbol] . Towards this, it will be helpful to consider the following PPT adversary [symbol] _{ZK} for the advice −ZK property of ZK (V₀, P, V₁). In particular:
1. [symbol] _{ZK} runs [symbol] (1^{λ}) to generate CRS=(CRS_{Inner}, zk₁).
2. It forwards zk₁ as its first message.
3. For each iteration until [symbol] halts:
   (a) When [symbol] queries on (x, w), it outputs (x, w).
   (b) Then, upon receiving zk₂ from the challenger, it internally computes π_{Inner} identically to the honest prover algorithm Prove. In particular, it computes a commitment c to zk₂ using randomness r and then computes a NIZK proof for the statement (x, zk₁, c) using witness (zk₂, r).
   (c) It then sends π=(π_{Inner}, C) to A.
4. When [symbol] halts, [symbol] _{ZK} simply outputs [symbol] 's view.

Now, since ZK=(V₀, P, V₁) satisfies advice ZK, we know that for [symbol] _{ZK} as constructed above there exists an advice distribution [symbol] _{ZK} and [symbol] _{ZK} such that [symbol] (λ), and [symbol] (λ) (as defined in Theorem 3.1) are computationally indistinguishable. We will use [symbol] _{ZK} and [symbol] _{ZK} to define [symbol] and [symbol] respectively in a straightforward way.

Advice Distribution [symbol] (1^{λ}, CRS):
1. Sample an advice d_{ZK} from [symbol] _{ZK}(1^{λ}, CRS_{Inner}).
   2. Output d=d_{ZK}.
      Simulator [symbol] (1^{λ}, CRS, x, d):
1. Parse CRS=(CRS_{Inner}, x, zk₁) and d=d_{ZK}.
2. Run [symbol] _{ZK}(1^{λ}, CRS_{Inner}, x, d_{ZK}) to compute zk₂.
3. Abort if ZK.Verify(x, zk₁, zk₂)≠1.
4. Compute π_{Inner} like the honest prover algorithm Prove. That is, computes a commitment c to zk₂ using randomness r and then computes a NIZK proof for the statement (x, zk₁, c) using witness (zk₂, r).
5. Send (x, π=(π_{Inner}, c)) to [symbol] and output its view.

First note that since [symbol] _{ZK} can be computed by an S-time algorithm, we have that [symbol] also can be computed by an S-time algorithm. To conclude the proof we observe that [symbol] 's view in REAL [symbol] _{,Π}(λ) is identical to [symbol] _{ZK}'s view in [symbol] (λ) Similarly, [symbol] 's view in [symbol] (λ) is identical to [symbol] _{ZK}'s view in [symbol] (λ). Then, the proof follows by the computationally indistinguishability of [symbol] (λ) and [symbol] (λ).

### 5 Accountable Soundness

In this section, we define accountable soundness for any non-interactive argument system in the CRS model which captures both NIZKs and SNARGs.

There are two aspects to our definition, depending on whether the CRS is honestly or maliciously generated. When the CRS is honestly generated, we require that the scheme satisfies the same traditional security requirements (e.g., either be a NIZK or a SNARG). In the latter case, we want to prevent the authority from running a service in which it provides accepting proofs for (either valid or invalid) statements without receiving the corresponding witness. If it does run such a service, we should be able to implicate the malicious authority for its wrongdoing. We define an extractor that interacts with the malicious authority and comes up with a piece of evidence T that can be presented to a Judge, defined by a Judge algorithm, who verifies whether the presented piece of evidence is valid. At the same time, we require that no efficient adversary can compute a piece of evidence that can falsely accuse an honest authority.

Consider a non-interactive argument system consisting of a triplet of algorithms Π=(GenCRS, Prove, Verify). In addition, we define a PPT algorithm Judge, which is necessary to define accountable soundness for maliciously
b←Judge(CRS, τ) where b ∈{honest, corrupted}: The algorithm receives as input the (possibly corrupted) CRS and some transcript τ, and outputs a bit b, indicating whether the CRS CRS is corrupted of not.
   Definition 5.1 (Argument System with Accountable Soundness). Let L∈NP. We say that a non-interactive argument system Π=(GenCRS, Prove, Verify, Judge) for L achieves accountable soundness with respect to distribution [symbol] if all the following properties hold:
1. (Accountability: There exists a PPT extractor ε, such that for every (possibly stateful) PPT adversary [symbol] there is a negligible function μ(⋅) such that for all A:

$$\vert Pr [ AccSnd . {REAL}_{Π , 𝒜} ( λ ) = 1 ] - Pr [ AccSnd . {IDEAL}_{Π , 𝒜 , ℰ} ( λ ) = 1 ‖ \leq μ ( λ )$$

where random variables AccSnd. [symbol] (λ), AccSnd. [symbol] (λ) are:

| | |
|---|---|
| AccSnd. [symbol] (λ): | AccSnd.I [symbol] (λ): |
| | • CRS* ← [symbol] (1^{λ}); |
| • CRS* ← [symbol] (1^{^{λ}}); | • ε (CRS*) outputs some query x. |
| • x ← D(1^{λ}); | • The adversary [symbol] receives x and out- |
| • Query [symbol] on x and receive back a | puts a proof π. |
| proof π. | • Give π to ε which replies with τ. |
| • The output is 1 iff | • The output is 1 iff Judge(CRS*, τ) = |
| Verify(CRS*, x, π) = 1. | corrupted. |

2. (Defamation-free:) For every PPT adversary [symbol] , there exists a negligible function μ(⋅), such that for all λ∈ [symbol] :

$$Pr [ Judge ( CRS , τ ) = corrupted : CRS ← G e n C R S ( {1}^{λ} ) ; τ ← 𝒜 ( CRS ) ] \leq μ ( λ ) .$$

We next define NIZKs (resp., SNARGs) with accountable soundness.

Definition 5.2. A non-interactive argument system Π=(GenCRS, Prove, Verify, Judge) for any NP language Lis a NIZK (resp., SNARG) with accountable soundness w. r. t. distribution [symbol] if (GenCRS, Prove, Verify) is a NIZK (resp., SNARG) for L and it satisfies accountable soundness w.r.t. [symbol] .
Notation. For a distribution D over R_{L}⊆{0, 1}*×{0, 1}* (i.e., pairs of instances and their associated witnesses), we denote by M( [symbol] _{L}) the marginal distribution over the instances only where the distributions are parameterized by the security parameter.
Comparison with Ananth et al. Our definition is inspired by the definition of ac countability of Ananth et al. Their definition is with respect to an authority who helps others to open witnesses of proofs proven with respect to the maliciously generated CRS*. We highlight few differences from that prior definition:
Universal extractor: The prior definition requires that for every malicious authority [symbol] there exists an extractor, whereas we require a universal extractor that works for all possible malicious authorities. Ours is a stronger definition, and we believe it is more natural. Specifically, if one identifies that the authority misbehaves, our definition guarantees explicit instructions on how to hold the authority accountable, as opposed to the prior definition which only guarantees the existence of such instructions which may additionally depend on the specific code of the authority.
Probability of errors: The prior definition allows a gap between the probability that the adversary succeeds in the real, vs. the probability that the extractor succeeds to hold the authority accountable in the ideal. Specifically, it just requires that if the authority succeeds with some non-negligible probability in the real, then the extractor succeeds with some non-negligible probability in the ideal. The gap between the two might be large. We require that the gap between the two is only negligible.
   Constructions of Non-Interactive Arguments with Accountable Soundness
   In this section, we provide several constructions of non-interactive arguments with ac countable soundness. Section 6.1 gives a construction for languages in NP n co-N P and its generalization. But, this construction crucially relies on the ability to efficiently sample NO instances along with an efficiently checkable witness of non-membership. Towards capturing general languages, we discuss sparse languages in Section 6.2 and Section 6.3, and also give a general feasibility result for N P in Section 6.4. A particularly interesting aspect of our constructions is that we only add a (short) random string to the CRS of an non-interactive argument system, and do not change the prover and the verifier algorithms. Thus, our constructions preserve the privacy (e.g., ZK) and the efficiency (e.g., succinctness and prover/verifier time) properties of the underlying non-interactive argument.

### 6.1 Construction for Languages in NP∩TEXT Co-NP

Let L be a NP∩coNP language with relations R_{L} and R_{L} over L and its complement L̅ respectively. Let Π′=(GenCRS′, Prove′, Verify′) be any non-interactive argument system for L. We present the construction II below followed by the security theorem and its proof.
Construction 6.1: Non-Interactive Argument with Accountable Sndness
GenCRS(1^{λ}): Output CRS←GenCRS′(1^{λ}).

### Prove(CRS, x, w): Output π←Prove′(CRS, x, w).

Verify (CRS, x, π): Output b←-Verify′(CRS, x, π).
Judge (CRS*, π=(x*, π*, w̅*)):

$$Output b = corrupted iff Verify ( {CRS}^{*} , {x}^{*} , {π}^{*} ) = 1 ⋀ {R}_{\overline{L}} ( {x}^{*} , {\overline{w}}^{*} ) = 1.$$

Theorem 6.2. Let L be any NP∩coNP language, and R_{L} and R_{L̅} be the relations for L and its complement L̅. Let Π′=(GenCRS′, Prove′, Verify′) be a non-interactive adaptively sound argument for the language L. Then, the above construction II is a non-interactive argument system for L with accountable soundness w.r.t. any distribution) [symbol] over {0, 1}* for which there exists a distribution [symbol] _{No} over R_{L} such that the marginal distribution M( [symbol] _{No}) and [symbol] are computationally indistinguishable. Further, if Π′ is a NIZK (resp., SNARG) then Π is a NIZK (resp., SNARG) with accountable soundness for [symbol] .
Proof. The completeness and soundness properties hold by the completeness and sound ness of the non-interactive argument Π′. Moreover, GenCRS, Prove and Verify are identical to GenCRS′, Prove′ and Verify′ respectively. Therefore, if Π′ is a NIZK (resp., SNARG), then so is Π. Next, we show that the accountability and defamation free properties hold:
Accountability. We describe the extractor ε:
1. It receives (possibly maliciously generated) CRS* generated by the authority.
2. Sample (x, w̅) from [symbol] _{No}(1^{λ}).
3. Query [symbol] on x and receive back π.
4. Output τ=(x, w̅, π).
   We claim that the view of the malicious authority is indistinguishable between AccSnd.REAL and AccSnd.IDEAL. In AccSnd.REAL, the authority receives x sampled according to [symbol] . In the ideal, the extractor samples (x, w) according to [symbol] _{NO}, and then gives x to the authority. This is equivalent to sampling from M( [symbol] _{No}), and according to our assumption, M( [symbol] _{No})≈_{c} [symbol] .

We conclude that the authority provides a valid proof to the extractor query with probability negligibly close to the probability in the real experiment. Whenever the authority provides a valid proof in the ideal, the extractor provides τ that makes Judge accept, and the output of AccSnd.IDEAL is 1.

Defamation Free. We show that for an honestly generated CRS CRS←GenCRS(1^{λ}), no PPT adversary [symbol] can output τ=(x*, π*, w̅*) for which Judge accepts with non-negligible probability.

Suppose that there exists a PPT adversary, [symbol] and a non-negligible function ϵ(⋅) such that Pr[Judge(CRS, [symbol] (CRS)) corrupted]≥ϵ(×) for an honestly generated CRS←GenCRS(1^{λ}). We show that [symbol] can be used to construct a PPT corrupted prover P that breaks the adaptive soundness property of the inner NIZK system Π′=(GenCRS′, Prove′, Verify′) with non-negligible probability: Given an honestly generated CRS′←GenCRS′(1^{λ}) as an input, P sets CRS=CRS′ and runs [symbol] (CRS) to obtain it's output τ. It parses τ=(x*, π*, w̅*) and outputs (x*, π*).

First, since [symbol] is a PTT algorithm, then so is P. Second, P perfectly simulates [symbol] in the defamation-free experiment. Therefore, [symbol] outputs τ=(x*, πr*, w̅*) such that Pr[Judge(CRS, τ)=corrupted]≥ϵ(×). That is, Verify(CRS, x*, π*)=1 and (x*, w̅*)∈R_{L̅}. Thus, we have Verify(CRS, x*, π*)=Verify′(CRS, x*, π*)=1 and x*∉L. Overall, the following violates the adaptive soundness property of Π′:

$$Pr [ {Soundness}_{{Π}^{′} , P} ( λ ) = 1 ] = Pr [ {Verify}^{′} ( CRS , {x}^{*} , {π}^{*} ) = 1 ⋀ {x}^{*} ∉ L ] = Pr [ Verify ( CRS , {x}^{*} , {π}^{*} ) = 1 ⋀ {x}^{*} ∉ L ] = Pr [ Verify ( CRS , {x}^{*} , {π}^{*} ) = 1 ⋀ ( ∃ {\overline{w}}^{*} : ( {x}^{*} , {\overline{w}}^{*} ) ∈ {R}_{\overline{L}} ) ] \geq ϵ ( λ ) .$$

### 6.1.1 Generalization

The class NP∩coNP is both theoretically and practically relevant as it contains many interesting cryptographic languages. However, for a language L to be in NP∩coNP, all NO instances must have an efficiently checkable witness for non-membership in L. But Theorem 6.2's proof readily extends to languages L where only sufficiently large (but still only negligible fraction) of the NO instances have such a witness. More formally, Theorem 6.2's proof only requires the existence of a subset L_{No} of its complement L̅ along with an efficiently checkable relation R_{No} over L_{No}. In particular, we require that for any x: x∈L_{No} iff ∃w̅ s.t. R_{No}(x, w̅)=1. This is a strict generalization of NP∩coNP and it allows us to capture more languages.

Then, consider a minor modification of the construction H where the Judge algorithm uses the relation R_{No} instead of R_{L̅}. Then, this modified construction achieves accountable soundness for distributions [symbol] as long as there exist a computationally indistinguishable distribution [symbol] _{No} over R_{No}. We formalize this in the subsequent theorem whose proof is identical to that of Theorem 6.2.

Theorem 6.3. Let L be any NP language, R_{L} be the its relation. For L_{No}⊆L̅, let R_{No} be the its relation. Let Π′ be a non-interactive adaptively sound argument for L. Then, there exists a non-interactive argument system with accountable soundness w.r.t. any distribution [symbol] over {0,1}* assuming the existence of a distribution [symbol] _{No} over R_{No} such that the marginal distribution M( [symbol] _{No}) and [symbol] are computationally indistinguishable. Further, if Π′ is a NIZK (resp., SNARG) then Π is a NIZK (resp., SNARG) with accountable soundness for [symbol] .

### 6.1.2 Examples

We present examples of several languages beyond NP∩co-N P for which accountable soundness is achievable. A key feature of these languages is that the instances contain commitments/encryptions where the plaintext satisfies an efficiently verifiable relation (e.g., preimage of a one-way function). For such languages, we can exhibit L_{No} (and R_{No}) and [symbol] _{No} relying on semantic-security of the commitments/encryptions.
GMW Compiler on Yao's 2PC. The GMW compiler is a central compilation technique in cryptography that allows to upgrade any multi-party computation protocol with semi-honest security to malicious security. For simplicity, we discuss applying the GMW compiler to Yao's semi-honest secure 2PC protocol. Recall, Yao's protocol relies on a two-round oblivious transfer protocol (OT₁, OT₂, OT₃) where OT₁ (resp., OT₂) computes receiver's (resp., sender's) message, and the receiver uses 0T₃ to compute its output, and a garbled circuit Garble=(Gen, Eval). In the protocol, the receiver first generates and sends ot₁ on its input b∈{0, 1}, followed by the sender garbling the circuit C(x, ⋅) that has its input x hardwired and generating appropriate ot₂ w.r.t. the keys obtained by the garbling. To get malicious security, the sender also sends a NIZK proof for the following language that shows that the message is well-formed:

$${L}_{GMW} = \{ ( {ot}_{1} , {ot}_{2} , \hat{C} ) : ∃ ( x , {r}_{OT} , {r}_{GC} ) s . t . \begin{matrix}( C , {k}_{0} , {k}_{1} ) = Gen ( C ( x , \cdot ) ; {r}_{GC} ) \\ {ot}_{2} = {OT}_{2} ( {ot}_{1} , {k}_{0} , {k}_{1} ; {r}_{OT} )\end{matrix} \} .$$

This language may not be in NP∩co-N P as L̅_̅{̅G̅M̅W̅}̅ consists of strings (ot₁, ot₂, Ĉ) where Ĉ may be outside the range of the Gen algorithm for which no efficiently checkable witness may exist. However, consider the subset L_{No}⊆L̅_̅{̅G̅M̅W̅}̅containing tuples (ot₁, ot₂, Ĉ) where Ĉ garbles a constant function:

$${L}_{No} = \{ ( {ot}_{1} , {ot}_{2} , \hat{C} ) : ∃ ( b , r , x , {r}_{OT} , {r}_{GC} ) s . t . \begin{matrix}\begin{matrix}{ot}_{1} = {OT}_{1} ( b ; r ) ; z = C ( x , b ) ; \\ ( \hat{C} , {k}_{0} , {k}_{1} ) = Gen ( z ; {r}_{GC} )\end{matrix} \\ {ot}_{2} = {OT}_{2} ( {ot}_{1} , {k}_{0} , {k}_{1} ; {r}_{OT} )\end{matrix} \} .$$

The associated relation R_{No} takes an instance (ot₁, ot₂, Ĉ) and a witness (b, r, x, r_{OT}, r_{GC}), and verifies that Ĉ is indeed a garbling of the constant function that outputs z C(x, b). Given any NIZK for L_{GMW}, we can obtain another NIZK that achieves accountable soundness w.r.t. the uniform distribution [symbol] over L_{GMW}: the required distribution [symbol] _{No} is the uniform distribution over R_{L}_{_{No}}, and computational indistinguishability follows from the security of garbling.
ZCash's POUR transaction. The ZCash cryptocurrency uses ZK-SNARKs for privacy. ZK-SNARKs are NIZKs with short proofs and a polylogarithmic time verifier. In ZCash, such NIZKs are used for its POUR transaction that allows any user to pour the value of two of its coins

$$( {c}_{1}^{old} , {c}_{2}^{old} )$$

into two new coins while preserving the monetary value. Here, a user needs to generate its new coins

$${c}_{1}^{n e w} , {c}_{2}^{n e w}$$

and post hiding commitments to the description of these coins along with a NIZK proof that proves (among other things) (a) ownership of old coins

$${c}_{1}^{old} , {c}_{2}^{old} ,$$

(b) well formedness of new coins

$${c}_{1}^{n e w} , {c}_{2}^{n e w} ,$$

and (c) the total value in old coins and new coins are equal, that is,

$${v}_{1}^{n e w} + {v}_{2}^{n e w} = {v}_{1}^{old} + {v}_{2}^{old} .$$

At a high level, L_{No} contains instances which are identical except that the condition (c) is not satisfied. The hiding of the commitment scheme will ensure that random instances from L_{POUR} and L_{No} are indistinguishable.

A formal description of L_{POUR} is available in the literature; we only discuss a simpler abstraction below. The instances in L_{POUR} are tuples

$$( rt , s {n}_{1}^{old} , s {n}_{2}^{old} , {c}_{1}^{n e w} , {c}_{2}^{n e w} )$$

with the witness

$${\{ ( {path}_{i} , {c}_{i}^{old} , {r}_{i}^{old} , {v}_{i}^{old} , {r}_{i}^{n e w} , {v}_{i}^{n e w} , {sn}_{i}^{n e w} ) \}}_{i ∈ [ 1 , 2 ]}$$

where:
1. for both i∈{1, 2}:
   (a) pathᵢ is the Merkle membership proof for

$${c}_{i}^{old}$$

w.r.t. the Merkle root rt.
   (b)

$${c}_{i}^{old} = C o m ( s {n}_{i}^{old} ‖ {v}_{i}^{old} , {r}_{i}^{old} ) , {c}_{i}^{n e w} = C o m ( s {n}_{i}^{n e w} ‖ {v}_{i}^{n e w} ; {r}_{i}^{n e w} ) .$$

2.

$${v}_{1}^{old} + {v}_{2}^{old} = {v}_{1}^{n e w} + {v}_{2}^{n e w} .$$

Note that L_{POUR} may not be in NP∩coNP as L̅_̅{̅P̅O̅U̅R̅}̅ contains instances where strings c^{new} may be outside the range of Corn, and there may not be any efficiently checkable witness for this. However, let L_{No} be the subset of L̅_̅{̅P̅O̅U̅R̅}̅ that samples instances identically to L_{POUR} except that condition (2) doesn't hold for the new coins. One can verify that L_{No} has an efficient-to-compute relation R_{No}.

For accountable soundness, consider the distribution [symbol] that samples instances from L_{POUR} while using uniform randomness to compute c where [symbol] may choose values (and other attributes of the coins) arbitrarily. Then, we can transform any NIZK for L_{POUR} to additionally achieve accountable soundness for [symbol] : the required distribution [symbol] _{No} over R_{L}_{_{No}} is the uniform distribution, and the required computational indistinguishability follows from the hiding of Com. Recall that our compiler for achieving accountable soundness only adds the Judge algorithm without changing the underlying NIZK's CRS as well as Prove/Verify algorithms. Therefore, we can already upgrade ZK-SNARKs, currently implemented in ZCash, to satisfy accountable soundness.

Non-interactive Commitments. Let Com be any perfectly binding non-interactive commitment scheme. Then, consider the language L_{c,1}={c: ∃r s.t. c=Com(1; r)}. This language may not be in NP∩co-NP as L̅_̅{̅c̅,̅1̅}̅ also consists of strings outside the range of Com for which no efficiently checkable witness may exist. However, for L_{No}={c: ∃r s.t. c=Com(0; r)} there exists an efficiently checkable relation R_{No} such that for every c∈L_{No} there exists some witness r for which R_{No}(c, r)=1 (and vice versa). For accountable soundness, a particularly interesting distribution [symbol] is the uniform distribution over L_{c,1} for which the uniform distribution over R_{L}_{_{No}} satisfies the required computational indistinguishability due to the hiding of Corn.
Validity of Ciphertexts. Next, we consider the NP language that consists of well-formed ciphertexts where the plaintext satisfies a publicly-verifiable relation. NIZKs for such languages have appeared in several different applications including providing range proofs and building verifiable timed signatures. For simplicity, we choose to describe the language w.r.t. encryption schemes but our ideas would also extend to languages where that use primitives like commitments or time-lock puzzles in place of encryption schemes.

As mentioned above the language is parametrized by some PKE encryption scheme (KgGen, Enc, Dec) and a signature scheme (KgGen, Sign, Ver). The language is as follows:

$$L = \{ ( pk , vk , ct ) : ∃ ( m , σ , r ) : ct = Enc ( pk , m ‖ σ ; r ) ∧ Ver ( vk , m , σ ) = 1 \} .$$

This language may not be in NP∩co-NP as L̅ consists of strings (pk, vk, ct) where ct may be outside the range of the Enc algorithm for which no efficiently checkable witness may exist. However, consider the following subset L_{No}⊆L̅ which contains tuples (pk, vk, ct) where ct encrypts 0^{λ}:

$${L}_{N o} = \{ ( pk , vk , ct ) : ∃ r : ct = Enc ( pk , {0}^{λ} ; r ) \} .$$

For the above language, there does exists an associated relation R_{No} that on inputs a statement (pk, vk, ct) and a witness r outputs 1 iff the ct is an encryption of 0^{λ} using randomness r. For accountable soundness, consider the distribution [symbol] that samples instances from L while using randomness used to sample pk, vk and compute the ciphertext ct uniformly at random. In particular, [symbol] may choose the plaintext to be encrypted arbitarily. Then, we can transform any NIZK for L to additionally achieve accountable soundness for [symbol] : the required distribution [symbol] _{No} over R_{L}_{_{No}} is the uniform distribution and the required computational indistinguishability would follow from the semantic security of the PKE scheme.

Hash-time-lock Contracts. Hash-time-lock contracts (HTLC) are a type of smart contracts supported by Bitcoin and used in several blockchain applications. An HTLC allows a party to redeem a transaction containing some hash value h if they can produce a pre-image (under SHA256) of h. Such contracts along with NIZKs have recently found applications in zero-knowledge contingency payments to execute fair sale of N P secrets. Specifically, Alice wanting to sell a witness w for some N P statement x generates a secret-key k for some encryption scheme and computes (h, ct) where h SHA256(k) and ct is an encryption of w under k. It additionally computes a NIZK proof π to show the well-formedness of (h, ct) and sends the tuple (h, ct, π) to Bob. Then, Bob generates a hash-time-lock contract w.r.t. the hash h included by Alice. To redeem, Alice needs to post the pre-image of h on the blockchain which would also allow Bob to learn the witness w via decrypting ct using the posted pre-image.

More formally, Alice generates a NIZK proof for the following language:

$$L = \{ ( x , h , ct ) : ∃ ( k , w ) s . t . h = SHA 256 ( k ) ∧ w = D e c ( k , ct ) ∧ R ( x , w ) = 1 \} .$$

This language may not be in NP∩o-N P as L̅ consists of strings (x, h, ct) where ct may be outside the range of the Enc algorithm and no efficiently checkable witness may exist. However, consider the following subset L_{No}⊆L̅ which contains tuples (x, h, ct) where ct encrypts a non-witness (e.g., a special symbol L)

$${L}_{N o} = \{ ( x , h , ct ) : ∃ ( k , r ) s . t . h = SHA 256 ( k ) ∧ c t = E n c ( k , ⊥ , r ) \} .$$

For the above language, there does exist an associated relation R_{No} that on inputs a statement (x, h, ct) and a witness k, r outputs 1 iff ct is an encryption of ⊥ under key k and randomness r.

For accountable soundness, consider the distribution [symbol] that samples instances from L while using randomness used to sample k and compute the ciphertext ct uniformly at random. In particular, [symbol] may choose the plaintext to be encrypted arbitarily. Then, we can transform any NIZK for L to additionally achieve accountable soundness for [symbol] : the required distribution [symbol] _{No} over R_{L}_{_{No}} is the uniform distribution and the required computational indistinguishability would follow from the semantic security of the encryption scheme. Note here that we require semantic security even in the presence of the leak age h which is the hash of the corresponding secret-key. If h is sufficiently compressing then we can show that the secret-key has enough min-entropy and relyin on the standard notion of semantic security. Else, modelling SHA256 as a one-way function, we would need a symmetric-key encryption scheme which is leakage-resilient against computational leakages of secret-key.

### 6.2 Construction for Sparse Languages

In this section, we focus on languages where it may not be possible to sample NO instances along with their witness. In particular, the idea is to “force” a successful defamation-freeness adversary to find accepting proofs for NO instances. We rely on the “sparsity” of the underlying language L to achieve this. We next formally define the notion of δ-sparsity and then state our theorem.
Sparsity. For security parameter λ, let L⊆{0, 1 [symbol] be a language with instances of length [symbol] (λ). Then, for a function δ=δ(λ), L is δ-sparse if |L|≤ [symbol] ·δ.
Theorem 6.4. Let L be a δ-sparse language over [symbol] bit strings and Π′ be a non-interactive adaptively sound argument for L. Then, there exists a non-interactive argument system Π with accountable soundness w.r.t. any distribution [symbol] = [symbol] _{yes} over R_{L} as long as M( [symbol] _{yes}) is computationally indistinguishable from [symbol] and δ²· [symbol] is negligible in λ. Further, if Π′ is a NIZK (resp., SNARG) then Π is a NIZK (resp., SNARG) with accountable soundness for [symbol] .
Proof. Towards proving Theorem 6.4, we first outline the construction and discuss the security proof.
Construction We now give our construction for δ-sparse languages L, for, e.g., δ= [symbol] and [symbol] ∈poly(λ). Let L be any such language in NP, and let Π′=(GenCRS′, Prove′, Verify′) be a non-interactive argument system for L. We present the following construction Π=(GenCRS, Prove, Verify, Judge) of an non-interactive argument with accountable soundness:
Construction 6.5: Accountable soundness for sparse languages

### GenCRS(1^{λ}):

1. Run CRS_{Π}=GenCRS′(1^{λ}).
2. Sample x*← [symbol] .
3. Output CRS=(CRS_{Π}, x*).
   Prove(CRS, x, w) where CRS (CRS_{Π}, x*):
1. Output π=Prove′(CRS_{Π}, x, w).
   Verify (CRS, x, π) where CRS (CRS_{Π}, x*):
1. Output b=Verify′(CRS_{Π}, x, π).
   Judge (CRS=(CRS_{Π}, x*), τ=(x, w, π)):
1. If CRS is not well-formed (i.e., CRS≠(CRS_{Π}, x*)) then output corrupted.
2. Otherwise, output corrupted iff R_{L}(x, w)=1, and Verify(CRS, x*⊕x, π)=1. (Note that π is a proof for the statement is x* ⊕x and not x.)
   Security Proof. The completeness and soundness properties hold by the completeness and soundness of the non-interactive argument Π′. Moreover, GenCRS is identical to GenCRS′ except that we add random string x* of length [symbol] in the CRS, and Prove and Verify algorithms ignore x* and behave identically to Prove′ and Verify′. Therefore, if Π′ is a NIZK (resp., SNARG), we can conclude that so is Π.

Next, we show that the accountability and defamation free properties hold:

Accountability. We present the extractor Ext. Let [symbol] be some PPT adversary. The extractor has one black-box query to the adversary [symbol] , after [symbol] gives out CRS*.
1. The extractor is invoked on an input CRS*. If CRS* is not of the form of (CRS_{Π}, x*) then just use x*=0.
2. It samples (x, w)← [symbol] _{yes} and queries [symbol] on x*⊕x, to receive π.
3. It outputs τ=(x, w, π).
   Recall that in real world, [symbol] is queried on some random x sampled from [symbol] _{yes} whereas in the ideal world the extractor samples some x∈L, but then queries [symbol] on the input x⊕x*. We proceed to show that AccSnd [symbol] (λ), AccSnd. [symbol] (λ) are negligibly close via the following sequence of hybrids.
Hybrid Hyb₀: This is identical to AccSnd. [symbol] (λ). More specifically,
   1. CRS (CRS*, x*)← [symbol] (λ).
   2. Sample (x, w)← [symbol] _{Yes}.
   3. Query [symbol] on x to get back π.
   4. Output 1 iff Verify(CRS, x, π)=1.
Hybrid Hyb₁: This is identical to Hyb₀ except that x← [symbol] .
Hybrid Hyb₂: This is identical to Hyb₁ except that [symbol] is queried on the statement x x* instead of querying it on x (as in Hyb₁) where x← [symbol] . Furthermore, the winning condition of this hybrid is now changed: Hyb₂ outputs 1 only if Verify(CRS, x⊕x*, π)=1.
Hybrid Hyb₃: This is identical to Hyb₂ except that we switch to sampling (x, w)← [symbol] _{yes}. Recall that the output of hybrid is 1 if Verify(CRS, x⊕x*, π).
Hybrid Hyb₄: This hybrid is identical to Hyb₃ except that the output condition of this hybrid is now changed: Hyb₄ output 1 if Verify(CRS, x⊕x*, π)=1∧R_{L}(x, w)=1. This is the identical to AccSnd. [symbol] .

For each i∈{0, . . . , 4}, let pᵢ be the probability that the hybrid Hyb₁ outputs 1. To conclude the proof we need to argue that there exists some negligible function μ such that |p₀−p₄|≤μ(λ). First, by the indistinguishability of M( [symbol] _{yes}) and [symbol] , we can conclude that there exist negligible functions μ₀₁, μ₂₃ such that |p₀−p₁|≤μ₀₁ as well as |p₂−p₃|≤μ₂₃. Furthermore, p₁=P₂ as the two hybrids Hyb₁ and Hyb₂ are identical. Finally, we argue that p₃=p₄: the only difference between the hybrids Hyb₃ and Hyb₄ are their respective winning conditions: in particular, Hyb₃ outputs 1. only if Verify(CRS, x⊕x*, π)=1 whereas Hyb₄ additionally also need R_{L}(x, w)=1. However, note that in both hybrids R_{L}(x, w)=1 and so p₃=p₄. Therefore, |p₀−p₄| is upperbounded by the negligible function μ·μ₀₁+μ₂₃.

Defamation free. We show that it is infeasible to frame an honestly generated CRS. First, we claim that

$${Pr}_{{x}^{*} ← {𝒰}_{ℓ}} [ ∃ x ∈ L s . t . {x}^{*} ⊕ x ∈ L ] \leq {\sum }_{x ∈ L} {Pr}_{{x}^{*} ← {𝒰}_{ℓ}} [ {x}^{*} ⊕ x ∈ L ] \leq \vert L \vert \frac{\vert L \vert}{{2}^{ℓ}} = {δ}^{2} \cdot {2}^{ℓ} ,$$

which is negligible according to our assumption in the theorem statement.

Now, fix some PPT adversary [symbol] . Denote by [symbol] the event in which CRS=(CRS_{Π}, x*) is chosen honestly according to GenCRS(1^{λ}), and them [symbol] , on input outputs (x, w, π) such that Judge((CRS_{Π}, x*), (x, w, π))=corrupted.

$$Pr [ {win}_{𝒜} ] = Pr [ {win}_{𝒜} ∧ x ⊕ {x}^{*} ∉ L ] + Pr [ {win}_{𝒜} ∧ x ⊕ {x}^{*} ∈ L ] \leq Pr [ {win}_{𝒜} ∧ x ⊕ {x}^{*} ∉ L ] + {δ}^{2} \cdot {2}^{ℓ}$$

where the latter holds since the probability is taken also over the choice of the x* (as part of the honestly generated CRS), and thus the probability that there exists a x∈L such that x⊕x*∈L is at most δ²· [symbol] . Thus, if there exists an adversary that can break defamation free, we can use the adversary to break the soundness of the underlying NIZK: on an honestly generated CRS_{Π}←GenCRS′(1^{λ}) we choose a random x* and run [symbol] on (CRS_{Π}, x*). When [symbol] outputs (x, w, π) such that Judge((CRS_{Π}, x*), (x, w, Π))=corrupted then with non-negligible probability it holds that x⊕x* ∉L, but Verify′(CRS_{Π}, x*⊕x, π)=1, in contradiction to the soundness property of the underlying NIZK system.

### 6.2.1 Examples of Sparse Languages

We next present two examples of languages that satisfy the necessary sparseness require ments.
PRG language. As an example of a language that is captured by this construction, consider the language which consists of outputs of pseudorandom generators. Let G: {0, 1}^{λ}→{0, 1 [symbol] be a pseudorandom generator with expansion factor [symbol] (λ). Consider the language:

$$L = \{ y ∈ {\{ 0 , 1 \}}^{ℓ ( λ )} \vert ∃ x ∈ {\{ 0 , 1 \}}^{λ} s . t . G ( x ) = y \} .$$

[symbol]

_{yes} is constructed in the natural way (sample x and apply G(x)). From the pseudorandomness property of the PRG we have that M( [symbol] _{yes}) is indistinguishable from [symbol] , and we can construct non-interactive arguments with accountable-soundness as long as [symbol] (λ)=2λ+polylog(λ).
Sequential Composition of Hash. Let H: {0, 1}^{λ}→{0, 1}^{λ/2} be an unkeyed hash function (e.g., SHA-256) where A is sufficiently large even number. We emphasize that this is just a hash function and not a keyed hash family as typically required for complexity theoretic analysis. For some repetition parameter T, consider the following language:

$$L = \{ {x}_{T + 1} ∈ {\{ 0 , 1 \}}^{λ / 2} : ∃ {x}_{0} = ( {0}^{⌊ 7 λ / 8 ⌋} \vert \vert y ) ∈ {\{ 0 , 1 \}}^{λ} s . t . ∀ i ∈ [ T ] {x}_{i} = H ( {0}^{λ / 2} \vert \vert {x}_{i - 1} ) \} .$$

In essence, a non-interactive argument of knowledge for L proves knowledge of a structured pre-image of a hash output obtained via repeated hashing. This language is a prominent benchmark for designing time- and space-efficient arguments for RAM computations, and also can be viewed as proving knowledge of a T-sized chain in a blockchain. Firstly, observe that L has 2^{┌μ/8┐} instances, thereby it is δ-sparse for δ=2^{-└3λ/8┘}. Secondly, for some specific hash function H, we can potentially conjecture that the distribution that generates y as above but for a uniformly random x₀ not of the form (0^{λ}∥*) is indistinguishable from the uniform distribution over L. Therefore, any adaptively sound SNARG for L can then be lifted to achieve accountable soundness w.r.t. the uniform distribution.

### 6.3 Construction for Negligibly Sparse Languages

The construction in Section 6.2 only covers a small subset of languages glue to the required sparsity. In this section, we present a construction for δ-sparse languages for any negligible δ. However, this construction is worse than the above construction in two aspects: (a) the construction (in particular, Judge) depends on the distribution [symbol] for which accountability is to be shown, and (b) the defamation-freeness proof requires subexponential hardness assumptions. We note that the constructions presented in Section 6.1 as well as in this section do not suffer from these limitations: in particular, the construction is independent of the distribution [symbol] and the security proof only requires polynomial hardness from the building blocks.

Let L be any such δ-sparse NP language. Let Π′=(GenCRS′, Prove′, Verify′) be a non-interactive argument system for L. Let [symbol] ′ be some distribution over L using t(λ) bits of randomness, for some appropriate t (that depends on δ). Towards the end of this section, we show how to realize such a [symbol] ′ from any distribution [symbol] additionally assuming subexponentially secure PRG.

We now give the construction Π=(GenCRS, Prove, Verify, Judge) of a non-interactive argument system with accountable soundness:

Construction 6.6: NIZK with Accountable Soundness

### GenCRS(1^{λ}):

1. Run CRS′=GenCRS′(1^{λ}).
2. Sample x*← [symbol] .
3. Output CRS (CRS′, x*).
   Prove(CRS, x, w) where CRS=(CRS′, x*):
1. Output π=Prove′(CRS′, x, w).
   Verify (CRS, x, π) where CRS=(CRS′, x*):
1. Output b=Verify′(CRS′, x, π).
   Judge (CRS=(CRS′, x*), τ=(x′, r, π)):
1. If CRS is not well-formed (i.e., CRS=(CRS′, x*)) then output corrupted.
2. Otherwise, output corrupted iff x′= [symbol] (r), and Verify(CRS, x*⊕x′, π)=1.
   Theorem 6.7. Let δ be some negligible function and let L be δ(λ)-sparse language L over [symbol] (λ)-bit strings, and let [symbol] ′ be a distribution over L using t(λ) bits of randomness. Then, if Π′=(GenCRS′, Prove′, Verify′) be a non-interactive adaptively sound argument for L, then the construction Π as described above achieves satisfies accountable soundness for L w. r. t. [symbol] ′ as long as [symbol] ′≈_{c} [symbol] and δ·2^{t} is negligible in λ.
   Further, if Π′ is a NIZK (resp., SNARG) then Π is a NIZK (resp., SNARG) with accountable soundness for the distribution [symbol] .
   Proof of Theorem 6.7. The completeness and soundness properties hold by the completeness and soundness of the non-interactive argument Π′. Moreover, GenCRS is identical to GenCRS′ except that we add random string x* of length [symbol] in the CRS, and Prove and Verify algorithms ignore x* and behave identically to Prove′ and Verify′. Therefore, if Π′ is a NIZK (resp., SNARG), we can conclude that so is Π.

Next, we proceed to show accountable soundness. Here, accountability follows identically to the proof of accountability in Theorem 6.4. We now proceed to discuss defamation-freeness.

Recall that to show defamation-freeness, we need to show that the no PPT adversary [symbol] when given a honestly generated CRS, can output a certificate τ=(x′, r, π) that the Judge accepts with overwhelming probability. Recall that the Judge algorithm accepts T iff π is an accepting proof for x=x′⊕x* and that x′ is chosen from the support of the distribution [symbol] ′.

Towards this, we first show that, over the choice of x*, it is only with negligible probability that there exists any x′ in the support of the distribution [symbol] ′ for which x x* ⊕x′ is even in L: By the δ-sparseness of L we have that for every x′ in the support of [symbol] ′

$${Pr}_{{x}^{*} ∈ {𝒰}_{ℓ}} [ {x}^{*} ⊕ {x}^{′} ∈ L ] \leq δ . \qquad ( 1 )$$

Then, by a union bound over all 2^{t} values of x′ in the support of [symbol] ′ we have that,

$${Pr}_{{x}^{*} ∈ {𝒰}_{ℓ}} [ ∃ {x}^{′} ∈ [ {𝒟}^{′} ( \cdot ) ] : {x}^{*} ⊕ {x}^{′} ∈ L ] \leq δ \cdot {2}^{t} , \qquad ( 2 )$$

which is negligible.

Therefore, for any [symbol] , that breaks defamation-freeness with non-negligible probability p, with probability at least p/2, we have that [symbol] outputs a false statement x=x′ ⊕x* along with an accepting proof for it. Then, we can build a reduction to the adaptive soundness of Π′.

Existence of the distribution [symbol] ′. Next, we argue that given any distribution [symbol] using poly(λ) bits of randomness, we can construct a distribution [symbol] ′ using t bits of randomness by assuming sufficiently strong PRGs.
Claim 6.8. Let δ(λ) be negligible fun δ-sparse language L over [symbol] bit strings, and [symbol] be a distribution over L using [symbol] , bits of randomness. Then, for t=log(1/\sqrt{δ}), assuming the existence of a PRG G from t bits to [symbol] , there exists a distribution [symbol] ′ over L that uses t bits of randomness. Further [symbol] ≈_{c} [symbol] implies [symbol] ′≈_{c} [symbol] .

The construction of the distribution [symbol] ′ is straightforward: [symbol] ′(r) outputs [symbol] (G(r)). For inverse subexponential functions δ=2^{-λ}^{^{ϵ}}for 0<ϵ<1, a polynomial stretch PRG would be sufficient (i.e., t=(λ^{ϵ})/2.). Such a PRG can be instantiated from any polynomially-secure PRG. However, for larger δ's (e.g., δ=2^{-log}^{²}^{λ}) one would need a “super-polynomial” stretch PRG G that maps seeds of length polylog(6λ) bits to strings of length poly(λ). Such a PRG can be instantiated from any sub-exponentially-secure PRG by appropriately scaling its security parameter. The indistinguishability of [symbol] ′ from [symbol] then follows readily from the pseudorandomness of the PRG as well as the fact that [symbol] ≈_{c} [symbol] .

### 6.4 General Feasibility for Accountable Soundness

So far in this section we presented compilers to lift any non-interactive argument to additionally satisfy accountable soundness. However, these compilers relied crucially on algebraic structures of the language L: in Section 6.1 required the ability to sample NO instances along with a witness where as in Section 6.2 the language was assumed to be sparse. In this section, we focus on understanding what cryptographic assumptions are sufficient to achieve accountable soundness for an NP language.

In particular, for any distribution [symbol] , we present a construction of a non-interactive argument that achieves accountable soundness w.r.t. [symbol] under subexponential hardness assumptions. The description of the construction (more specifically, the Judge) algorithm depends on the distribution [symbol] and we require [symbol] to satisfy some natural but strong properties. We proceed to give the construction.

Construction. Let L be any language in NP on [symbol] -bit strings and let D be a distribution over L using [symbol] , bits of randomness. Our non-interactive argument Π=(GenCRS, Prove, Verify, Judge) depends on another non-interactive argument Π′=(GenCRS′, Prove′, Verify′) for L and a PRG G from t bits to [symbol] ᵣ bits for parameter t to be specified shortly. The construction of II is as follows:
Construction 6.9: NIZK with Accountable Soundness

### GenCRS(1^{λ}):

1. Run CRS′=GenCRS′(1^{λ}).
2. Sample x*← [symbol] .
3. Output CRS=(CRS′, x*).
   Prove(CRS, x, w) where CRS=(CRS′, x*):
1. Output π=Prove′(CRS′, x, w).
   Verify (CRS, x, π) where CRS=(CRS′, x*):
1. Output b=Verify′(CRS′, x, π).
   Judge (CRS=(CRS′, x*), τ=(x′, r, π)):
1. If CRS is not well-formed (i.e., CRS=(CRS′, x*)) then output corrupted.
2. Otherwise, output corrupted iff x′=D(G(r)), and Verify(CRS, x* ⊕x′, π)=1.
   Theorem 6.10. Let L be an NP language over [symbol] bit strings. Let D be a distribution over L with the following two properties: (a) [symbol] ≈_{c} [symbol] , (b) there exists 0<ϵ<1 and a distribution [symbol] ₙₒ over L̅ such that no PPT adversary can distinguish [symbol] ₙₒ from [symbol] with advantage better than 2⁻⁸⁰ ^{^{ϵ}}. Let Π′=(GenCRS′, Prove′, Verify′) be a non-interactive argument for L for which no PPT adversary can break adaptive soundness with probability better than 2^{-λ}^{^{ϵ}}and G be a PRG. Then, the above construction Π is a non-interactive argument for L that satisfies accountable-soundness w.r.t. [symbol] .
   Further, if Π′ is a NIZK (resp., SNARG) then II is a NIZK (resp., SNARG) with ac countable soundness for the distribution [symbol] .
   Proof. The completeness and soundness properties hold by the completeness and soundness of the non-interactive argument Π′. Moreover, GenCRS is identical to GenCRS′ except that we add random string x* of length [symbol] in the CRS, and Prove and Verify algorithms ignore x* and behave identically to Prove′ and Verify′. Therefore, if Π′ is a NIZK (resp., SNARG), we can conclude that so is H.

Next, we show that H satisfies accountable soundness w.r.t. [symbol] . For this. we first show accountability and then proceed to show defamation-freeness.

Accountability. We exhibit the required extractor Ext below. Let [symbol] be some PPT adversary. The extractor has one black-box query to the adversary [symbol] , after [symbol] gives out CRS*.
1. The extractor is invoked on an input CRS*. If CRS* is not of the form of (CRS_{Π}, x*) then output τ=⊥.
2. Otherwise, it samples a random seed r← [symbol] for the PRG, and uses G(r) as the randomness to sample a statement x′ from [symbol] . That is, x′= [symbol] (G(r)).
3. It queries [symbol] on x=x* ⊕x′ to get back π, and outputs τ=(x′, r, π).

We now show that AccSnd. [symbol] (λ), AccSnd. [symbol] (λ) are negligibly close. Recall that in AccSnd.REAL, A is queried on some random x sampled from [symbol] whereas in AccSnd.IDEAL the extractor samples some x′ from [symbol] using randomness G(r) and then queries [symbol] on the input x=x′ ⊕x*. To show accountability, we consider the following set of intermediate hybrids.

Hybrid H₀(λ): This is identical to the AccSnd.REAL game. More specifically,
1. Run [symbol] to get CRS=(CRS′, x*)
2. x← [symbol] .
3. Query [symbol] on x to get π.
4. Output 1 iff Verify(CRS, x, π)=1.
   Hybrid H₁ (λ): This is identical to H₀ except that x← [symbol] instead of x← [symbol] .
   Hybrid H₂(λ): This is identical to H₁ except that [symbol] is queried on x=x′ ⊕x* for x′← [symbol] .
   Hybrid H₃(λ): This is identical to H₂ except that x′ ← [symbol] instead of x′ ← [symbol] .
   Hybrid H₄(λ): This is identical to H₃ except that x′ is computed as [symbol] (G(r)) for a uniformly random string r instead of x′← [symbol] .
   Hybrid H₅(λ): This is identical to H₄ except that the winning condition is changed. In particular, this hybrid outputs 1 iff Verify(CRS, x, π)=1 and x′= [symbol] (G(r)). This hybrid is identical to the AccSnd.IDEAL game. We explicitly write down this hybrid for clarity.
1. Run [symbol] to get CRS=(CRS′, x*)
2. Set x′= [symbol] (G(r)) for r← [symbol] .
3. Query [symbol] on x=x* ⊕x′ to get back π.
4. Output 1 iff Verify(CRS, x, π)=1 and x′= [symbol] (G(r)).

For H₂, let p₂ be the probability that Hᵢ outputs 1. We need to show that there exists a negligible function μ such that |p₀−p₅|≤μ(λ).

First, note that there exists a negligible function μ₀₃ such that |p₀−p₃|≤μ₀₃(λ) This follows from the indistinguishability of [symbol] and [symbol] : p₀ and p₁ are negligibly close due to [symbol] ≈_{c} [symbol] . The hybrids Hyb₀ and Hyb₁ are identical and hence we conclude that p₁ and p₂ are equal, and finally p₂ and p₃ are negligible close due [symbol] ≈_{c} [symbol] .

Secondly, the only difference between H₃ and H₄ is that in the former x′ is sampled from [symbol] using a uniformly random lᵣ bit string as the randomness whereas in the latter x′ is sampled from [symbol] using G(r) as a the randomness for a uniformly random t bit string r. Therefore, by the security of the PRG G, there exists a negligible function μ₃₄ such that |p₃−p₄|≤μ₃₄(λ).

Finally, the only difference between H₄ and H₅ is the condition on which the hybrids output 1. Specifically, H₄ outputs 1 only if Verify(CRS, x, π)=1 whereas H₅ additionally requires that x′= [symbol] (G(r)) when outputting 1. However, note that the view of [symbol] is identical across both experiments and the additional condition checked in H₅ is always satisfied in H₅. Therefore, we can conclude that p₄ and p₅ are identical. This concludes the proof of accountability.

Defamation-freeness. We need to show that for a honestly generated CRS=(CRS′, x*), no PPT adversary [symbol] can output a certificate τ=(x′, r, π) that the Judge algorithm accepts with non-negligible probability. To show this we consider the following set of hybrids and highlight the changes across hybrids in red.
Hybrid H₀(λ): This hybrid is identical to the defamation-freeness game for Π. More specifically,
1. CRS′←GenCRS′(λ), x*← [symbol] .
2. Set CRS=(CRS′, x*).
3. Run [symbol] on input CRS to get back τ=(x′, r, π).
4. Output 1 iff Verify(CRS, x*⊕, x′, π)=1 and x′= [symbol] (G(r)).
   Hybrid H₁ (λ): This hybrid is identical to H₀ except that the hybrid samples a guess s for the randomness r output by [symbol] , and outputs 1 only if its guess for r is correct. More specifically,
1. CRS′←GenCRS′(λ), x*← [symbol] .
2. Set CRS=(CRS′, x*)
3. Compute s← [symbol] .
4. Run [symbol] on input CRS to get back τ=(x′, r, π).
5. Output 1 iff Verify(CRS, x*⊕, x′, π)=1 and x′= [symbol] (G(r)) and s=r.
   Hybrid H₂(λ): This hybrid is identical to H₁ except that sample x* from a syntactically different distribution. More specifically,
1. CRS′←GenCRS′(λ).
2. \tilde{x} ← [symbol] .
3. s← [symbol] , y= [symbol] (G(s)).
4. Set x*=\tilde{x} ⊕y.
5. Set CRS=(CRS′, x*).
6. Run [symbol] on input CRS to get back τ=(x′, r, π).
7. Output 1 iff Verify(CRS, x*⊕, x′, π)=1 and x′= [symbol] (G(r)) and s=r.
   Hybrid H₃(λ): This hybrid is identical to H₂ except that \tilde{x} is sampled from [symbol] ₙₒ distribution instead of [symbol] . More specifically,
1. CRS′←GenCRS′(λ).
2. \tilde{x} ← [symbol] ₙₒ.
3. s← [symbol] , y= [symbol] (G(s)).
4. Set x*=\tilde{x} ⊕g.
5. Set CRS=(CRS′, x*).
6. Run [symbol] on input CRS to get back τ=(x′, r, π).
7. Output 1 iff Verify(CRS, x*⊕, x′, π)=1 and x′= [symbol] (G(r)) and s=r.

For each H₂, let pᵢ be the probability that Hᵢ outputs 1. We want to show that p₀ is negligible for all [symbol] . Towards this, first note that p₁/p₀/2^{t}. The hybrids H₂ and H₁ are identical, hence p₂=p₁.

Claim 6.11. By the subexponential indistinguishability of [symbol] and [symbol] ₙₒ, we have that |p₂−p₃|≤2^{-λ}^{^{ϵ}}.

The only difference between H₂ and H₃ is that in H₂ \tilde{x} is sampled from [symbol] whereas in H₃ it is sampled from [symbol] ₙₒ. The claim follows.

We conclude the proof by upperbounding the probability p₃ relying on the adaptive soundness of Π′. At a high level, since \tilde{x} is sampled from [symbol] ₙₒ if H₃ outputs 1 with probability p₃ this implies that [symbol] was able to come up with an accepting proof π for the statement x* ⊕x′ and that s=r. Combining these, we can conclude that x′=y and furthermore x* ⊕x′=\tilde{x} which is a NO instance. Therefore, we can reduce to the adaptive soundness of Π′.

Claim 6.12. By adaptive soundness of Π′, we have that p₃≤2^{-λ}^{^{ϵ}}.

Therefore, by combining the above claims, we have that p₀≤2·2^{-λ}^{^{ϵ}}·2^{t} which is negligible for t=λ^{δ} for 0<δ<ϵ.

### 7 Combining Subversion Advice-ZK and Accountable Soundness

In this section, we build NIZKs that satisfy both subversion advice-ZK and accountable soundness. This results in the first NIZKs that satisfy meaningful notions of privacy as well as soundness for malicious CRS.

For languages that fit NP∩co-NP's generalization defined in Section 6.1, we start by plugging in an adaptively sound NIZK argument Π′ for NP in Theorem 4.3 to get a NIZK argument Π that satisfies subversion advice-ZK. Then, instantiate Theorem 6.2 with such a Π to get a subversion advice-ZK NIZK \tilde{Π} with accountable soundness: the compiler in Theorem 6.2 preserves subversion advice-ZK property as it doesn't change Π's Prove, Verify, GenCRS algorithms.

Theorem 7.1. Let L be any NP language, R_{L} be its relation. For L_{No} ⊆L̅, let R_{No} be its relation. For some super-polynomial function T, assume an adaptively sound NIZK for NP, a non-interactive perfectly binding T-extractable commitment Corn, a T-hard trapdoor generation protocol, and a two-message delayed input, publicly verifiable WI argument for NP with T-adaptive soundness.
Then, there exists a subversion advice-ZK NIZK argument for L that satisfies accountable soundness w.r.t. distribution [symbol] as required in Theorem 6.2.

Similarly, we obtain a subversion advice-ZK NIZK with accountable soundness for sparse languages from Theorem 6.4 and Theorem 4.3.

Theorem 7.2. Let L be some δ-sparse NP language over [symbol] -bit strings such that δ²· [symbol] is negligible. For some super-polynomial function T, assume an adaptively sound NIZK for NP, a non-interactive perfectly binding T-extractable commitment Corn, a T-hard trapdoor generation protocol, and a two-message delayed input, publicly verifiable WI argument for NP with T-adaptive soundness.
Then, there exists a subversion advice-ZK NIZK argument for L that satisfies accountable soundness w.r.t. distribution [symbol] as required in Theorem 6.4.

### A Instantiations of Trapdoor Generation

A.1 Trapdoor Generation from One-Way Functions with Efficient Recognizable Range
Let ƒ={ƒ_{λ}: [symbol] _{λ}→ [symbol] _{λ}}_{λ} be a T-one-way function. Further we assume that ƒ has an efficient recognizable range, that is, we assume the existence of a PPT algorithm CheckRange that for all λ and sₒᵤₜ ∈ [symbol] _{λ}:

$$CheckRange ( {s}_{out} ) = 1 ⇔ ∃ {s}_{i n} ∈ {𝒟}_{λ} s . t . {f}_{λ} ( {s}_{i n} ) = {s}_{out} .$$

We give a construction of the trapdoor generation protocol for such a one-way function:
1. TDGen(1^{λ}) samples a random sᵢₙ← [symbol] _{λ} and output sₒᵤₜ=ƒ_{λ}(sᵢₙ).
2. TDValid(sₒᵤₜ) outputs 1 iff CheckRange(sₒᵤₜ)=1.
3. TDCheck(1^{λ}, sᵢₙ, sₒᵤₜ) outputs 1 iff sₒᵤₜ=ƒ_{λ}(sᵢₙ).
4. TDSol on input sₒᵤₜ∈ [symbol] _{λ} finds an sᵢₙ∈ [symbol] _{λ} such that ƒ_{λ}(sᵢₙ)=sₒᵤₜ via brute-force search.

Clearly, TDValid(TDGen(1^{λ}))=1. Moreover, for every sₒᵤₜ we have that TDValid(sₒᵤₜ)=1 if and only if there exists an sᵢₙ such that TDCheck(sᵢₙ, sₒᵤₜ)=1, i.e., sₒᵤₜ=ƒ_{λ}(sᵢₙ). T-hardness follows from the T-one-wayness of ƒ. Finally, the correctness of TDSol is immediate.

Instantiating T-hard one-way function: For any T, a T-hard OWF g can be obtained from 2^{λ}^{^{ϵ}}-secure OWF ƒ by setting λ_{ƒ}=ω(1)·T/ϵ where λ_{ƒ}, λ are security parameters of ƒ and g respectively. Then, T-hardness of g follows from the fact that for any polynomial p,

$$p ( T ) < {2}^{{λ}_{f}^{ϵ}} .$$

Additionally, g satisfies S-solvability for S=2^{λ}^{_{ƒ}}=2^{ω(1)T1/ϵ}.
A.2 Trapdoor Generation from Collision-Resistant Hash Family
Let H={h_{λ}: {0, 1}^{κ(λ)}× [symbol] _{λ}→ [symbol] _{λ}} be a collision-resistant hash family, where for every λ∈ [symbol] we have | [symbol] _{λ}|<| [symbol] _{λ}|. Then consider the following construction of trapdoor generation:
1. TDGen(1^{λ}) outputs a random hash function key sₒᵤₜ←{0, 1}^{κ(λ)}.
2. TDValid(sₒᵤₜ) outputs 1 iff sₒᵤₜ∈{0, 1}^{κ(λ)}.
3. TDCheck(1^{λ}, sᵢₙ=(x₀, x₁), sₒᵤₜ) outputs 1 iff h_{λ}(sₒᵤₜ, x₀) ha(sₒᵤₜ, x₁) and x₀≠x₁.
4. TDSol on input sₒᵤₜ∈ [symbol] _{λ} a finds an

$${s}_{i n} ∈ {𝒟}_{λ}^{2}$$

such that TDCheck(1^{λ}, sᵢₙ, sₒᵤₜ)=1 via brute-force search.

Clearly, TDValid(TDGen(1^{λ}))=1. Further, since h is compressing, for every sₒᵤₜ there exists sᵢₙ=(x₀, x₁) such that TDCheck(sᵢₙ, sₒᵤₜ)=1 and x₀≠x₁. Finally, T-hardness follows from the T-collision-resistance of H and the correctness of TDSol is immediate.

Instantiating T-collision resistant hash function: As described in the above subsection, for any T, a T-collision resistant hash function g can be obtained from 2-collision resistant hash function ƒ by setting λ_{ƒ}=ω(1)·T/ϵ where λ_{ƒ}, λ are security parameters of ƒ and g respectively. Then, T-hardness of g follows from the fact that for any polynomial p,

$$p ( T ) < {2}^{{λ}_{f}^{ϵ}} .$$

B Subversion Advice-ZK NIZKs satisfy Subversion Witness Hiding, Subversion Function Hiding and More

In this section, we discuss the relation of our new notion of subversion advice-ZK for NIZKs with several different notions of privacy in the subversion-setting. In particular, we show that it implies the previously considered notion of subversion-witness-indistinguishability. We also introduce other relaxed notions including subversion witness-hiding and subversion-function-hiding, and show that subversion advice-ZK imply them all.

### B.1 Subversion Witness Hiding (WH)

Informally, Subversion WH demands that even when the authority creates the CRS maliciously, it still cannot recover a valid witness for the instance from the proof it was given. The adversary is modeled as a two-stage algorithm: it first outputs a CRS CRS* and a secret state T passed to the second stage. The second stage is then defined like the honest-CRS WH game. We emphasize that WH is meaningful only for languages that are considered “hard” according to some distribution; that is, it is infeasible to find a valid witness for the instance, when it is drawn from the distribution. We first formally define “hard” distributions. s
Definition B.1. Let L be an NP language and R_{L} be its associated relation, let [symbol] be a distribution over instance-witness pairs of R_{L}. We say that L is hard w.r.t. distribution [symbol] if for every non-uniform PPT algorithm [symbol] there exists a negligible function μ(⋅) such that for every auxiliary input z∈{0, 1}*:

$$P r [ ( x , {w}^{′} ) ∈ {R}_{L} : ( x , w ) ← 𝒟 , {w}^{′} ← 𝒜 ( x , z ) ] \leq μ ( λ ) .$$

Next, we formally define subversion-witness-hiding for NIZKs.

Definition B.2 (Witness-Hiding with Subversion CRS). Let L∈NP and a distribution D over its associated relation R_{L}, L is hard w.r.t. [symbol] . We say that a NIZK argument for Π=(GenCRS, Prove, Verify) for L is also witness hiding with subversion CRS with respect to [symbol] if for all non-uniform PPT adversaries [symbol] there exists a negligible function μ such that:

$$P r [ S - W {H}_{\prod , 𝒜 , 𝒟} ( λ ) = 1 ] \leq μ ( λ )$$

where the random variable S- [symbol] (λ) is defined as follows:
S- [symbol] (λ):
   1. The adversary [symbol] (1^{λ}) outputs (subverted) CRS* and secret state T.
2. (x, w)← [symbol] and then π←Prove(CRS*, x, w).
3. [symbol] is given (x, π).
4. [symbol] outputs w′. The output of the experiment is 1 if R_{L}(x, w′) 1.
   Theorem B.3. An subversion advice-ZK NIZK system Π=(GenCRS, Prove, Verify) is also subversion witness hiding.
   Proof. Assume there exists a non-uniform PPT adversary [symbol] that wins in S- [symbol] (λ) with some non-negligible probability ϵ(λ). That is, [symbol] does the following:
1. [symbol] outputs (CRS*, τ)
2. On input (x, π) (where π is a valid proof for x), [symbol] outputs w′.
   Consider the following adversary [symbol] for the subversion advice-ZK game of Π that depends on [symbol] : It runs [symbol] (1^{λ}) and gets (CRS*, τ). It outputs CRS* as it's first message. It samples (x, W)← [symbol] and queries on that instance-witness pair, and then receives back π. It sends (x, π) to [symbol] in order to obtain w′ and outputs whatever it outputs.

Since Π is an subversion advice-ZK NIZK there exists a non-uniform PPT simulator [symbol] and an advice distribution [symbol] for which [symbol] (λ) and [symbol] (λ) are computationally indistinguishable.

By the subversion advice-ZK NIZK property of Π, we can claim that [symbol] outputs a valid witness for x with non-negligible probability. However, in order to reduce to the hardness of distribution [symbol] , we need to somehow provide d as non-uniform advice to [symbol] . This can actually be done via a standard averaging argument. Specifically, there exist some d in the support of [symbol] such that conditioned on d being given to [symbol] , it outputs a valid witness with non-negligible probability. Let us fix such a d. Then, [symbol] with such a d hardwired as non-uniform advice contradicts the hardness of the underlying language.

### B.2 Subversion Witness Indistinguishability (WI)

Subversion WI demands that even when the authority creates the CRS maliciously, it still cannot decide which of two witnesses of its choice were used to create a proof. The adversary is modeled as a two-stage algorithm: it first outputs a CRS CRS* and a secret state τ passed to the second stage. The second stage is then defined like the honest-CRS WI game.
Definition B.4. Let L∈NP and a distribution [symbol] over its associated relation R_{L}, L is hard w.r.t. [symbol] . We say that a NIZK argument Π=(GenCRS, Prove, Verify) for L is also witness indistinguishable for subversion CRS if for all non-uniform PPT adversaries [symbol] , there exists a negligible function μ(⋅) such that for all x∈L, witnesses w₀, w₁ of x:

$$P r [ S - {WI}_{\prod , 𝒜} ( λ , x , {w}_{0} , {w}_{1} ) = 1 ] \leq \frac{1}{2} + μ ( λ )$$

where the random variable S- [symbol] (λ, x, w₀, w₁) is defined as follows:
S- [symbol] (λ, x, w₀, w₁):
   1. If (x, w₀)∉R_{L} or (x, w₁)∉R_{L} then abort and output ⊥.
   2. The adversary [symbol] (1^{λ}) outputs (subverted) CRS* and a secret state τ.
   3. Sample b←{0, 1} uniformly at random. Compute π=Prove(CRS*, x, w_{b}) and send (x, π) to [symbol] .
4. A outputs a bit b′∈{0, 1}. The output of the experiment is 1 iff b=b′.
   Theorem B.5. An subversion advice-ZK NIZK system Π=(GenCRS, Prove, Verify) satisfies subversion witness indistinguishability.
   Proof. Let [symbol] be a non-uniform PPT adversary for the S-WI game. We show that [symbol] can be used to construct a non-uniform PPT adversary [symbol] ′ for the REAL game of the subversion advice-ZK of Π: On input 1λ, [symbol] ′ runs [symbol] (1^{λ}) to obtain (CRS*, τ). It outputs CRS*. Eventually, [symbol] ′ receives (x, π) as an input. It runs [symbol] (x, π) and outputs its output b′.

[symbol] ′ is non-uniform and PPT since [symbol] is non-uniform and PPT. By the subversion advice-ZK property of Π, there exist a non-uniform PPT simulator [symbol] and an advice distribution [symbol] for which [symbol] (λ, x, w_{b}) and [symbol] (λ, x, w_{b}) are indistinguishable, where b∈{0, 1} is the uniform bit chosen in the game S-WI. Since the simulator's view is independent from the used witness, we also have that [symbol] (λ, x, w₀) and [symbol] (λ, x, w₁) are indistinguishable. Thus from transitivity of indistinguishability, we have that [symbol] (λ, x, w₀) and [symbol] (λ, x, w₁) are indistinguishable. Therefore, there exists a negligible function μ(⋅) such that:

$$P r [ {b}^{′} = 0 : {b}^{′} ← 𝒜 ( x , π ) , π ← Prove ( {CRS}^{*} , x , {w}_{0} ) , CR {S}^{*} ← 𝒜 ( {1}^{λ} ) ] - Pr [ {b}^{′} = 0 : {b}^{′} ← 𝒜 ( x , π ) , π ← Prove ( {CRS}^{*} , x , {w}_{1} ) , CR {S}^{*} ← 𝒜 ( {1}^{λ} ) ] \leq μ ( λ )$$

Overall, we have that:

$$P r [ S - {WI}_{\prod , 𝒜} ( λ , x , {w}_{0} , {w}_{1} ) = 1 ] = Pr [ {b}^{′} = {b}^{′} : {b}^{′} ← 𝒜 ( x , π ) , π ← Prove ( CR {S}^{*} , x , {w}_{b} ) , CR {S}^{*} ← 𝒜 ( {1}^{λ} ) , b ← \{ 0 , 1 \} ] = \frac{1}{2} \cdot Pr [ {b}^{′} = 0 : {b}^{′} ← 𝒜 ( x , π ) , π ← Prove ( CR {S}^{*} , x , {w}_{0} ) , CR {S}^{*} ← 𝒜 ( {1}^{λ} ) ] + \frac{1}{2} \cdot Pr [ {b}^{′} = 1 : {b}^{′} ← 𝒜 ( x , π ) , π ← Prove ( CR {S}^{*} , x , {w}_{1} ) , CR {S}^{*} ← 𝒜 ( {1}^{λ} ) ] = \frac{1}{2} \cdot Pr [ {b}^{′} = 0 : {b}^{′} ← 𝒜 ( x , π ) , π ← Prove ( CR {S}^{*} , x , {w}_{0} ) , CR {S}^{*} ← 𝒜 ( {1}^{λ} ) ] + \frac{1}{2} \cdot ( 1 - Pr [ {b}^{′} = 0 : {b}^{′} ← 𝒜 ( x , π ) , π ← Prove ( CR {S}^{*} , x , {w}_{1} ) , CR {S}^{*} ← 𝒜 ( {1}^{λ} ) ] ) \leq \frac{1}{2} + \frac{1}{2} \cdot μ ( λ )$$

### B.3 Subversion Function Hiding

We introduce a new notion of subversion-security that we call subversion function hiding. Intuitively, a NIZK proof system satisfies subversion function-hiding if no efficient adversary can compute any efficiently computable function ƒ(x, w) of the prover's witness when given an honestly generated NIZK proof for the statement x even using a maliciously sampled CRS. We emphasize that we are only interested in hiding functions of the prover's witness. While an extension to hide functions of all witnesses is interesting, it is not clear how such a definition should look like. We leave it as an open question for the future.
Definition B.6. Let L be some NP language, [symbol] be a distribution over instance-witness pairs of L. We say that a NIZK (GenCRS, Prove, Verify) for L is subversion function-hiding if for all non-uniform PPT verifiers V (V₀, V₁) there exists a non-uniform polynomial-time simulator [symbol] such that for all efficiently computable functions ƒ(⋅)
if there exists a non-negligible function c such that

$$Pr [ {REAL}_{p r e d} ( λ , 𝒮 , f , 𝒟 ) = 1 ] \geq ϵ ( λ ) ,$$

then there exists a non-negligible function δ such that

$$Pr [ {IDEAL}_{p r e d} ( λ , V , f , 𝒟 ) = 1 ] \geq δ ( λ ) ,$$

where the games IDEAL and REAL are defined below:
REAL_{pred}(×, V, ƒ, [symbol] ):
   1. (CRS, τ)←V₀.
   2. (x, w)← [symbol] (1^{λ}).
   3. π←Prove(CRS, x, w).
   4. yᵣₑₐₗ←V₁(CRS, τ, x, π).
   5. Output 1 iff yᵣₑₐₗ=ƒ(x, w).
IDEAL_{pred}(λ, [symbol] , ƒ, [symbol] ):
   1. (x, w)← [symbol] (1^{λ}).
   2. y_{ideal}← [symbol] (x).
   3. Output 1 iff y_{ideal}=ƒ(x, w).
      Theorem B.7. An subversion advice-ZK NIZK Π=(GenCRS, Prove, Verify) satisfies subversion function hiding.
      Proof. The proof is very similar to the case of subversion witness-hiding but we include it for completeness. Let V=(V₀, V₁) be a non-uniform PPT corrupted verifier for the subversion function-hiding game. We show that V can be used to construct a non-uniform PPT adversary [symbol] for the subversion advice-ZK game of Π: [symbol] is given 1^{λ} as an input. It runs V₀(1^{λ}) and obtains its output (CRS*, τ). It outputs CRS*, and then being invoked on (x, π). It runs V₁(CRS*, τ, x, π) and obtains yᵣₑₐₗ.

Since V is non-uniform and PPT, [symbol] is also non-uniform and PPT. From the subversion advice ZK property of Π, there exists a PPT simulator [symbol] and an advice distribution

[symbol]

such that [symbol] (λ, x, w) and [symbol] (λ, x, w) are indistinguishable.

Consider the following adversary [symbol] that depends on [symbol] : It gets as input x′ [symbol] and a sample d=(r, td) from [symbol] . It first sets CRS* [symbol] (r). It then runs the [symbol] to computes a simulated proof π′ using the trapdoor td of CRS. It sends [symbol] on (x, π′) to receive y, and outputs whatever it outputs.

By the subversion advice-ZK NIZK property of Π, we can claim that with non-negligible probability, [symbol] 's output y is indeed ƒ(x, w). However, notice that [symbol] additionally receives a sample from the inefficient distribution [symbol] . To conclude the construction of the required simulator, we will have to fix some “good” advice d to [symbol] as non-uniform advice. This can actually be done via a standard averaging argument. Specifically, there exist some d in the support of [symbol] such that conditioned on d being given to [symbol] , it's output y is ƒ(x, w) with non-negligible probability. Let us fix such a d. Then, [symbol] with such a d hardwired as non-uniform advice gives us the required simulator to show subversion function-hiding.

### System Implementations

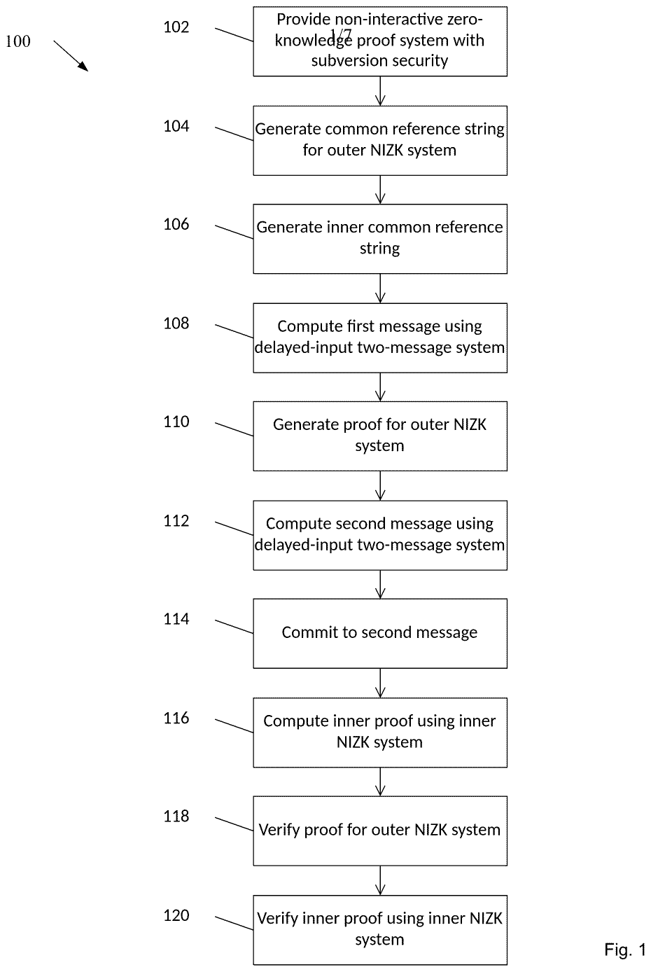

Referring to FIG. 1, a method 100 for generating and verifying a non-interactive zero-knowledge proof with subversion security is illustrated. The method 100 provides subversion zero-knowledge security against malicious common reference strings, enabling secure proof generation and verification even when the authority running a trusted setup may be corrupted or malicious.

The method 100 begins at step 102 with providing a non-interactive zero-knowledge proof system with subversion zero-knowledge security. The subversion zero-knowledge security comprises that for every non-uniform probabilistic polynomial-time adversary [symbol] that generates a potentially malicious common reference string CRS*, there exists a probabilistic polynomial-time simulator [symbol] and an [symbol] (λ)-time computable advice distribution [symbol] such that the view of [symbol] in a real proof generation process [symbol] (λ) is computationally indistinguishable from the view of [symbol] In an ideal simulation process [symbol] (λ). The system implements a subversion advice-ZK NIZK (Non-Interactive Zero-Knowledge) construction that strengthens zero-knowledge properties with malicious authority security in the common reference string model.

With continued reference to FIG. 1, the method 100 proceeds to step 104 with generating a common reference string CRS for an outer NIZK system. The outer NIZK system provides subversion zero-knowledge security and operates in a common reference string (CRS) model where the authority running the trusted setup may be corrupted or malicious. The method 100 generates and verifies the non-interactive zero-knowledge proof using a combination of components including the outer NIZK system, an inner NIZK system, a delayed-input two-message publicly-verifiable S-advice zero-knowledge argument system, and a non-interactive perfectly binding and T-extractable commitment scheme.

At step 106, the method 100 generates an inner common reference string CRS_{Inner} using a first non-interactive zero-knowledge argument system, referred to as the inner NIZK system. The inner common reference string CRS_{Inner} provides parameters for the inner NIZK system to generate and verify inner proofs.

As further shown in FIG. 1, step 108 involves computing a first message zk₁ using the delayed-input two-message publicly-verifiable S-advice zero-knowledge argument system. The first message zk₁ forms part of the common reference string CRS for the outer NIZK system. Step 110 involves generating a proof π for the outer NIZK system, which encompasses subsequent proof generation operations.

The method 100 continues at step 112, where a second message zk₂ is computed using the delayed-input two-message publicly-verifiable S-advice zero-knowledge argument system. At step 114, the method 100 commits to the second message zk₂ using the non-interactive perfectly binding and T-extractable commitment scheme to obtain a commitment c. The commitment c binds the prover to the second message zk₂ while maintaining the zero-knowledge property.

With continued reference to FIG. 1, step 116 involves computing an inner proof π_{Inner} using the inner NIZK system. The inner proof π_{Inner} demonstrates knowledge of the committed values and satisfies the language requirements of the inner NIZK system.

The verification portion of the method 100 begins at step 118 with verifying the proof π for the outer NIZK system. The verification process confirms that the proof π satisfies the verification conditions of the outer NIZK system. At step 120, the method 100 verifies the inner proof π_{Inner} using the inner NIZK system. The verification of the inner proof π_{Inner} completes the verification process for the non-interactive zero-knowledge proof with subversion security.

The flowchart of FIG. 1 shows a sequential process where each step flows directly into the next step through connecting arrows, indicating the order of operations in the non-interactive zero-knowledge proof system. The steps are arranged in a top-to-bottom sequence, with the proof generation steps (steps 102 through 116) preceding the verification steps (steps 118 and 120). The method 100 may be implemented on a computing system comprising processing circuitry and storage configured to execute the proof generation and verification operations.

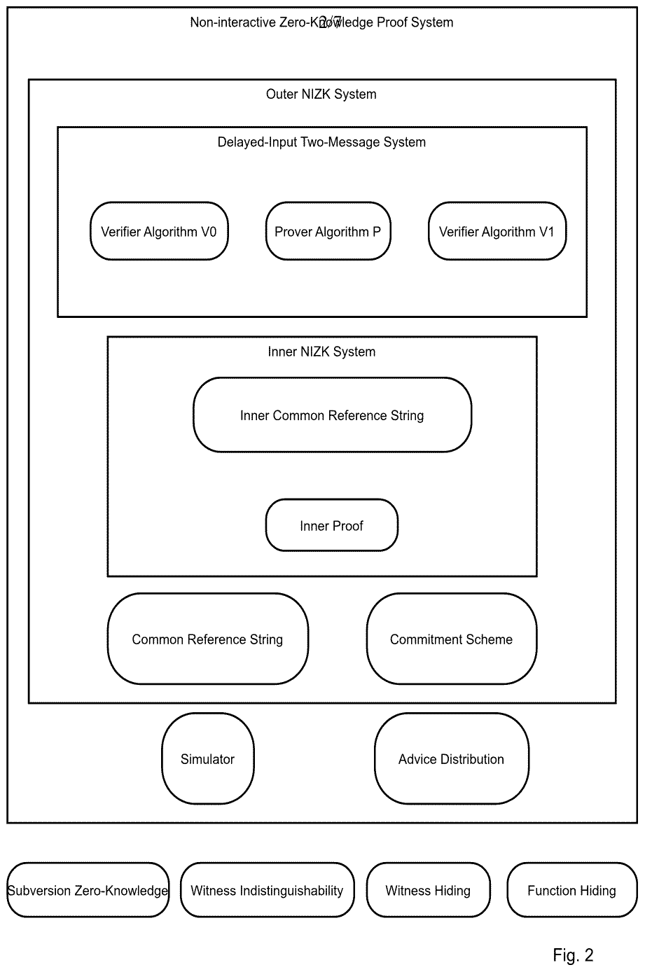

Referring to FIG. 2, a block diagram of a non-interactive zero-knowledge proof system is illustrated. The non-interactive zero-knowledge proof system may comprise multiple nested components arranged in a hierarchical structure. An Outer NIZK System may form the outermost layer of the non-interactive zero-knowledge proof system and may encompass several subsystems and components.

The Outer NIZK System may contain a Delayed-Input Two-Message System. The Delayed-Input Two-Message System may comprise three components: a Verifier Algorithm V0, a Prover Algorithm P, and a Verifier Algorithm V1. The Verifier Algorithm V0 may generate a first message independent of the statement to be proven. The Prover Algorithm P may generate a second message dependent on the statement and the first message. The Verifier Algorithm V1 may decide whether to accept or reject based on the transcript. In some cases, the three components are arranged horizontally to represent sequential interaction between the components.

With continued reference to FIG. 2, the Delayed-Input Two-Message System may be publicly verifiable such that the verifier does not keep a secret state after generating the first message. For every non-uniform probabilistic polynomial-time adversarial verifier, there may exist a probabilistic polynomial-time simulator and an S)-time computable advice distribution, such that the view of the adversary in a real proof generation process is computationally indistinguishable from the view of the adversary in an ideal simulation process. The simulator, given a sample from the advice distribution, may efficiently generate transcripts for multiple statements that are indistinguishable from transcripts generated by an honest prover interacting with the adversarial verifier. The Delayed-Input Two-Message System may provide perfect completeness and T-adaptive soundness for NP languages.

The non-interactive zero-knowledge proof system may include an Inner NIZK System. The Inner NIZK System may contain an Inner Common Reference String and an Inner Proof component. The Inner Common Reference String may provide parameters for proof generation within the Inner NIZK System. The Inner Proof component may generate proofs based on the Inner Common Reference String and input statements.

As further shown in FIG. 2, a Common Reference String component and a Commitment Scheme component may be positioned adjacent to the Inner NIZK System. The Commitment Scheme may comprise a non-interactive perfectly binding and T-extractable commitment scheme. The Commitment Scheme may provide binding properties for messages exchanged within the non-interactive zero-knowledge proof system.

The non-interactive zero-knowledge proof system may include a Simulator component and an Advice Distribution component. The Simulator and the Advice Distribution may operate outside the main system boundary of the Outer NIZK System but may interact with the Outer NIZK System. The Simulator may enable simulation of proof generation. The Advice Distribution may provide parameters for the simulation process.

In some cases, the Delayed-Input Two-Message System may be constructed using a T-hard trapdoor generation protocol, a non-interactive perfectly binding and T-extractable commitment scheme, and a delayed-input, two-message, T-sound and publicly-verifiable witness indistinguishable argument for a language that combines the statement to be proven and the trapdoor.

With continued reference to FIG. 2, the non-interactive zero-knowledge proof system may utilize sub-exponential hardness of learning with errors (LWE) as the cryptographic foundation for constructing a subversion advice-ZK NIZK. LWE refers to a computational problem where distinguishing between random linear equations with small errors and uniformly random equations is computationally difficult.

The non-interactive zero-knowledge proof system may be provided without subversion security in an initial configuration. In some cases, the non-interactive zero-knowledge proof system with subversion zero-knowledge security may satisfy perfect completeness and computational adaptive soundness when the common reference string is honestly generated.

FIG. 2 illustrates four security properties represented as separate components: Subversion Zero-Knowledge, Witness Indistinguishability, Witness Hiding, and Function Hiding. The security properties may be arranged horizontally and positioned outside the main system boundary of the Outer NIZK System.

Subversion Zero-Knowledge may provide security guarantees even when the common reference string is maliciously generated. Witness Indistinguishability may ensure that proofs generated using different witnesses for the same statement are computationally indistinguishable. Witness Hiding may ensure that an adversary cannot extract the witness from a proof. Function Hiding may ensure that the function being computed remains hidden from adversaries.

In some cases, the subversion zero-knowledge security may imply that the non-interactive zero-knowledge proof system satisfies subversion witness indistinguishability, subversion witness hiding, and subversion function hiding properties. The diagram in FIG. 2 uses nested rectangular boxes to show the hierarchical relationship between different components and subsystems, with labels identifying each element's function within the overall proof system.

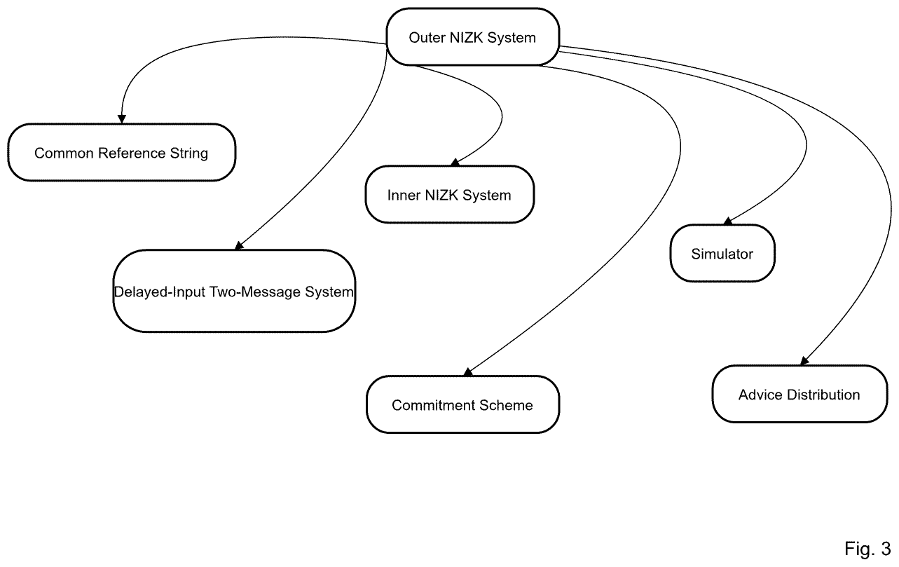

Referring to FIG. 3, a system diagram illustrates a non-interactive zero-knowledge (NIZK) proof system with subversion security. The system comprises an Outer NIZK System that serves as a framework for generating and verifying zero-knowledge proofs in a common reference string model where a trusted setup authority may be corrupted. The Outer NIZK System connects to multiple components through directed arrows that indicate information flow and dependencies between the components.

A Common Reference String component connects to the Outer NIZK System and provides parameters for proof generation. In some cases, the common reference string CRS may be parsed as (CRS_{Inner}, zk₁), where CRS_{Inner} represents an inner common reference string and zk₁ represents a first message from a delayed-input two-message system. The system incorporates a Delayed-Input Two-Message System that handles a communication protocol between proving and verifying parties. The Delayed-Input Two-Message System may implement a publicly-verifiable S-advice zero-knowledge argument system that enables computation of messages for proof generation.

With continued reference to FIG. 3, an Inner NIZK System exists within the framework and processes internal proofs. The Inner NIZK System may receive an inner common reference string CRS_{Inner} and generate an inner proof π_{Inner} for statements involving the delayed-input two-message system. In some cases, the inner proof π_{Inner} may be computed for a statement that there exists a second message zk₂ such that a verifier algorithm V₁ of the delayed-input two-message publicly-verifiable S-advice zero-knowledge argument system accepts (zk₁, zk₂) and a commitment c is a commitment to zk₂.

The system includes a Commitment Scheme component that provides binding properties for messages exchanged during proof generation. The Commitment Scheme may receive the second message zk₂ and produce the commitment c that binds the prover to the second message without revealing the message content. In a method for generating a proof π for the outer NIZK system, the method may comprise computing the second message zk₂ using a statement x and witness w as inputs to a prover algorithm P of the delayed-input two-message publicly-verifiable S-advice zero-knowledge argument system. The method may further comprise computing the inner proof π_{Inner} for the statement that there exists a zk₂ such that the verifier algorithm V₁ of the delayed-input two-message publicly-verifiable S-advice zero-knowledge argument system accepts (zk₁, zk₂) and c is a commitment to zk₂.

As further shown in FIG. 3, a Simulator component connects to the Outer NIZK System to enable simulation of proof generation. An Advice Distribution component provides parameters for the simulation process. In some cases, an [symbol] (λ)-time computable advice distribution [symbol] may be independent of the statement to be proven and may be sampled in super-polynomial time [symbol] (λ), where [symbol] is a function of a security parameter λ but independent of a hardness of a language L. The advice distribution, [symbol] enables the simulator to produce proofs that are indistinguishable from real proofs even when the common reference string is maliciously generated.

The system introduces accountable soundness as a strengthened notion of traditional soundness that provides verification guarantees even when the trusted setup authority is corrupted. Accountable soundness ensures that if a malicious authority generates a common reference string that allows false proofs to be accepted, evidence of the authority's misbehavior may be extracted. The system employs generic compilers that transform any NIZK for NP languages to additionally achieve accountable soundness properties. The generic compilers may take an existing NIZK system for a language in NP and augment the NIZK system with additional mechanisms that enable detection of corrupted setup parameters.

In a method for verifying a proof for the outer NIZK system, the method may comprise parsing the common reference string CRS as (CRS_{Inner}, zk₁). The method may further comprise parsing the proof π as (π_{Inner}, c). The method may then comprise verifying the inner proof π_{Inner} for the statement (x, zk₁, c) using the inner NIZK system. The hierarchical structure shown in FIG. 3 enables the combination of subversion advice zero-knowledge properties with accountable soundness properties, resulting in a NIZK construction that satisfies meaningful notions of both soundness and zero-knowledge even for maliciously chosen common reference strings.

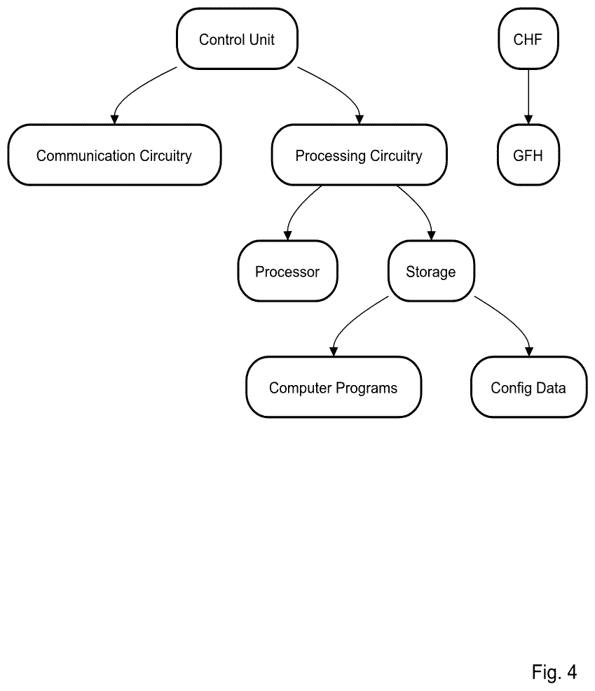

Referring to FIG. 4, a computing system architecture for generating and verifying a non-interactive zero-knowledge proof providing subversion zero-knowledge security against malicious common reference strings may comprise a Control Unit, Communication Circuitry, Processing Circuitry, a Processor, Storage, Computer Programs, and Config Data components. The computing system architecture may implement a system for generating and verifying a non-interactive zero-knowledge proof with subversion zero-knowledge security.

The Control Unit may coordinate operations across the computing system architecture and may manage the execution of cryptographic operations associated with the non-interactive zero-knowledge proof system. The Control Unit may connect to the Communication Circuitry and the Processing Circuitry to facilitate data exchange and computational operations. The Communication Circuitry may handle input and output operations for the computing system architecture, including receiving statements to be proven and transmitting generated proofs to external systems.

With continued reference to FIG. 4, the Processing Circuitry may branch into a Processor component and a Storage component. The Processor may execute instructions stored in the Storage component to perform the operations of the non-interactive zero-knowledge proof system with subversion zero-knowledge security. The system may comprise the Processor and a memory (implemented as the Storage component) storing instructions that, when executed by the Processor, cause the system to provide a non-interactive zero-knowledge proof system with subversion zero-knowledge security.

The Storage component may connect to Computer Programs and Config Data com ponents. The Computer Programs component may store executable instructions that implement the non-interactive zero-knowledge proof system operations, including proof generation and verification algorithms. The Config Data component may store configuration parameters, including common reference strings, commitment scheme parameters, and other cryptographic parameters used by the proof system.

The subversion zero-knowledge security may comprise that for every non-uniform probabilistic polynomial-time adversary [symbol] that generates a potentially malicious common reference string CRS, there exists a probabilistic polynomial-time time simulator [symbol] and an [symbol] (λ)-time computable advice distribution [symbol] such that the view of [symbol] in a real proof generation process [symbol] (λ) is computationally indistinguishable from the view of [symbol] in an ideal simulation process [symbol] (λ).

As further shown in FIG. 4, the computing system architecture may include a Cryptographic Hash Function (CHF) component connected to a Group Function Hash (GFH) component. The CHF and GFH components may operate independently from the main system hierarchy and may provide cryptographic primitives used in the non-interactive zero-knowledge proof system operations.

The CHF component may implement hash functions used in the commitment scheme and in generating challenges for the proof system. The CHF component may support the non-interactive perfectly binding and T-extractable commitment scheme used in the proof generation process. The GFH component may implement group-based hash functions that support the algebraic operations in the proof system, including operations related to the delayed-input two-message publicly-verifiable S-advice zero-knowledge argument system.

The instructions stored in the memory may cause the system to generate and verify the non-interactive zero-knowledge proof using a combination of: a provided non-interactive zero-knowledge proof system that optionally provides no subversion security; a delayed-input two-message publicly-verifiable S-advice zero-knowledge argument system; and a non-interactive perfectly binding and T-extractable commitment scheme.

The delayed-input two-message publicly-verifiable S-advice zero-knowledge argument system may comprise: a verifier algorithm V₀ that generates a first message independent of the statement to be proven; a prover algorithm P that generates a second message dependent on the statement and the first message; and a verifier algorithm V₁ that decides whether to accept or reject based on the transcript. The system may be publicly verifiable such that the verifier does not keep a secret state after generating the first message.

For every non-uniform probabilistic polynomial-time adversarial verifier, there may exist a probabilistic polynomial-time simulator and an S(λ)-time computable advice distribution, such that the view of the adversary in a real proof generation process is computationally indistinguishable from its view in an ideal simulation process. The simulator, given a sample from the advice distribution, may efficiently generate transcripts for multiple statements that are indistinguishable from transcripts generated by an honest prover interacting with the adversarial verifier. The system may provide perfect completeness and T-adaptive soundness for NP languages.

The instructions may further cause the system to generate and verify the non-interactive zero-knowledge proof with subversion zero-knowledge security (referred to as the outer NIZK system) by generating a common reference string CRS for the outer NIZK system. Generating the common reference string may comprise generating an inner common reference string CRS_{Inner} using a first non-interactive zero-knowledge argument system (referred to as the inner NIZK system), and computing a first message zk₁ using the delayed-input two-message publicly-verifiable S-advice zero-knowledge argument system.

The instructions may cause the system to generate a proof π for the outer NIZK system by computing a second message zk₂ using the delayed-input two-message publicly-verifiable S-advice zero-knowledge argument system, committing to the second message using the non-interactive perfectly binding and T-extractable commitment scheme to obtain a commitment c, and computing an inner proof π_{Inner} using the inner NIZK system. The instructions may cause the system to verify the proof for the outer NIZK system by verifying the inner proof using the inner NIZK system.

The delayed-input two-message publicly-verifiable S-advice zero-knowledge argument system may be constructed using: a T-hard trapdoor generation protocol; a non-interactive perfectly binding and T-extractable commitment scheme; and a delayed-input, two-message, T-sound and publicly-verifiable witness indistinguishable argument for a language that combines the statement to be proven and the trapdoor.

The non-interactive zero-knowledge proof system with subversion zero-knowledge security may satisfy perfect completeness and computational adaptive soundness when the common reference string is honestly generated.

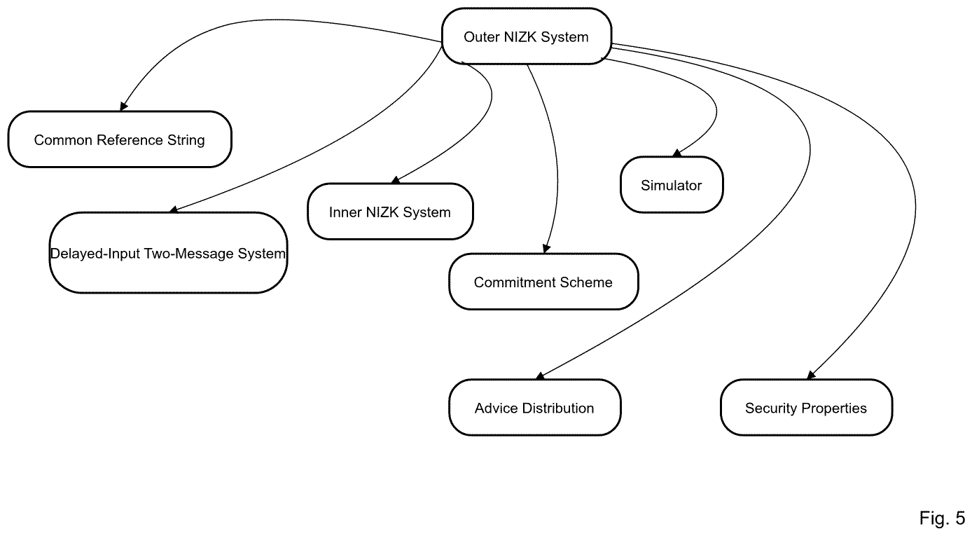

Referring to FIG. 5, a block diagram illustrates a non-interactive zero-knowledge (NIZK) proof system with subversion security. The system includes an Outer NIZK System positioned at the top of the diagram, which connects to multiple components through directed arrows indicating information flow. The distributed layout of the Outer NIZK System enables the system to combine subversion advice-ZK and accountable soundness to achieve a NIZK construction satisfying both soundness and zero-knowledge properties for maliciously chosen CRS.

With continued reference to FIG. 5, a Common Reference String component connects to the Outer NIZK System. In some cases, the common reference string CRS may be parsed as (CRS_{Inner}, zk₁), where CRS_{Inner} represents an inner common reference string and zk₁ represents a first message of a delayed-input two-message system. A Delayed-Input Two-Message System component is positioned to the left side of the diagram and may provide a publicly-verifiable S-advice zero-knowledge argument system. The Delayed-Input Two-Message System may include a prover algorithm P and a verifier algorithm V₁ that operate on messages exchanged between proving and verifying parties.

As further shown in FIG. 5, an Inner NIZK System component is located in the center of the diagram. The Inner NIZK System may be used to compute an inner proof π_{Inner} for a statement that there exists a zk₂ such that the verifier algorithm V₁ of the delayed-input two-message publicly-verifiable S-advice zero-knowledge argument system accepts (zk₁, zk₂) and c is a commitment to zk₂. The system incorporates a Commitment Scheme component that connects to the Outer NIZK System. The Commitment Scheme may provide binding properties for messages, including the commitment c to the second message zk₂.

With continued reference to FIG. 5, a Simulator component and an Advice Distribution component are positioned on the right side of the diagram, both connected to the Outer NIZK System through directed arrows. The Advice Distribution may comprise an S(λ)-time computable advice distribution [symbol] that is independent of the statement to be proven and can be sampled in super-polynomial time S(λ), where S is a function of a security parameter λ but independent of the hardness of a language L. At the bottom right, a Security Properties component is shown with a connection to the Outer NIZK System.

In some cases, generating a proof π for the outer NIZK system may further comprise computing the second message zk₂ using a statement x and witness w as inputs to the prover algorithm P of the delayed-input two-message publicly-verifiable S-advice zero-knowledge argument system. The proof generation may further comprise computing the inner proof π_{Inner} for the statement that there exists a zk₂ such that the verifier algorithm V₁ of the delayed-input two-message publicly-verifiable S-advice zero-knowledge argument system accepts (zk₁, zk₂) and c is a commitment to zk₂.

As further shown in FIG. 5, verifying the proof for the outer NIZK system may further comprise parsing the common reference string CRS as (CRS_{Inner}, zk₁), parsing the proof π as (π_{Inner}, c), and verifying the inner proof π_{Inner} for the statement (x, zk₁, c) using the inner NIZK system. The curved arrows in the diagram indicate the relationships and interactions between different parts of the system during verification operations.

The Security Properties component shown in FIG. 5 may represent subversion zero-knowledge security properties. In some cases, the subversion zero-knowledge security implies that the non-interactive zero-knowledge proof system satisfies subversion witness indistinguishability, subversion witness hiding, and subversion function hiding proper ties. The combined ZK-soundness NIZK construction achieves both soundness and zero-knowledge properties even when the CRS is maliciously chosen by a corrupted authority.

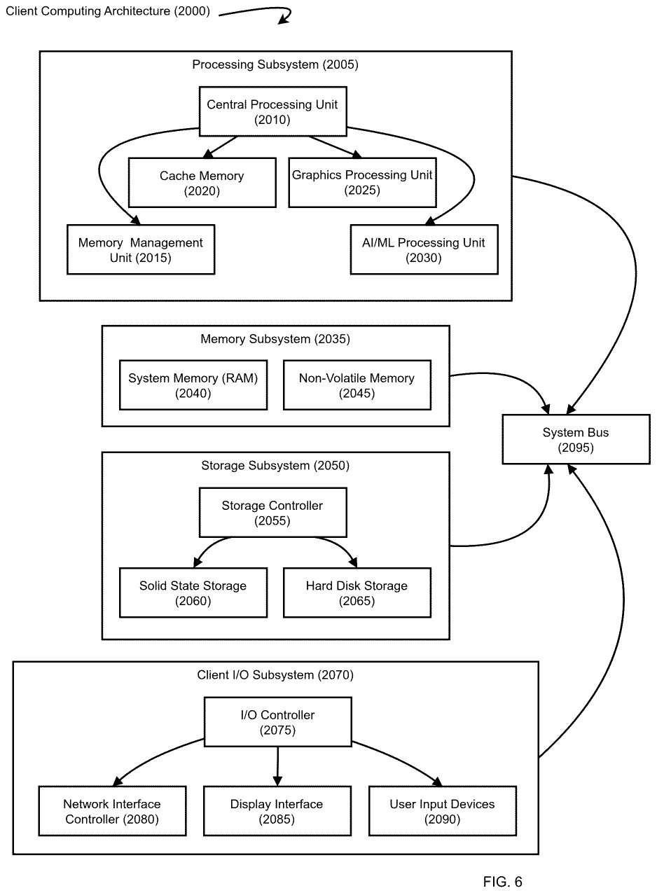

Referring to FIG. 6, a client computing architecture 2000 may provide hardware and software resources for executing non-interactive zero-knowledge proof systems with subversion zero-knowledge security. The client computing architecture 2000 may comprise a processing subsystem 2005, a memory subsystem 2035, a storage subsystem 2050, a client I/O subsystem 2070, and a system bus 2095 that interconnects these subsystems.

The processing subsystem 2005 may include a central processing unit 2010 that serves as a primary computational element for executing proof generation and verification operations. The central processing unit 2010 may execute instructions stored on a non-transitory computer-readable medium that, when executed by a processor, cause the processor to perform a method for generating and verifying a non-interactive zero-knowledge proof providing subversion zero-knowledge security against malicious common reference strings. The processing subsystem 2005 may execute non-interactive proof and argument systems that do not require interaction between prover and verifier after initial setup.

With continued reference to FIG. 6, the processing subsystem 2005 may further include a memory management unit 2015 that handles memory operations during proof computation. A cache memory 2020 may connect to the central processing unit 2010 to provide rapid access to frequently used data during cryptographic operations. The processing subsystem 2005 may include a graphics processing unit 2025 that provides parallel processing capabilities for computationally intensive operations such as those involved in generating a common reference string CRS for an outer NIZK system or computing messages using a delayed-input two-message publicly-verifiable S-advice zero-knowledge argument system.

The processing subsystem 2005 may further include an AI/ML processing unit 2030 that provides specialized processing capabilities. The AI/ML processing unit 2030 may accelerate operations related to the delayed-input two-message publicly-verifiable S-advice zero-knowledge argument system, which comprises a verifier algorithm V₀ that generates a first message independent of the statement to be proven, a prover algorithm P that generates a second message dependent on the statement and the first message, and a verifier algorithm V₁ that decides whether to accept or reject based on the transcript.

As further shown in FIG. 6, the memory subsystem 2035 may comprise a system memory 2040 implemented as RAM for volatile data storage during proof generation and verification processes. The system memory 2040 may store intermediate computational results when computing a second message zk₂ using the delayed-input two-message publicly-verifiable S-advice zero-knowledge argument system, committing to the second message using a non-interactive perfectly binding and T-extractable commitment scheme to obtain a commitment c, and computing an inner proof π_{Inner} using an inner NIZK system. The memory subsystem 2035 may further include a non-volatile memory 2045 for persistent data retention of cryptographic parameters.

The storage subsystem 2050 may include a storage controller 2055 that manages data storage operations for the non-interactive zero-knowledge proof system. The storage controller 2055 may interface with a solid state storage 2060 and a hard disk storage 2065, providing storage options for proof data, common reference strings, and commitment values. The solid state storage 2060 may store an inner common reference string CRS_{Inner} generated using a first non-interactive zero-knowledge argument system (referred to as the inner NIZK system) and a first message zk₁ computed using the delayed-input two-message publicly-verifiable S-advice zero-knowledge argument system.

With continued reference to FIG. 6, the client I/O subsystem 2070 may comprise an I/O controller 2075 that coordinates input and output operations for the proof system. The I/O controller 2075 may connect to a network interface controller 2080 for network communications, enabling transmission of proofs and verification results between parties. The client I/O subsystem 2070 may further include a display interface 2085 for visual output of verification results and user input devices 2090 for receiving user commands related to proof generation.

The system bus 2095 may provide a communication pathway that interconnects the processing subsystem 2005, the memory subsystem 2035, the storage subsystem 2050, and the client I/O subsystem 2070. The system bus 2095 may enable data transfer and coordination between all components of the client computing architecture 2000 during execution of the non-interactive zero-knowledge proof system with subversion zero-knowledge security.

In some cases, the client computing architecture 2000 may support verification of the proof for the outer NIZK system by verifying the inner proof using the inner NIZK system. The delayed-input two-message publicly-verifiable S-advice zero-knowledge argument system may be constructed using a T-hard trapdoor generation protocol, a non-interactive perfectly binding and T-extractable commitment scheme, and a delayed-input, two-message, T-sound and publicly-verifiable witness indistinguishable argument for a language that combines the statement to be proven and the trapdoor. The non-interactive zero-knowledge proof system with subversion zero-knowledge security may satisfy perfect completeness and computational adaptive soundness when the common reference string is honestly generated.

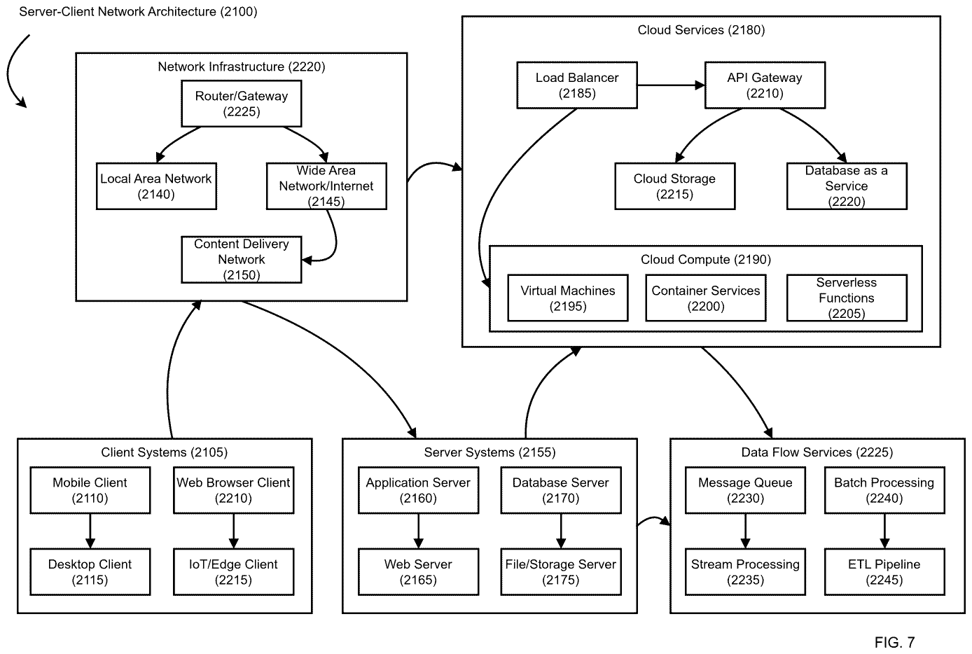

Referring to FIG. 7, a server-client network architecture 2100 may be configured to implement the non-interactive zero-knowledge proof system with subversion security. The server-client network architecture 2100 may comprise client systems 2105, server systems 2155, cloud services 2180, and data flow services 2225 interconnected through network infrastructure.

The client systems 2105 may include a mobile client 2110 and a desktop client 2115. The mobile client 2110 may comprise a smartphone, tablet, or other portable computing device configured to generate or verify non-interactive zero-knowledge proofs. The desk top client 2115 may comprise a personal computer or workstation configured to perform proof generation and verification operations. In some cases, the client systems 2105 may execute instructions stored on a non-transitory computer-readable medium to implement the proof system operations.

With continued reference to FIG. 7, the server-client network architecture 2100 may include network components that facilitate communication between the client systems 2105 and the server systems 2155. A local area network 2140 may provide connectivity within a localized geographic area. A wide area network/internet 2145 may extend connectivity across broader geographic regions. A content delivery network 2150 may dis tribute proof system components and data across multiple geographic locations to reduce latency and improve accessibility.

The server systems 2155 may comprise an application server 2160, a web server 2165, a database server 2170, and a file/storage server 2175. The application server 2160 may execute the proof generation and verification algorithms, including computing the second message zk₂ using the statement x and witness w as inputs to the prover algorithm P of the delayed-input two-message publicly-verifiable S-notion zero-knowledge argument system. The web server 2165 may provide interface functionality for accessing the proof system. The database server 2170 may store common reference strings, proofs, and related cryptographic parameters. The file/storage server 2175 may maintain proof system configuration data and archived proofs.

As further shown in FIG. 7, the cloud services 2180 may provide scalable computing resources for the proof system. A load balancer 2185 may distribute proof generation and verification requests across multiple computing resources. A cloud compute 2190 subsystem may include virtual machines 2195, container services 2200, and serverless functions 2205. The virtual machines 2195 may execute proof system operations in isolated computing environments. The container services 2200 may deploy proof system components in containerized environments. The serverless functions 2205 may execute discrete proof system operations on demand.

An API gateway 2210 may provide access management for the cloud services 2180, enabling the client systems 2105 to submit proof generation and verification requests. A cloud storage 2215 component may store common reference strings, including the inner common reference string CRS_{Inner} and the first message zk₁. A database as a service 2220 component may provide managed database functionality for storing proof system data.

With continued reference to FIG. 7, the data flow services 2225 may facilitate data movement within the server-client network architecture 2100. A message queue 2230 may buffer proof generation and verification requests. A stream processing 2235 component may process proof system data in real-time. A batch processing 2240 component may process multiple proofs in batched operations. An ETL pipeline 2245 may extract, transform, and load proof system data between storage components.

In some cases, the server-client network architecture 2100 may execute instructions stored on a non-transitory computer-readable medium to compute the inner proof π_{Inner} for the statement that there exists a zk₂ such that the verifier algorithm V₁ of the delayed-input two-message publicly-verifiable S-notion zero-knowledge argument system accepts (zk₁, zk₂) and c is a commitment to zk₂.

The server-client network architecture 2100 may verify proofs by parsing the common reference string CRS as (CRS_{Inner}, zk₁), parsing the proof π as (π_{Inner}, c), and verifying the inner proof π_{Inner} for the statement (x, zk₁, c) using the inner NIZK system.

In some cases, the S)-time computable advice distribution [symbol] may be independent of the statement to be proven and may be sampled in super-polynomial time S(q), where S is a function of the security parameter A but independent of the hardness of the language L. The server-client network architecture 2100 may utilize the cloud compute 2190 resources to perform the super-polynomial time sampling operations.

The non-interactive zero-knowledge (NIZK) proof system with subversion security may be applied to various practical applications across multiple domains. The following describes several applications where the NIZK proof system provides privacy-preserving verification capabilities.

In cryptocurrency systems, the NIZK proof system may be applied to transaction verification while maintaining user privacy. In the ZCash cryptocurrency system, a proof system exists for a language referred to as POUR. In the POUR transaction language, a user pours old coins into new coins. The statement in the POUR language consists of commitments to hidden values. The NIZK proof system with subversion security may capture such proof systems through a generalization that handles languages involving commitments. The subversion security properties ensure that even when the common reference string is generated by a potentially malicious authority, the privacy of the transaction remains protected and the soundness of the proof system remains verifiable.

The NIZK proof system may be applied to the GMW compiler for transforming multi party computation protocols from semi-honest security to malicious security. The GMW compiler was first proposed as a transformation mechanism for enhancing the security guarantees of multi-party computation protocols. The NIZK proof system with subversion security may capture NIZK languages used in the GMW compiler. In one application, the GMW compiler may be applied to Yao's semi-honest two-party protocol. In Yao's protocol, two parties compute a function on their private inputs without revealing those inputs to each other. The GMW compiler uses NIZK proofs to ensure that each party follows the protocol correctly, transforming the semi-honest security guarantee into malicious security. The subversion security properties of the NIZK proof system ensure that the transformation remains secure even when the trusted setup is performed by a potentially corrupted authority.

In blockchain systems, the NIZK proof system may be used to verify transactions without revealing sensitive information. The NIZK proof system allows a prover to demonstrate that a transaction is valid according to the rules of the blockchain protocol without disclosing the transaction details. The subversion zero-knowledge property ensures that transaction privacy is maintained even when the common reference string is maliciously generated. The accountable soundness property ensures that if a false proof is accepted, the malicious authority that generated the common reference string can be identified and held accountable.

In secure communications, the NIZK proof system may be applied to digital signature schemes. A signer may use the NIZK proof system to prove knowledge of a signing key without revealing the signing key itself. The subversion security properties ensure that the signature scheme remains secure even when the setup parameters are generated by an untrusted party.

The NIZK proof system may also be applied to secure voting systems. In a secure voting system, a voter may use the NIZK proof system to prove that a vote is valid without revealing the contents of the vote. The zero-knowledge property ensures voter privacy, while the soundness property ensures that invalid votes cannot be accepted. The subversion security properties provide additional guarantees that the voting system remains secure even when the election authority that generates the common reference string may be compromised or malicious.

Throughout this disclosure, various terms and phrases are used to describe features of the disclosed technology. It is to be understood that these terms and phrases may encompass a variety of meanings and definitions, as is common in the field of technology and patent law. The definitions of these terms may vary depending on the context in which they are used, the specific embodiment being described, or the interpretation of the technology by those skilled in the art.

In various embodiments, certain variable names, symbols, or labels may be used in the claims to represent various elements, components, or steps of the described methods, systems, and apparatuses. These variable names, symbols, or labels are provided for convenience and clarity in describing the claimed subject matter. However, it should be understood that the use of such variable names, symbols, or labels in the claims does not necessarily limit these elements, components, or steps to being the same specific entities described in the specification or in other parts of the disclosure. The variable names, symbols, or labels used in the claims should be interpreted broadly and may encompass various implementations, variations, or equivalents of the described elements, components, or steps, unless explicitly stated otherwise or clearly limited by the context of the claim. As such, the scope of the claims is not confined to the specific examples or embodiments described in the specification, but rather extends to the full breadth of the inventive concepts disclosed herein.

For instance, terms such as “computing device,” “processor,” “memory,” and “net work” may refer to a wide range of devices, components, systems, and configurations known in the art, and their specific definitions may differ based on the implementation or design of the system. Similarly, phrases like “securely storing,” “computing a vector,” and “generating a message” may involve various methods, techniques, and processes that achieve the same or similar outcomes but may be executed in different manners. It is also to be understood that the use of terms in the singular or plural form is not intended to limit the scope of the claims. For example, the mention of “a computing device” does not preclude the presence of multiple computing devices within a system. Likewise, references to “a network” may include various interconnected networks or a single network comprising multiple segments or layers.

Furthermore, the use of the term “may” in relation to an action or feature indicates that the action or feature is possible, but not necessarily mandatory. This term is used to describe optional or alternative aspects of the disclosed technology that provide flexibility in how the technology may be implemented or utilized.

The definitions provided herein are intended to serve as examples and are not exhaustive. Those skilled in the art may ascribe different meanings to these terms based on the context, the specific technology being described, or the advancements in the field. Therefore, the definitions of the terms and phrases used in this disclosure and the claims are to be interpreted broadly and in a manner consistent with the understanding of those skilled in the relevant art.

The use of the word “a” or “an” when used in conjunction with the claims herein is to be interpreted as including one or more than one of the element it introduces. Similarly, the use of the term “or” is intended to be inclusive, such that the phrase “A or B” is intended to include A, B, or both A and B, unless explicitly stated otherwise.

Reference throughout the specification to “one embodiment,” “another embodiment,” “an embodiment,” and so forth, means that a particular feature, structure, or characteristic described in connection with the embodiment is included in at least one embodiment of the present disclosure, and may not necessarily be present in all embodiments. Furthermore, the particular features, structures, or characteristics may be combined in any suitable manner in one or more embodiments without limitation.

The use of the terms “first,” “second,” and the like does not imply any order or sequence, but are used to distinguish one element from another, and the terms “top,” “bottom,” “front,” “back,” “leading,” “trailing,” and the like are used for descriptive purposes and are not necessarily to be construed as limiting.

As used herein, the term “processor” refers to any computing entity capable of executing instructions to perform a specific set of operations, whether implemented in hardware, firmware, software, or any combination thereof. This definition includes a broad range of processing technologies and architectures. The term encompasses general-purpose processors such as Central Processing Units (CPUs), specialized processors such as Graphics Processing Units (CPUs), as well as highly specialized hardware accelerators such as Neural Processing Units (NPUs) for artificial intelligence applications and Tensor Processing Units (TPUs) for machine learning workloads.

The term also encompasses reconfigurable computing architectures such as Field-Programmable Gate Arrays (FPGAs) for applications requiring specialized processing configurations, Application-Specific Integrated Circuits (ASICs), Digital Signal Processors (DSPs), Systolic Array Processors, and emerging computing paradigms such as Quantum Processors that leverage principles of quantum mechanics. System on Chip (SoC) designs, heterogeneous computing systems, Edge Computing Processors for dis tributed network applications, cloud-based and distributed processors, multi-core and parallel processors, and Neuromorphic processors that draw inspiration from biological neural architectures are all encompassed within this definition.

The term “processor” also encompasses the associated memory hierarchies, including primary memory (such as RAM), secondary storage (such as hard drives and SSDs), and cache memory, which work in conjunction with the processor to store and retrieve data necessary for executing instructions. In this patent application, any reference to a “processor” should be interpreted broadly to include any type of processing unit capable of performing the described functions, regardless of its specific implementation, architecture, or physical form.

As used herein, the term “messages” may refer to any form of data or information that can be processed, transmitted, or stored in a digital format. Messages may include arbitrary-length plaintext messages, pre-hashed messages, concatenated messages, binary data, network protocol messages, database records, and time-stamped messages. Messages may be composed of characters, symbols, or binary data and may represent various forms of content such as text, numbers, multimedia, executable code, or any other data that can be digitally encoded. Messages may be used as input for cryptographic functions, such as keyed hash functions, where they are transformed into a fixed-size hash value influenced by a secret cryptographic key.

The term “messages” encompasses a wide range of data types and structures, from simple text strings to complex structured data, and may include metadata, headers, foot ers, or other information that facilitates the processing, transmission, or interpretation of the content. Messages may be generated by users, systems, or processes and may be intended for various purposes, including communication, authentication, verification, logging, or any other function that involves the use of digital data.

Messages may also include data formats specific to artificial intelligence and machine learning applications, such as tensors, feature vectors, embeddings, model parameters, activation maps, training examples, and inference requests. In distributed and edge computing contexts, the term “messages” further extends to include event streams, state updates, service requests, synchronization messages, and smart contract transactions used in blockchain platforms.

As used herein, the terms “store,” “storing,” “storage,” or variants thereof refer to any means, methods, systems, or processes for recording, retaining, or preserving data in a retrievable format. This terminology encompasses a broad spectrum of technologies and mechanisms that may be employed to maintain information for future access or reference.

The term “storing” or “storage” as used in this specification may encompass both persistent and transient data retention. In some cases, the storage may be entirely ephemeral, lasting only for the duration of a specific operation or process. The use of these terms does not imply any particular time period for data retention or any level of permanence. Storage and storing may be as brief as a few microseconds or indefinitely long, depending on the specific implementation and requirements of the system.

The term includes traditional electronic storage technologies such as magnetic storage (including hard disk drives, magnetic tape, and floppy disks), optical storage (including optical discs, holographic storage, and optical tape), and solid-state storage (including solid-state drives, flash memory, static random-access memory, dynamic random-access memory, and read-only memory). It also encompasses emerging storage technologies such as DNA storage, molecular storage, quantum storage, and photonic storage.

Storage terminology may refer to various architectural organizations and hierarchies of data repositories. This includes primary storage (main memory, cache memory) designed for rapid access during processing operations; secondary storage providing non-volatile retention of larger data volumes; and tertiary storage for archival purposes. The terminology extends to distributed storage architectures such as network-attached storage (NAS), storage area networks (SAN), direct-attached storage (DAS), and object storage systems. It also includes cloud-based storage configurations, including public, private, and hybrid cloud storage implementations; edge storage systems located at network peripheries; and fog storage systems distributed between centralized and edge locations.

The definition encompasses storage virtualization technologies that abstract physical storage resources and present them as logical storage units, including virtual disks, software-defined storage, and storage hypervisors. It also includes storage orchestration systems that manage data placement, replication, and migration across distributed infrastructures.

The terminology extends to various data organization and management paradigms. This includes file systems that organize data into files and directories; block storage systems that manage data as fixed-sized blocks; object storage systems that handle data as discrete objects with metadata; and content-addressable storage systems that retrieve data based on content rather than location. It also includes specialized storage structures such as databases, data lakes, data warehouses, and knowledge repositories.

Storage terminology encompasses various operational characteristics and capabilities of storage systems. This includes persistent storage that maintains data integrity across power cycles; volatile storage that requires continuous power to retain data; and non-volatile storage that preserves data without power. It also includes immutable storage that prevents modification of stored data; append-only storage that allows additions but not modifications; and version-controlled storage that maintains historical states of data. The term further encompasses encrypted storage that protects data confidentiality; redundant storage that duplicates data to prevent loss; and resilient storage that maintains availability despite component failures.

In specialized computing contexts, storage terminology may refer to domain-specific storage mechanisms. For blockchain and distributed ledger technologies, this includes on-chain storage within the blockchain itself and off-chain storage that maintains references to externally stored data. For neural networks and artificial intelligence systems, it includes weight storage for maintaining learned parameters and activation storage for intermediate computational results. For quantum computing systems, it refers to quantum state storage that preserves quantum information, while for edge computing, it includes transient storage for temporary data processing at network boundaries.

The term “storage” also encompasses the protocols, interfaces, and access methods used to interact with stored data. This includes file access protocols (such as NFS, SMB, and HDFS), block access protocols (such as iSCSI, Fibre Channel, and ATA), and object access protocols (such as S3, Swift, and CDMI). It also includes direct memory access mechanisms, memory-mapped file interfaces, and storage controller interfaces.

The term “database” should be construed to mean a blockchain, distributed ledger technology, key-value store, document-oriented database, graph database, time-series database, in-memory database, columnar database, object-oriented database, hierarchical database, network database, or any other structured data storage system capable of storing and retrieving information. This may include traditional relational database management systems (RDBMS), NoSQL databases, NewSQL databases, or hybrid database systems that combine multiple database paradigms. The database may be centralized, distributed, or decentralized, and may employ various data models, indexing strategies, and query languages to organize and access the stored information. It may also incorporate features such as ACID (Atomicity, Consistency, Isolation, Durability) compliance, eventual consistency, sharding, replication, or partitioning to ensure data integrity, avail ability, and scalability. The database may be hosted on-premises, in the cloud, or in a hybrid environment, and may support various access methods including direct queries, API calls, or event-driven architectures.

The term “database” further encompasses specialized data storage and management systems designed for particular domains or use cases. This includes blockchain and distributed ledger technologies used for secure, decentralized transaction records, edge databases optimized for resource-constrained environments, vector databases for high-dimensional data, time-series databases for temporal data management, knowledge graphs for representing interconnected information, federated databases for integrating autonomous systems, and emerging paradigms such as quantum databases that leverage quantum computing principles.

The terms “connected,” “coupled,” or any variant thereof, mean any direct or indirect connection or coupling between two or more elements, and may encompass the presence of one or more intermediate elements between the two elements that are connected or coupled to each other.

In the context of modern computing architectures and network topologies, these terms may also refer to various connection modalities. This includes physical connections through wired or wireless interfaces, logical connections operating independently of the physical layer, API connections allowing software components to communicate, and microservice connections in distributed architectures. The terminology extends to edge-to-cloud connections for distributed processing environments, blockchain connections for distributed ledger systems, quantum connections for secure communication, and neural network connections for artificial intelligence systems.

As used herein, the term “display” or “displaying” refers to any means, method, apparatus, or process for visually presenting or otherwise conveying information to a user. This terminology encompasses a broad spectrum of technologies and presentation modalities that may be employed to render content perceivable by a user. The term includes traditional display technologies such as cathode ray tubes (CRTs), liquid crystal displays (LCDs), light-emitting diode (LED) displays, organic light-emitting diode (OLED) dis plays, micro-LED displays, and electronic paper displays. It also encompasses specialized display types such as transparent displays, flexible displays, foldable displays, stretchable displays, and holographic displays.

The term “display” may also refer to projection systems, including traditional projectors, laser projectors, pico projectors, and holographic projection systems. It further includes immersive display technologies such as head-mounted displays (HMDs), virtual reality (VR) headsets, augmented reality (AR) glasses, mixed reality (MR) systems, and smart contact lenses. The terminology extends to ambient display methods that integrate visual information into the environment, such as smart mirrors, interactive surfaces, projection mapping systems, and volumetric displays.

The definition also encompasses non-visual display modalities that may complement or substitute for visual displays. This includes auditory displays such as speech output systems, sonification interfaces, and spatial audio; haptic displays that communicate through tactile feedback, vibration patterns, or force feedback; and other sensory output mechanisms such as olfactory displays and thermotactile interfaces. Multimodal displays that combine multiple sensory channels for information presentation are also included within this terminology.

The term “display” further encompasses the software and computational components involved in rendering information. This includes rendering engines, graphics processing pipelines, display servers, and compositing systems. It also includes specialized display rendering techniques such as rasterization, ray tracing, vector graphics, procedural generation, and neural rendering. The term extends to user interface paradigms such as graphical user interfaces (GUIs), natural user interfaces (NUIs), voice user interfaces (VUIs), brain-computer interfaces (BCIs), and ambient intelligence systems.

In the context of accessibility, the term “display” includes assistive technologies and alternative display methods designed to accommodate diverse user needs. This encompasses screen readers, braille displays, audio descriptions, high-contrast modes, color-shifted presentations, and other adaptive display mechanisms. The terminology also includes display personalization techniques such as adaptive interfaces, contextual displays, and user-specific rendering optimizations.

The description of the embodiments of the present disclosure is intended to be illustrative, and not to limit the scope of the claims. Many alternatives, modifications, and variations will be apparent to those skilled in the art. A number of implementations have been described. Nevertheless, it will be understood that various modifications may be made without departing from the spirit and scope of the disclosure. Accordingly, other implementations are within the scope of the following claims.

1. A computer-implemented method for generating and verifying a non-interactive zero-knowledge proof providing subversion zero-knowledge security against malicious common reference strings, the method comprising:
(a) providing, by one or more computerized processors, a non-interactive zero-knowledge proof system with subversion zero-knowledge security, wherein the subversion zero-knowledge security comprises that for every non-uniform probabilistic polynomial-time adversary [symbol] that generates a potentially malicious common reference string CRS*, there exists a probabilistic polynomial-time simulator [symbol] and an S(λ)-time computable advice distribution [symbol] such that the view of [symbol] in a real proof generation process [symbol] (λ) is computationally indistinguishable from the view of [symbol] in ideal simulation process [symbol] (λ);
(b) generating and verifying the non-interactive zero-knowledge proof using a combination of:
(i) a provided non-interactive zero-knowledge proof system that optionally provides no subversion security,
(ii) a delayed-input two-message publicly-verifiable S-advice zero-knowledge argument system, wherein the delayed-input two-message publicly-verifiable S-advice zero-knowledge argument system comprises:
(a) a verifier algorithm V₀ that generates a first message independent of the statement to be proven;
(b) a prover algorithm P that generates a second message dependent on the statement and the first message;
(c) a verifier algorithm V₁ that decides whether to accept or reject based on the transcript;
(d) wherein the system is publicly verifiable such that the verifier does not keep a secret state after generating the first message;
(e) wherein for every non-uniform probabilistic polynomial-time adversarial verifier, there exists a probabilistic polynomial-time simulator and an S(λ)-time computable advice distribution, such that the view of the adversary in a real proof generation process is computationally indistinguishable from its view in an ideal simulation process;
(f) wherein the simulator, given a sample from the advice distribution, can efficiently generate transcripts for multiple statements that are indistinguishable from transcripts generated by an honest prover interacting with the adversarial verifier;
(g) and wherein the system provides perfect completeness and T-adaptive soundness for NP languages; and
(iii) a non-interactive perfectly binding and T-extractable commitment scheme.
(c) generating and verifying the non-interactive zero-knowledge proof with subversion zero-knowledge security (referred to as the outer NIZK system) by:
(i) generating a common reference string CRS for the outer NIZK system by:
(a) generating an inner common reference string CRS_{Inner} using a first non-interactive zero-knowledge argument system (referred to as the inner NIZK system), and storing the inner common reference string CRS_{Inner} in a non-transitory computer-readable memory;
(b) computing a first message zk₁ using the delayed-input two-message publicly-verifiable S-advice zero-knowledge argument system;
(ii) generating a proof π for the outer NIZK system for a statement x using a witness w by:
(a) computing a second message zk₂ using the delayed-input two-message publicly-verifiable S-advice zero-knowledge argument system,
(b) committing to the second message using the non-interactive perfectly binding and T-extractable commitment scheme to obtain a commitment c, and
(c) computing an inner proof π_{Inner} using the inner NIZK system, and storing the inner proof π_{Inner} in the non-transitory computer-readable memory;
(iii) verifying the proof for the outer NIZK system by:
(a) retrieving the inner proof π_{Inner} from the non-transitory computer-readable memory and verifying the inner proof using the inner NIZK system.

2. The method of claim 1, wherein the delayed-input two-message publicly-verifiable S-advice zero-knowledge argument system is constructed using:
(a) a T-hard trapdoor generation protocol;
(b) a non-interactive perfectly binding and T-extractable commitment scheme; and
(c) a delayed-input, two-message, T-sound and publicly-verifiable witness indistinguishable argument for a language that combines the statement to be proven and the trapdoor.

3. The method of claim 1, wherein the non-interactive zero-knowledge proof system with subversion zero-knowledge security satisfies perfect completeness and computational adaptive soundness when the common reference string is honestly generated.

4. The method of claim 1, wherein generating the proof π for the outer NIZK system further comprises:
(a) computing the second message zk₂ using the statement x and the witness w as inputs to the prover algorithm P of the delayed-input two-message
publicly-verifiable S-advice zero-knowledge argument system; and
(b) computing the inner proof π_{Inner} for the statement that there exists a zk₂ such that the verifier algorithm V₁ of the delayed-input two-message publicly-verifiable S-advice zero-knowledge argument system accepts (zk₁, zk₂) and c is a commitment to zk₂.

5. The method of claim 1, wherein verifying the proof for the outer NIZK system further comprises:
(a) parsing the common reference string CRS as (CRS_{Inner}, zk₁);
(b) parsing the proof π as (π_{Inner}, c); and
(c) verifying the inner proof π_{Inner} for the statement (x, zk₁, c) using the inner NIZK system.

6. The method of claim 1, wherein the S(λ)-time computable advice distribution [symbol] is independent of the statement to be proven and can be sampled in super-polynomial time S(λ), where S is a function of the security parameter λ but independent of the hardness of the language L.

7. The method of claim 1, wherein the subversion zero-knowledge security implies that the non-interactive zero-knowledge proof system satisfies subversion witness indistinguishability, subversion witness hiding, and subversion function hiding properties.

8. A system for generating and verifying a non-interactive zero-knowledge proof providing subversion zero-knowledge security against malicious common reference strings, the system comprising:
(a) a processor; and
(b) a memory storing instructions that, when executed by the processor, cause the system to:
(i) provide a non-interactive zero-knowledge proof system with subversion zero-knowledge security, wherein the subversion zero-knowledge security comprises that for every non-uniform probabilistic polynomial-time adversary [symbol] that generates a potentially malicious common reference strip CRS*, there exists a probabilistic polynomial time simulator [symbol] and an S(λ)-time computable advice distribution [symbol] such that the view of [symbol] in a real proof generation process [symbol] (λ) is computationally indistinguishable from the view of [symbol] in an ideal simulation process [symbol] (λ);
(ii) generate and verify the non-interactive zero-knowledge proof using a combination of:
(a) a provided non-interactive zero-knowledge proof system that optionally provides no subversion security,
(b) a delayed-input two-message publicly-verifiable S-advice zero-knowledge argument system, wherein the delayed-input two-message publicly-verifiable S-advice zero-knowledge argument system comprises:
(i) a verifier algorithm V₀ that generates a first message independent of the statement to be proven;
(ii) a prover algorithm P that generates a second message dependent on the statement and the first message;
(iii) a verifier algorithm V₁ that decides whether to accept or reject based on the transcript;
(iv) wherein the system is publicly verifiable such that the verifier does not keep a secret state after generating the first message;
(v) wherein for every non-uniform probabilistic polynomial-time adversarial verifier, there exists a probabilistic polynomial-time simulator and an S(λ)-time computable advice distribution, such that the view of the adversary in a real proof generation process is computationally indistinguishable from its view in an ideal simulation process;
(vi) wherein the simulator, given a sample from the advice distribution, can efficiently generate transcripts for multiple statements that are indistinguishable from transcripts generated by an honest prover interacting with the adversarial verifier;
(vii) and wherein the system provides perfect completeness and T-adaptive soundness for NP languages; and
(c) a non-interactive perfectly binding and T-extractable commitment scheme.
(iii) generate and verify the non-interactive zero-knowledge proof with subversion zero-knowledge security (referred to as the outer NIZK system) by:
(a) generating a common reference string CRS for the outer NIZK system by:
(i) generating an inner common reference string CRS_{Inner} using a first non-interactive zero-knowledge argument system (referred to as the inner NIZK system), and storing the inner common reference string CRS_{Inner} in the memory;
(ii) computing a first message A₁ using the delayed-input two-message publicly-verifiable S-advice zero-knowledge argument system;
(b) generating a proof π for the outer NIZK system for a statement x using a witness w by:
(i) computing a second message zk₂ using the delayed-input two-message publicly-verifiable S-advice zero-knowledge argument system,
(ii) committing to the second message using the non-interactive perfectly binding and T-extractable commitment scheme to obtain a commitment c, and
(iii) computing an inner proof π_{Inner} using the inner NIZK system, and storing the inner proof π_{Inner} in the memory;
(c) verifying the proof for the outer NIZK system by:
(i) retrieving the inner proof π_{Inner} from the memory and verifying the inner proof using the inner NIZK system.

9. The system of claim 8, wherein the delayed-input two-message publicly-verifiable S-advice zero-knowledge argument system is constructed using:
(a) a T-hard trapdoor generation protocol;
(b) a non-interactive perfectly binding and T-extractable commitment scheme; and
(c) a delayed-input, two-message, T-sound and publicly-verifiable witness indistinguishable argument for a language that combines the statement to be proven and the trapdoor.

10. The system of claim 8, wherein the non-interactive zero-knowledge proof system with subversion zero-knowledge security satisfies perfect completeness and computational adaptive soundness when the common reference string is honestly generated.

11. The system of claim 8, wherein generating the proof π for the outer NIZK system further comprises:
(a) computing the second message zk₂ using the statement x and the witness w as inputs to the prover algorithm P of the delayed-input two-message publicly-verifiable S-advice zero-knowledge argument system; and
(b) computing the inner proof π_{Inner} for the statement that there exists a zk₂ such that the verifier algorithm V₁ of the delayed-input two-message publicly-verifiable S-advice zero-knowledge argument system accepts (zk₁, zk₂) and c is a commitment to zk₂.

12. The system of claim 8, wherein verifying the proof for the outer NIZK system further comprises:
(a) parsing the common reference string CRS as (CRS_{Inner}, zk₁);
(b) parsing the proof π as (π_{Inner}, c); and
(c) verifying the inner proof π_{Inner} for the statement (x, zk₁, c) using the inner NIZK system.

13. The system of claim 8, wherein the S(λ)-time computable advice distribution [symbol] is independent of the statement to be proven and can be sampled in super-polynomial time S(λ), where S is a function of the security parameter λ but independent of the hardness of the language L.

14. The system of claim 8, wherein the subversion zero-knowledge security implies that the non-interactive zero-knowledge proof system satisfies subversion witness indistinguishability, subversion witness hiding, and subversion function hiding properties.

15. A non-transitory computer-readable medium storing instructions that, when executed by a processor, cause the processor to perform a method for generating and verifying a non-interactive zero-knowledge proof providing subversion zero-knowledge security against malicious common reference strings, the method comprising:
(a) providing a non-interactive zero-knowledge proof system with subversion zero-knowledge security, wherein the subversion zero-knowledge security comprises that for every non-uniform probabilistic polynomial-time adversary [symbol] that generates a potentially malicious common reference string CRS*, there exists a probabilistic polynomial-time simulator [symbol] and an S(λ)-time computable advice distribution [symbol] such that the view of [symbol] in a real proof generation process [symbol] (λ) is computationally indistinguishable from the view of [symbol] in an ideal simulation process [symbol] (λ);
(b) generating and verifying the non-interactive zero-knowledge proof using a combination of:
(i) a provided non-interactive zero-knowledge proof system that optionally provides no subversion security,
(ii) a delayed-input two-message publicly-verifiable S-advice zero-knowledge argument system, wherein the delayed-input two-message publicly-verifiable S-advice zero-knowledge argument system comprises:
(a) a verifier algorithm V₀ that generates a first message independent of the statement to be proven;
(b) a prover algorithm P that generates a second message dependent on the statement and the first message;
(c) a verifier algorithm V₁ that decides whether to accept or reject based on the transcript;
(d) wherein the system is publicly verifiable such that the verifier does not keep a secret state after generating the first message;
(e) wherein for every non-uniform probabilistic polynomial-time adversarial verifier, there exists a probabilistic polynomial-time simulator and an S(λ)-time computable advice distribution, such that the view of the adversary in a real proof generation process is computationally indistinguishable from its view in an ideal simulation process;
(f) wherein the simulator, given a sample from the advice distribution, can efficiently generate transcripts for multiple statements that are indistinguishable from transcripts generated by an honest prover interacting with the adversarial verifier;
(g) and wherein the system provides perfect completeness and T-adaptive soundness for NP languages; and
(iii) a non-interactive perfectly binding and T-extractable commitment scheme.
(c) generating and verifying the non-interactive zero-knowledge proof with subversion zero-knowledge security (referred to as the outer NIZK system) by:
(i) generating a common reference string CRS for the outer NIZK system by:
(a) generating an inner common reference string CRS_{Inner} using a first non-interactive zero-knowledge argument system (referred to as the inner NIZK system), and storing the inner common reference string CRS_{Inner} in a memory;
(b) computing a first message zk₁ using the delayed-input two-message publicly-verifiable S-advice zero-knowledge argument system;
(ii) generating a proof π for the outer NIZK system for a statement x using a witness w by:
(a) computing a second message zk₂ using the delayed-input two-message publicly-verifiable S-advice zero-knowledge argument system,
(b) committing to the second message using the non-interactive perfectly binding and T-extractable commitment scheme to obtain a commitment c, and
(c) computing an inner proof π_{Inner} using the inner NIZK system, and storing the inner proof π_{Inner} in the memory;
(iii) verifying the proof for the outer NIZK system by:
(a) retrieving the inner proof π_{Inner} from the memory and verifying the inner proof using the inner NIZK system.

16. The non-transitory computer-readable medium of claim 15, wherein the delayed-input two-message publicly-verifiable S-advice zero-knowledge argument system is constructed using:
(a) a T-hard trapdoor generation protocol;
(b) a non-interactive perfectly binding and T-extractable commitment scheme; and
(c) a delayed-input, two-message, T-sound and publicly-verifiable witness indistinguishable argument for a language that combines the statement to be proven and the trapdoor.

17. The non-transitory computer-readable medium of claim 15, wherein the non-interactive zero-knowledge proof system with subversion zero-knowledge security satisfies perfect completeness and computational adaptive soundness when the common reference string is honestly generated.

18. The non-transitory computer-readable medium of claim 15, wherein generating the proof π for the outer NIZK system further comprises:
(a) computing the second message zk₂ using the statement x and the witness w as inputs to the prover algorithm P of the delayed-input two-message publicly-verifiable S-advice zero-knowledge argument system; and
(b) computing the inner proof π_{Inner} for the statement that there exists a zk₂ such that the verifier algorithm V₁ of the delayed-input two-message publicly-verifiable S-advice zero-knowledge argument system accepts (zk₁, zk₂) and c is a commitment to zk₂.

19. The non-transitory computer-readable medium of claim 15, wherein verifying the proof for the outer NIZK system further comprises:
(a) parsing the common reference string CRS as (CRS_{Inner}, zk₁);
(b) parsing the proof π as (π_{Inner}, c); and
(c) verifying the inner proof π_{Inner} for the statement (x, zk₁, c) using the inner NIZK system.

20. The non-transitory computer-readable medium of claim 15, wherein the S)-time computable advice distribution [symbol] is independent of the statement to be proven and can be sampled in super-polynomial time S(λ), where S is a function of the security parameter λ but independent of the hardness of the language L.
